(19) United States
(12) Patent Application Publication
(10) Pub. No.: US 2025/0215162 A1
(43) Pub. Date: Jul. 3, 2025

(54) PREPARATION OF POLYETHER-FUNCTIONAL ORGANOSILICON COMPOUNDS

(71) Applicants: Dow Global Technologies LLC, Midland, MI (US); Dow Silicones Corporation, Midland, MI (US)

(72) Inventors: Michael Tulchinsky, Midland, MI (US); Jason Fisk, Midland, MI (US); Heather Spinney, Midland, MI (US); Mike Ferritto, Midland, MI (US); Qichun Wan, Midland, MI (US)

(21) Appl. No.: 18/835,045

(22) PCT Filed: Feb. 24, 2023
(86) PCT No.: PCT/US2023/063186

§ 371 Date: Aug. 1, 2024

Related U.S. Application Data
(60) Provisional application No. 63/330,497, filed on Apr. 13, 2022.

(51) Int. Cl. C08G 77/46; C07F 5/02; C07F 9/6574

(52) U.S. Cl. CPC C08G 77/46; C07F 5/027; C07F 9/65746

(57) ABSTRACT

A polyether-functional organosilicon compound and method for its preparation are provided. The method produces a polyether-functional organosilicon compound having a polyether group bonded to a silicon atom via a silicon-carbon bond. The method includes alkoxylation of a carbinol-functional organosilicon compound. The carbinol-functional organosilicon compound may be prepared by hydroformylation of an alkenyl-functional organosilicon compound to produce an aldehyde-function organosilicon compound and subsequent hydrogenation of the aldehyde-functional organosilicon compound.

### CROSS REFERENCE TO RELATED APPLICATIONS

This application claims the benefit of U.S. Provisional Patent Application Ser. No. 63/330,497 filed on 13 Apr. 2022 under 35 U.S.C. § 119 (e). U.S. Provisional Patent Application Ser. No. 63/330,497 is hereby incorporated by reference.

### TECHNICAL FIELD

A polyether-functional organosilicon compound and method for its preparation are provided. The method produces a polyether-functional organosilicon compound having a polyether group bonded to a silicon atom via a silicon-carbon bond.

### INTRODUCTION

Silicone polyethers (SPEs) are used in a myriad of applications including polyurethane foams, personal care products, paints, inks, and coatings. The SPE may function as a stabilizer, surfactant, wetting agent, lubricant, or antifoam in these applications.

A typical SPE comprises a polyorganosiloxane backbone with terminal and/or pendant polyoxyalkylene chains. SPEs can be used in the various applications and functions because their hydrophilic-lipophilic balance (HLB) can be readily adjusted by appropriate choices of the polyorganosiloxane starting material and by structure and composition of the alkylene oxide starting material that forms the polyoxyalkylene chains.

U.S. Pat. No. 5,869,727 discloses siloxane-polyether copolymers manufactured by reaction of poly(dimethyl-siloxanes) containing SiH groups (hydrosiloxanes) with olefinic polyethers wherein the olefinic sites are allyl groups. This method suffers from the drawback that a significant percentage of the allyl groups are isomerized under the addition reaction conditions to give propenyl polyethers which do not participate in the hydrosilylation reaction. A stoichiometric excess (20 mole % or more) of the allyl polyethers has been used to insure reaction of all the SiH groups. The excess unreacted allyl polyether or isomerized propenyl polyether may limit product quality and performance.

Even with excess allyl polyether, it may still be difficult to achieve a complete conversion of the silicon hydride functionality. Proposed solutions such as adding an additional allyl polyether reagent and/or platinum catalyst add cost and can further decrease product quality. The SPEs made via hydrosilylation may suffer from the drawbacks of displaying bimodal or polymodal molecular weight distributions and high PDIs.

An alternative method of producing silicone polyethers involves reacting a polysiloxane containing carbon-bonded OH groups with an epoxide in the presence of trifluoroborane (BF₃) or a double metal cyanide (DMC) catalyst as disclosed in U.S. Pat. No. 5,391,679. This patent discloses SiC-bonded polyether-siloxane copolymers prepared by alkoxylation with propylene oxide or a mixture of propylene oxide and ethylene oxide with a molar ratio of 1:1. However, analytical characterization results of the alkoxylated polymers by NMR and gel permeation chromatography (GPC) are absent, so no determination of the product quality can be made. Furthermore, use of DMC catalyst requires high temperatures (140° C. or higher), which can result in decomposition of the siloxane backbone.

### Problems to be Addressed

There is a need in the organosilicon industry to provide a method to synthesize a polyether-functional organosilicon compound, such as a silicone polyether, which has one or more of the benefits of defined functionality, retains the polysiloxane structure, and is free of unsaturated polyether components. Commercial production of silicone polyethers relies upon platinum catalyzed hydrosilylation of SiH containing polyalkylsiloxanes with allyl polyethers. Allyl polyethers are used in excess because they partially isomerize during the course of reaction to form unreactive 2-propenyl polyethers with an internal C═C double bond. Both allyl polyether and 2-propenyl polyether remain as undesirable side products in the resulting alkoxylated polysiloxane products, which can lead to bimodal or polymodal molecular weight distributions and high PDIs. Hydrolysis of 2-propenyl polyether in the presence of water can generate propionaldehyde, resulting in unwanted side reactions and unpleasant smell.

### SUMMARY

A method is described herein for preparing a polyether-functional organosilicon compound comprising a polyether group bonded to a silicon atom via a Si—C bond.

### DETAILED DESCRIPTION

The method for making the polyether-functional organosilicon compound comprises: (1) combining, at a temperature up to 100° C. for a time up to 10 hours, starting materials comprising (A) an epoxide; (B) a halogenated triarylborane Lewis acid; and (C) a carbinol-functional organosilicon compound. The starting materials may optionally further comprise (D) a solvent, e.g., to facilitate mixing of one or more of the other starting materials. Alternatively, the temperature may be at least 20° C., alternatively at least 30° C., alternatively at least 40° C., and alternatively at least 50° C.; while at the same time the temperature may be up to 100° C., alternatively up to 80° C., alternatively up to 60° C., and alternatively up to 50° C. Alternatively, the temperature may be 20° C. to 100° C., alternatively 30° C. to 80° C., alternatively 30° C. to 50° C., alternatively 40° C. to 50° C., alternatively 20° C. to <50° C., alternatively 20° C. to 40° C., and alternatively 40° C. to <50° C. Without wishing to be bound by theory, it is thought that performing step (1) at a temperature >100° C. may lead to catalyst decomposition and partial degradation of the polysiloxane backbone, but temperature <20° C. may be insufficient to provide a reaction rate that is practical on a commercial scale.

Step (1) may be performed for a time of at least 1 hour, alternatively at least 3 hours, and alternatively at least 6 hours while at the same time the time may be up to 12 hours, alternatively up to 10 hours, alternatively up to 6 hours. Alternatively, the time may be 1 hour to 10 hours, alternatively 3 to 6 hours. Step (1) may be performed under an inert atmosphere, such as nitrogen. Without wishing to be bound by theory, it is thought that the inert atmosphere may minimize or prevent catalyst deactivation. Step (1) may be performed in a reactor capable of operating at increased pressure.

The method described above may optionally further comprise one or more additional steps. For example, the method may further comprise: step (2) recovering the polyether-functional organosilicon compound after step (1). Recovering in step (2) may be performed by any convenient means, such as solvent stripping optionally with reduced pressure and/or with flow of inert gas, such as nitrogen, to remove residual epoxide.

The method described above may optionally further comprise step pre-(1) removing an impurity from (C) the carbinol-functional organosilicon compound before step (1). Without wishing to be bound by theory, it is thought that the presence of an impurity may lead to undesirable side reactions or cause the carbinol-functional organosilicon compound not to undergo sufficient alkoxylation reaction in step (1). Removing the impurity may be done by any convenient means, such as treating (C) the carbinol-functional organosilicon compound with an adsorbent for a time sufficient to remove all or a portion of the impurity. The adsorbent may be, for example, activated carbon, which is commercially available. Treating (C) the carbinol-functional organosilicon compound with the adsorbent may be performed, e.g., by mixing at least 90% of the carbinol-functional organosilicon compound and up to 10% of the adsorbent for at least 1 hour, alternatively at least 6 hours, alternatively at least 12 hours; and thereafter removing the adsorbent by any convenient means, e.g., by filtering the mixture. For example, mixing 90% to 99% of the carbinol-functional organosilicon compound and 1% to 10% of the adsorbent for 1 hour to 24 hours, and thereafter removing the adsorbent. Without wishing to be bound by theory, it is thought that carbinol-functional organosilicon compounds are both acid and base sensitive, therefore, certain conventional purification techniques such as distillation, crystallization, and extraction may be ineffective to remove the impurity. Furthermore, it is thought that the impurity may comprise a base that may degrade the carbinol-functional organosilicon compound, reduce or inactivate the catalytic activity of (B) the halogenated triarylborane Lewis acid by, e.g., forming an acid-base adduct that is catalytically inactive for alkoxylation reaction, or both. It is further thought that the treatment with the adsorbent such as activated carbon removes all or a portion of the impurity, i.e., removes an amount of the impurity sufficient to prevent complete deactivation of catalytic activity and facilitate the alkoxylation reaction in step (1). Treating (C) the carbinol-functional organosilicon compound may be performed one time. Alternatively, treating the carbinol-functional organosilicon compound may be repeated (one or more times), e.g., the carbinol-functional organosilicon compound may be combined with the adsorbent as described above, filtered, and then combined with fresh adsorbent as described above, and filtered again before step (1). Without wishing to be bound by theory, it is thought that the concentration of starting material (B) used to achieve incorporation of the desired polyether group can be decreased if starting material (C) is treated with activated carbon two or more times instead of one time, particularly when starting material (C) has two or more carbinol groups per molecule.

### (A) Epoxide

Starting material (A) in the method for making the polyether-functional organosilicon compound is an epoxide. The epoxide may be, for example, an alkylene oxide such as ethylene oxide, propylene oxide, butylene oxide, hexylene oxide, decylene oxide, or a combination of two or more thereof. Alternatively, the epoxide may be glycidol, cyclohexene oxide, styrene oxide, or a combination of two or more thereof. Alternatively, the epoxide may be the alkylene oxide. Alternatively, the alkylene oxide may be selected from the group consisting of ethylene oxide (EO), propylene oxide (PO), and a combination of both EO and PO. The mixed epoxide combinations can be added in any order. For example, EO and PO may be mixed and then co-added. Alternatively, one epoxide may added first and run to completion followed by a second epoxide being added. For example, PO can be added first followed by EO to give a block polyether segment.

The amount of epoxide is not critical and may depend on various factors such as the reactor selected for conducting alkoxylation reaction in step (1). For example, the reactor may be filled to 50 volume % of its capacity for safety. The epoxide can be added to the reactor in multiple doses, or metered in over time, rather than loading all epoxide at once.

### (B) Halogenated Triarylborane

Starting material (B) in the method described herein is a halogenated triarylborane Lewis acid. The halogenated triarylborane Lewis acid may have formula:

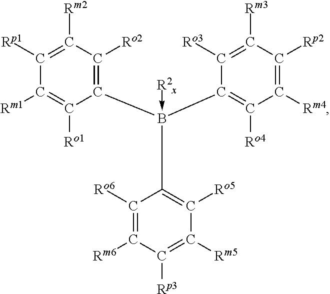

where each R^{o} is an independently selected ortho substituent, each R^{m} is an independently selected meta substituent, each R^{p} is a para substituent, R² is optional and includes a functional group or a functional polymer group; and subscript x is 0 or 1. In the formula above, each of R^{o1-6}, each of R^{m1-6}, and each of R^{p1-3} is independently selected from H, F, Cl, Br, or CF₃; with the provisos that i) not all of R^{o1-6}, R^{m1-6}, and R^{p1-3} are simultaneously H, and ii) no more than two of R^{o1-6} are simultaneously CF₃. R² is optional, i.e., R² is present when subscript x=1 and R² is absent when subscript x=0. R² may be a Lewis base that forms a complex with the halogenated triarylborane Lewis acid and/or a molecule or moiety that contains at least one electron pair that is available to form a dative bond with the Lewis acid, and may be as described for R⁴ in WO2019/055740 at paragraphs [0024] to [0025]. Examples of R² include cyclic ethers such as tetrahydrofuran or tetrahydropyran. Alternatively, R² may be tetrahydrofuran (THF). Alternatively, the halogenated triarylborane Lewis acid may be a fluorinated triarylborane Lewis acid, in which each of R^{o1-6}, each of R^{m1-6}, and each of R^{p1-3} may be independently selected from H, F, or CF₃; with the proviso that not all of R^{o1-6}, R^{m1-6}, and R^{p1-3} are simultaneously H, and no more than two of R^{o1-6} are simultaneously CF₃.

Alternatively, each of R^{o1}, R^{o2}, R^{o3}, R^{o4}, R^{o5}, and R^{o6} may be H. Alternatively, each of R^{o1}, R^{o2}, R^{o3}, and R^{o4} may be H. Alternatively, each of R^{o5} and R^{o6} may be F.

Alternatively, each of R^{m1}, R^{m2}, R^{m3}, R^{m4}, R^{m5}, and R^{m6} may be CF₃. Alternatively, each of R^{m1}, R^{m2}, R^{m3}, and R^{m4} may be CF₃. Alternatively, each of R^{m5} and R^{m6} may be F. Alternatively, each of R^{m5} and R^{m6} may be H.

Alternatively, each of R^{p1}, R^{p2}, and R^{p3} may be H. Alternatively, R^{p1} and R^{p2} may be H. Alternatively, R^{p3} may be F. Alternatively, R^{p3} may be CF₃.

Alternatively, each of R^{o1}, R^{o2}, R^{o3}, R^{o4}, R^{o5}, ROG, R^{p1}, R^{p2}, and R^{p3} may be H; and each of R^{m1}, R^{m2}, R^{m3}, R^{m4}, R^{m5}, and R^{m6} may be CF₃. Subscript x may be 1. Alternatively, starting material (B) may comprise tris(3,5-bis(trifluoromethyl)phenyl)borane THF adduct.

Alternatively, each of R^{o1}, R^{o2}, R^{o3}, R^{o4}, R^{o5}, R^{o6}, R^{p1}, R^{p2}, and R^{p3} may be H; and each of R^{m1}, R^{m2}, R^{m3}, R^{m4}, R^{m5}, and R^{m6} may be CF₃; and subscript x may be 0. Alternatively, starting material (B) may comprise tris(3,5-bis(trifluoromethyl)phenyl)borane.

Alternatively, each of R^{o1}, R^{o2}, R^{o3}, R^{o4}, R^{o5}, R^{o6}, R^{m5}, R^{m6}, R^{p1}, and R^{p2}, may be H; and each of R^{m1}, R^{m2}, R^{m3}, R^{m4}, and R^{p3} may be CF₃. Subscript x may be 1. Alternatively, starting material (B) may comprise bis(3,5-bis(trifluoromethyl)phenyl)(4-trifluoromethylphenyl)borane THF adduct.

Alternatively, each of R^{o1}, R^{o2}, R^{o3}, R^{o4}, R^{m5}, R^{m6}, R^{p1}, and R^{p2} may be H; each of R^{o5}, R^{o6}, and R^{p3} may be F; and each of R^{m1}, R^{m2}, R^{m3}, R^{m4}, may be CF₃. Subscript x may be 1. Alternatively, starting material (B) may comprise bis(3,5-bis(trifluoromethyl)phenyl)(2,4,6-trifluorophenyl)borane THF adduct.

Alternatively, each of R^{o1}, R^{o2}, R^{o3}, R^{o4}, R^{m5}, R^{m6}, R^{p1}, R^{p2}, and R^{p3} may be H; R^{o5} and R^{o6} may be F; and each of R^{m1}, R^{m2}, R^{m3}, and R^{m4} may be CF₃. Subscript x may be 1. Alternatively, starting material A) may comprise bis(3,5-bis(trifluoromethyl)phenyl)(2,6-difluorophenyl)borane THF adduct.

Alternatively, each of R^{o1}, R^{o2}, R^{o3}, R^{o4}, R^{o5}, R^{m6}, R^{p1}, R^{p2}, and R^{p3} may be H; and each of R^{m1}, R^{m2}, R^{m3}, R^{m4}, R^{m5}, and R^{o6} may be CF₃. Subscript x may be 0. Alternatively, starting material (B) may comprise bis(3,5-bis(trifluoromethyl)phenyl)(2,5-bis(trifluoromethyl)phenyl)borane.

Alternatively, each of R^{m1}, R^{p1}, R^{o2}, R^{o3}, R^{o4}, R^{p2}, R^{p3}, R^{o5}, and R^{m6} may be H; and each of R^{o1}, R^{m2}, R^{m3}, R^{m4}, R^{o6}, and R^{m5} may be CF₃. Subscript x may be 0. Alternatively, starting material A) may comprise (3,5-bis(trifluoromethyl)phenyl)bis(2,5-bis(trifluoromethyl)phenyl)borane.

Alternatively, each of R^{o1}, R^{o2}, R^{o3}, R^{o4}, R^{p1}, and R^{p2} may be H; each of R^{o5}, R^{o6}, R^{m5}, and R^{m6} may be F; and each of R^{m1}, R^{m2}, R^{m3}, R^{m4}, and R^{p3} may be CF₃. Subscript x may be 1. Alternatively, starting material (B) may comprise bis(3,5-bis(trifluoromethyl)phenyl)(2,3,5,6-tetrafluoro-4-trifluoromethylphenyl)borane THF adduct.

Alternatively, each of R^{o1}, R^{o2}, R^{o3}, R^{o4}, R^{o5}, R^{o6}, R^{m1}, R^{m2}, R^{m3}, R^{m4}, R^{m5}, R^{m6}, R^{p1}, R^{p2}, and R^{p3} may be F. Subscript x may be 0. Alternatively, starting material (B) may comprise B(C₆F₅)₃, tris(pentafluorophenyl)borane.

Alternatively, the fluorinated triarylborane Lewis acid may be selected from the group consisting of tris(3,5-bis(trifluoromethyl)phenyl)borane THF adduct; bis(3,5-bis(trifluoromethyl)phenyl)(2,4,6-trifluorophenyl)borane THF adduct; bis(3,5-bis(trifluoromethyl)phenyl)(2,5-bis(trifluoromethyl)phenyl)borane, and tris(pentafluorophenyl)borane. Alternatively, the fluorinated triarylborane Lewis acid may be selected from the group consisting of tris(3,5-bis(trifluoromethyl)phenyl)borane THF adduct; bis(3,5-bis(trifluoromethyl)phenyl)(2,4,6-trifluorophenyl)borane THF adduct; and tris(pentafluorophenyl)borane. Alternatively, starting material (B) may be bis(3,5-bis(trifluoromethyl)phenyl)(2,4,6-trifluorophenyl)borane THF adduct and tris(pentafluorophenyl)borane. Alternatively, starting material (B) may be tris(pentafluorophenyl)borane.

Halogenated triarylborane Lewis acids, such as fluorinated triarylborane Lewis acids, are known in the art, and may be prepared by known methods, for example, the methods disclosed in WO2019/055741 particularly at paragraphs to and U.S. Pat. No. 11,001,669 corresponding to WO2019/055740, particularly at paragraphs to by varying appropriate starting materials.

The amount of starting material (B) will depend on the type and amount of other starting materials used, however, starting material (B) may be present in an amount of 50 ppm to 10,000 ppm based on combined weights of starting materials (A), (B) and (C). Alternatively, the amount may be 100 ppm to 2,500 ppm, alternatively 200 ppm to 2,000 ppm, and alternatively 300 ppm to 1,500 ppm on the same basis.

### (C) Carbinol-Functional Organosilicon Compound

The carbinol-functional organosilicon compound has at least one carbinol-functional group bonded to silicon, per molecule. Alternatively, the carbinol-functional organosilicon compound may have more than one carbinol-functional group bonded to different silicon atoms in each molecule. The carbinol functional group is bonded to silicon via an Si—C bond. The carbinol functional group may have primary —OH groups or secondary —OH groups.

Alternatively, the carbinol functional group, R^{Car}, may have formula

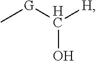

where G is a divalent hydrocarbon group free of aliphatic unsaturation that may have 1 to 8 carbon atoms, alternatively 2 to 8 carbon atoms. G may be linear or branched. Examples of divalent hydrocarbon groups for G include alkane-diyl groups of empirical formula —CᵣH₂ᵣ—, where subscript r is 2 to 8. The alkane-diyl group may be a linear alkane-diyl, e.g., —CH₂—CH₂—, —CH₂—CH₂—CH₂—, —CH₂—CH₂—CH₂—CH₂—, or —CH₂—CH₂—CH₂—CH₂—CH₂—CH₂—; or a branched alkane-diyl, e.g.,

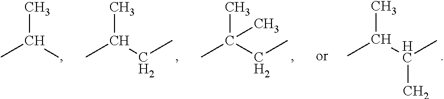

Alternatively, the alkane-diyl may be linear. Alternatively, the alkane-diyl may be —CH₂—CH₂—.

The carbinol-functional organosilicon compound may comprise (C1) a carbinol-functional silane of formula (C1-1): R^{Car}ₓSiR⁴₍₄₋ₓ₎, where each R^{Car} is an independently selected carbinol group of 3 to 9 carbon atoms of formula

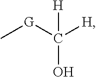

where G is a divalent hydrocarbon group free of aliphatic unsaturation that has 2 to 8 carbon atoms as described above; each R⁴ is independently selected from the group consisting of an alkyl group of 1 to 18 carbon atoms, an aryl group of 6 to 18 carbon atoms, an acyloxy group of 2 to 18 carbon atoms, and a hydrocarbonoxy-functional group of 1 to 18 carbon atoms; and subscript x is 1 to 4. Alternatively, subscript x may be 1 or 2, alternatively 2, and alternatively 1. Alternatively, each R⁴ may be independently selected from the group consisting of an alkyl group of 1 to 18 carbon atoms, an aryl group of 6 to 18 carbon atoms, an acyloxy group of 1 to 18 carbon atoms, and a hydrocarbonoxy-functional group of 1 to 18 carbon atoms. Alternatively, each R⁴ may be independently selected from the group consisting of an alkyl group of 1 to 18 carbon atoms, an aryl group of 6 to 18 carbon atoms, and an alkoxy-functional group of 1 to 18 carbon atoms. Alternatively, each R⁴ in formula (C1-1) may be independently selected from the group consisting of an alkyl group of 1 to 18 carbon atoms, an aryl group of 6 to 18 carbon atoms, and a hydrocarbonoxy-functional group of 1 to 18 carbon atoms.

Suitable alkyl groups for R⁴ may be linear, branched, cyclic, or combinations of two or more thereof. The alkyl groups are exemplified by methyl, ethyl, propyl (including n-propyl and/or isopropyl), butyl (including n-butyl, tert-butyl, sec-butyl, and/or isobutyl); pentyl, hexyl, heptyl, octyl, decyl, dodecyl, undecyl, and octadecyl (and branched isomers having 5 to 18 carbon atoms), and the alkyl groups are further exemplified by cycloalkyl groups such as cyclopropyl, cyclobutyl, cyclopentyl, and cyclohexyl. Alternatively, the alkyl group for R⁴ may be selected from the group consisting of methyl, ethyl, propyl and butyl; alternatively methyl, ethyl, and propyl; alternatively methyl and ethyl. Alternatively, the alkyl group for R⁴ may be methyl.

Suitable aryl groups for R⁴ may be monocyclic or polycyclic and may have pendant hydrocarbyl groups. For example, the aryl groups for R⁴ include phenyl, tolyl, xylyl, and naphthyl and further include aralkyl groups such as benzyl, 1-phenylethyl and 2-phenylethyl. Alternatively, the aryl group for R⁴ may be monocyclic, such as phenyl, tolyl, or benzyl; alternatively the aryl group for R⁴ may be phenyl.

Suitable hydrocarbonoxy-functional groups for R⁴ may have the formula —OR⁵ or the formula —OR³—OR⁵, where each R³ is an independently selected divalent hydrocarbyl group of 1 to 18 carbon atoms, and each R⁵ is independently selected from the group consisting of the alkyl groups of 1-18 carbon atoms and the aryl groups of 6-18 carbon atoms, which are as described and exemplified above for R⁴. Examples of divalent hydrocarbyl groups for R³ include alkylene group such as ethylene, propylene, butylene, or hexylene; an arylene group such as phenylene, or an alkylarylene group such as:

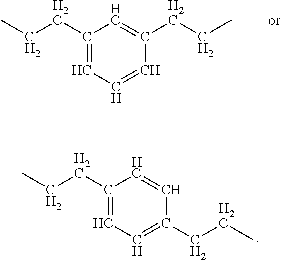

Alternatively, R³ may be an alkylene group such as ethylene. Alternatively, the hydrocarbonoxy-functional group may be an alkoxy-functional group such as methoxy, ethoxy, propoxy, or butoxy; alternatively methoxy or ethoxy, and alternatively methoxy.

Suitable acyloxy groups for R⁴ may have the formula

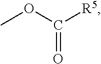

where R⁵ is as described above. Examples of suitable acyloxy groups include acetoxy.

Alternatively, the carbinol functional organosilicon compound may comprise a carbinol-functional polyorganosiloxane of unit formula (C2-1): (R⁴₃SiO_{1/2})ₐ(R⁴₂R^{Car}SiO_{1/2})_{b}(R⁴₂SiO_{2/2})_{c}(R⁴R^{Car}SiO_{2/2})_{d}(R⁴SiO_{3/2})ₑ(R^{Car}SiO_{3/2})_{f}(SiO_{4/2})_{g}(ZO_{1/2})ₕ; where R^{Car} is as described above; each R⁴ is independently selected from the group consisting of an alkyl group of 1 to 18 carbon atoms and an aryl group of 6 to 18 carbon atoms; each Z is independently selected from the group consisting of a hydrogen atom and R⁵, where each R⁵ is independently selected from the group consisting of an alkyl group of 1 to 18 carbon atoms and an aryl group of 6 to 18 carbon atoms; subscripts a, b, c, d, e, f, and g represent average numbers of each unit in formula (C2-1) and have values such that subscript a≥0, subscript b≥0, subscript c≥0, subscript d≥0, subscript e≥0, subscript f≥0, subscript g≥0; and subscript h has a value such that 0≤h/(e+f+g)≤1.5, 10,000 (a+b+c+d+e+f+g)≥2, and a quantity (b+d+f)>1. When e=f=g=0, then h≥0. Alternatively, in formula (C2-1), each R⁴ may be independently selected from the group consisting of a hydrogen atom, an alkyl group of 1 to 18 carbon atoms, an aryl group of 6 to 18 carbon atoms, and a hydrocarbonoxy-functional group of 1 to 18 carbon atoms. Alternatively, each R⁴ may be independently selected from the group consisting of an alkyl group of 1 to 18 carbon atoms, an aryl group of 6 to 18 carbon atoms, and an alkoxy-functional group of 1 to 18 carbon atoms. Alternatively, each R⁴ in formula (C2-1) may be independently selected from the group consisting of an alkyl group of 1 to 18 carbon atoms and an aryl group of 6 to 18 carbon atoms. Alternatively, each Z may be hydrogen or an alkyl group of 1 to 6 carbon atoms, e.g., the alkyl groups described an exemplified above for R⁴ that have 1 to 6 carbon atoms. Alternatively, each Z in formula (C2-1) may be hydrogen.

Alternatively, (C2) the carbinol-functional polyorganosiloxane may comprise (C2-2) a linear polydiorganosiloxane having, per molecule, at least one carbinol-functional group; alternatively at least two carbinol-functional groups (e.g., when in the formula (C2-1) for the carbinol-functional polyorganosiloxane above, subscripts e=f=g=0). For example, said polydiorganosiloxane may comprise unit formula (C2-3): (R⁴₃SiO_{1/2})ₐ(R^{Car}R⁴₂SiO_{1/2})_{b}(R⁴₂SiO_{2/2})_{c}(R^{Car}R⁴SiO_{2/2})ₐ, where R^{Car} and R⁴ are as described above for formula (C2-1), subscript a is 0, 1, or 2; subscript b is 0, 1, or 2, subscript c≥0, subscript d≥0, with the provisos that a quantity (b+d)≥1, a quantity (a+b)=2, and a quantity (a+b+c+d)≥2. Alternatively, in the unit formula (C2-3) for the linear carbinol-functional polydiorganosiloxane, above, the quantity (a+b+c+d) may be at least 3, alternatively at least 4, and alternatively >50. At the same time said formula, the quantity (a+b+c+d) may be less than or equal to 10,000; alternatively less than or equal to 4,000; alternatively less than or equal to 2,000; alternatively less than or equal to 1,000; alternatively less than or equal to 500; alternatively less than or equal to 250. Alternatively, in the unit formula for the linear carbinol-functional polyorganosiloxane, each R⁴ may be independently selected from the group consisting of alkyl and aryl; alternatively methyl and phenyl. Alternatively, each R⁴ in said formula may be an alkyl group; alternatively each R⁴ may be methyl.

Alternatively, the linear carbinol-functional polydiorganosiloxane of unit formula (C2-3) may be selected from the group consisting of: unit formula (C2-4): (R⁴₂R^{Car}SiO_{1/2})₂(R⁴₂SiO_{2/2})ₘ(R⁴R^{Car}SiO_{2/2})ₙ, unit formula (C2-5): (R⁴₃SiO_{1/2})₂(R⁴₂SiO_{2/2})ₒ(R⁴R^{Car}SiO_{2/2})ₚ, or a combination of both (C2-4) and (C2-5).

In formulae (C2-4) and (C2-5), each R⁴ and R^{Car} are as described above for formula (C2-1). Subscript m may be 0 or a positive number. Alternatively, subscript m may be at least 2. Alternatively subscript m be 2 to 2,000. Subscript n may be 0 or a positive number. Alternatively, subscript n may be 0 to 2000. Subscript o may be 0 or a positive number. Alternatively, subscript o may be 0 to 2000. Subscript p is at least 2. Alternatively subscript p may be 2 to 2000.

Starting material (C2) may comprise a carbinol-functional polydiorganosiloxane such as i) bis-dimethyl(propyl-carbinol)siloxy-terminated polydimethylsiloxane, ii) bis-dimethyl(propyl-carbinol)siloxy-terminated poly(dimethylsiloxane/methyl(propyl-carbinol)siloxane), iii) bis-dimethyl(propyl-carbinol)siloxy-terminated polymethyl(propyl-carbinol)siloxane, iv) bis-trimethylsiloxy-terminated poly(dimethylsiloxane/methyl(propyl-carbinol)siloxane), v) bis-trimethylsiloxy-terminated polymethyl(propyl-carbinol)siloxane, vi) bis-dimethyl(propyl-carbinol)siloxy-terminated poly(dimethylsiloxane/methylphenylsiloxane/methyl(propyl-carbinol)siloxane), vii) bis-dimethyl(propyl-carbinol)siloxy-terminated poly(dimethylsiloxane/methylphenylsiloxane), viii) bis-dimethyl(propyl-carbinol)siloxy-terminated poly(dimethylsiloxane/diphenylsiloxane), ix) bis-phenyl, methyl, (propyl-carbinol)-siloxy-terminated polydimethylsiloxane, x) bis-dimethyl(heptyl-carbinol)siloxy-terminated polydimethylsiloxane, xi) bis-dimethyl(heptyl-carbinol)siloxy-terminated poly(dimethylsiloxane/methyl(heptyl-carbinol)siloxane), xii) bis-dimethyl(heptyl-carbinol)siloxy-terminated polymethyl(heptyl-carbinol)siloxane, xiii) bis-trimethylsiloxy-terminated poly(dimethylsiloxane/methyl(heptyl-carbinol)siloxane), xiv) bis-trimethylsiloxy-terminated polymethyl(heptyl-carbinol)siloxane, xv) bis-dimethyl(heptyl-carbinol)-siloxy terminated poly(dimethylsiloxane/methylphenylsiloxane/methyl(heptyl-carbinol)siloxane), xvi) bis-dimethyl(propyl-carbinol)siloxy-terminated poly(dimethylsiloxane/methyl(heptyl-carbinol)siloxane), xvii) bis-dimethyl(heptyl-carbinol)-siloxy-terminated poly(dimethylsiloxane/methylphenylsiloxane), xviii) dimethyl(heptyl-carbinol)-siloxy-terminated poly(dimethylsiloxane/diphenylsiloxane), and xix) a combination of two or more of i) to xviii).

Alternatively, (C2) the carbinol-functional polyorganosiloxane may be cyclic, e.g., when in unit formula (C2-1), subscripts a=b=c=e=f=g=h=0. The (C2-6) cyclic carbinol-functional polydiorganosiloxane may have unit formula (C2-7): (R⁴R^{Car}SiO_{2/2})ₐ, where R^{Car} and R⁴ are as described above for formula (C2-1), and subscript d may be 3 to 12, alternatively 3 to 6, and alternatively 4 to 5. Examples of cyclic carbinol-functional polydiorganosiloxanes include 2,4,6-trimethyl-2,4,6-tri (propyl-carbinol)-cyclotrisiloxane, 2,4,6,8-tetramethyl-2,4,6,8-tetra(propyl-carbinol)-cyclotetrasiloxane, 2,4,6,8,10-pentamethyl-2,4,6,8,10-penta (propyl-carbinol)-cyclopentasiloxane, and 2,4,6,8,10,12-hexamethyl-2,4,6,8,10,12-hexa (propyl-carbinol)-cyclohexasiloxane.

Alternatively, (C2-6) the cyclic carbinol-functional polydiorganosiloxane may have unit formula (C2-8): (R⁴₂SiO_{2/2})_{c}(R⁴R^{Car}SiO_{2/2})ₐ, where R⁴ and R^{Car} are as described above for formula (C2-1), subscript c is >0 to 6 and subscript d is 3 to 12. Alternatively, in formula (C2-8), a quantity (c+d) may be 3 to 12. Alternatively, in formula (C2-8), c may be 3 to 6, and d may be 3 to 6.

Alternatively, (C2) the carbinol-functional polyorganosiloxane may be (C2-9) oligomeric, e.g., when in unit formula (C2-1) above the quantity (a+b+c+d+e+f+g)≤50, alternatively ≤40, alternatively ≤30, alternatively ≤25, alternatively ≤20, alternatively ≤10, alternatively ≤5, alternatively ≤4, alternatively ≤3. The oligomer may be cyclic, linear, branched, or a combination thereof. The cyclic oligomers are as described above as starting material (C2-6).

Examples of linear carbinol-functional polyorganosiloxane oligomers may have formula (C2-10):

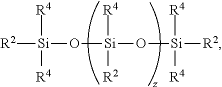

where R⁴ is as described above in formula (C2-1), each R² is independently selected from the group consisting of R⁴ and R^{Car}, with the proviso that at least one R², per molecule, is R^{Car}, and subscript z is 0 to 48. Examples of linear carbinol-functional polyorganosiloxane oligomers include 1,3-di(propyl-carbinol)-1,1,3,3-tetramethyldisiloxane; 1,1,1,3,3-pentamethyl-3-(propyl-carbinol)-disiloxane; and 1,1,1,3,5,5,5-heptamethyl-3-(propyl-carbinol)-trisiloxane.

Alternatively, the carbinol-functional polyorganosiloxane oligomer may be branched. The branched oligomer may have general formula (C2-11): R^{Car}SiR¹²₃, where R^{Car} is as described above in formula (C2-1), and each R¹² is selected from R¹³ and —OSi(R¹⁴)₃; where each R¹³ is a monovalent hydrocarbon group; where each R¹⁴ is selected from R¹³, —OSi(R¹⁵)₃, and —[OSiR¹³₂]ᵢᵢOSiR¹³₃; where each R¹⁵ is selected from R¹³, —OSi(R¹⁶)₃, and —[OSiR¹³₂]ᵢᵢOSiR¹³₃; where each R¹⁶ is selected from R¹³ and —[OSiR¹³₂]ᵢᵢOSiR¹³₃; and where subscript ii has a value such that 0≤ii≤100. At least two of R¹² may be —OSi(R¹⁴) 3. Alternatively, all three of R¹² may be —OSi(R¹⁴)₃.

Alternatively, in formula (C2-11) when each R¹² is —OSi(R¹⁴)₃, each R¹⁴ may be —OSi(R¹⁵)₃ moieties such that the branched polyorganosiloxane oligomer has the following structure:

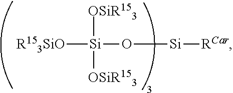

where R^{Car} and R¹⁵ are as described above. Alternatively, each R¹⁵ may be an R¹³, as described above, and each R¹³ may be methyl.

Alternatively, in formula (C2-11), when each R¹² is —OSi(R¹⁴)₃, one R¹⁴ may be R¹³ in each —OSi(R¹⁴)₃ such that each R¹² is —OSiR¹³(R¹⁴)₂. Alternatively, two R¹⁴ in —OSiR¹³(R¹⁴)₂ may each be —OSi(R¹⁵)₃ moieties such that the branched carbinol-functional polyorganosiloxane oligomer has the following structure:

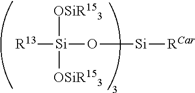

where R^{Car}, R¹³, and R¹⁵ are as described above. Alternatively, each R¹⁵ may be an R¹³, and each R¹³ may be methyl.

Alternatively, in formula (C2-11), one R¹² may be R¹³, and two of R¹² may be —OSi(R¹⁴)₃. When two of R¹² are —OSi(R¹⁴)₃, and one R¹⁴ is R¹³ in each —OSi(R¹⁴)₃ then two of R¹² are —OSiR¹³(R¹⁴)₂. Alternatively, each R¹⁴ in —OSiR¹³(R¹⁴)₂ may be —OSi(R¹⁵)₃ such that the branched polyorganosiloxane oligomer has the following structure:

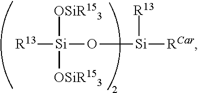

where R^{Car}, R¹³, and R¹⁵ are as described above. Alternatively, each R¹⁵ may be an R¹³, and each R¹³ may be methyl. Alternatively, the carbinol-functional branched polyorganosiloxane may have 3 to 16 silicon atoms per molecule, alternatively 4 to 16 silicon atoms per molecule, and alternatively 4 to 10 silicon atoms per molecule. Examples of carbinol-functional branched polyorganosiloxane oligomers include propyl-carbinol-tris(trimethyl)siloxy)silane (also named 3-(1,1,1,5,5,5-hexamethyl-3-((trimethylsilyl)oxy)trisiloxan-3-yl)propan-1-ol), which has formula:

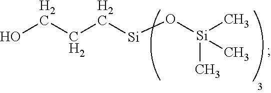

methyl-(propyl-carbinol)-di((1,1,1,3,5,5,5-heptamethyltrisiloxan-3-yl)oxy)-silane (also named 3,3-(1,1,1,3,5,7,9,9,9-nonamethyl-3,7-bis((trimethylsilyl)oxy)pentasiloxan-5-yl)propan-1-ol), which has formula

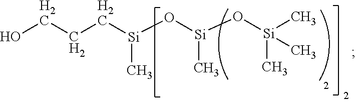

propyl-carbinol)-tris((1,1,1,3,5,5,5-heptamethyltrisiloxan-3-yl)oxy)-silane (also named 3-(5-((1,1,1,3,5,5,5-heptamethyltrisiloxan-3-yl)oxy)-1,1,1,3,7,9,9,9-octamethyl-3,7-bis((trimethylsilyl)oxy)pentasiloxan-5-yl)propan-1-ol), which has formula

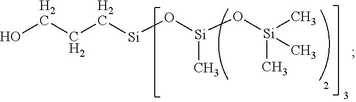

and (heptyl-carbinol)-tris((1,1,1,3,5,5,5-heptamethyltrisiloxan-3-yl)oxy)-silane (also named 7-(5-((1,1,1,3,5,5,5-heptamethyltrisiloxan-3-yl)oxy)-1,1,1,3,7,9,9,9-octamethyl-3,7-bis((trimethylsilyl)oxy)pentasiloxan-5-yl) heptan-1-ol), which has formula

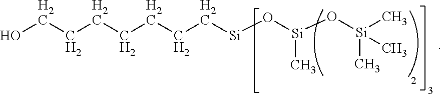

Alternatively, (C2) the carbinol-functional polyorganosiloxane may be branched, such as the branched oligomer described above and/or a branched carbinol-functional polyorganosiloxane that may have, e.g., more carbinol groups per molecule and/or more polymer units than the branched oligomer described above (e.g., in formula (C2-1) when the quantity (a+b+c+d+e+f+g)>50). The branched carbinol-functional polyorganosiloxane may have (in formula (C2-1)) a quantity (e+f+g) sufficient to provide >0 mol % to 5 mol % of trifunctional and/or quadrifunctional units to the branched carbinol-functional polyorganosiloxane.

For example, the branched carbinol-functional polyorganosiloxane may comprise a Q branched polyorganosiloxane of unit formula (C2-13): (R⁴₃SiO_{1/2})_{g}(R⁴₂R^{Car}SiO_{1/2})+ (R⁴₂SiO_{2/2}) s (SiO_{4/2}) t, where R⁴ and R^{Car} are as described above in formula (C2-1), and subscripts q, r, s, and t have average values such that 2≥q≥0, 4≥r≥0, 995≥s≥4, t=1, (q+r)=4, and a quantity (q+r+s+t) has a value sufficient to impart a viscosity >170 mPa·s measured by rotational viscometry (as described below with the test methods) to the branched polyorganosiloxane. Alternatively, viscosity may be >170 mPa·s to 1000 mPa·s, alternatively >170 to 500 mPa·s, alternatively 180 mPa·s to 450 mPa·s, and alternatively 190 mPa·s to 420 mPa·s.

Alternatively, the branched carbinol-functional polyorganosiloxane may comprise formula (C2-14): [R^{Car}R⁴₂Si—(O—SiR⁴₂)ₓ—O]_{(4-w)}—Si—[O—(R⁴₂SiO)ᵥSiR⁴₃]_{w}, where R^{Car} and R⁴ are as described above in formula (C2-1); and subscripts v, w, and x have values such that 200≥v≥1, 2≥w≥0, and 200≥x≥1. Alternatively, in this formula (C2-14), each R⁴ is independently selected from the group consisting of methyl and phenyl, and each R^{Car} has the formula above, wherein G has 2, 3, or 6 carbon atoms.

Alternatively, the branched carbinol-functional polyorganosiloxane for starting material (C2-11) may comprise a T branched polyorganosiloxane (silsesquioxane) of unit formula (C2-15): (R⁴₃SiO_{1/2})ₐₐ(R^{Car}R⁴₂SiO_{1/2})_{bb}(R⁴₂SiO_{2/2})_{cc}(R^{Car}R⁴SiO_{2/2})ₑₑ(R⁴SiO_{3/2})_{dd}, where R⁴ and R^{Car} are as described above in formula (C2-1), subscript aa≥0, subscript bb>0, subscript cc is 15 to 995, subscript dd>0, and subscript ee≥0. Subscript aa may be 0 to 10. Alternatively, subscript aa may have a value such that: 12≥aa≥0; alternatively 10≥aa≥0; alternatively 7≥aa≥0; alternatively 5≥aa≥0; and alternatively 3≥aa≥0. Alternatively, subscript bb≥1. Alternatively, subscript bb≥3. Alternatively, subscript bb may have a value such that: 12≥bb>0; alternatively 12≥bb≥3; alternatively 10≥bb>0; alternatively 7≥bb>1; alternatively 5≥bb≥2; and alternatively 7≥bb≥3. Alternatively, subscript cc may have a value such that: 800≥cc≥15; and alternatively 400≥cc≥15. Alternatively, subscript ee may have a value such that: 800≥ee≥0; 800≥ee≥15; and alternatively 400≥ee≥15. Alternatively, subscript ee may b 0. Alternatively, a quantity (cc+ee) may have a value such that 995≥(cc+ee)≥15. Alternatively, subscript dd≥1. Alternatively, subscript dd may be 1 to 10. Alternatively, subscript dd may have a value such that: 10≥dd>0; alternatively 5≥dd>0; and alternatively dd=1. Alternatively, subscript dd may be 1 to 10, alternatively subscript dd may be 1 or 2. Alternatively, when subscript dd=1, then subscript bb may be 3 and subscript cc may be 0. The values for subscript bb may be sufficient to provide the silsesquioxane of unit formula (C2-15) with a carbinol content of 0.1% to 1%, alternatively 0.2% to 0.6%, based on the weight of the silsesquioxane.

Alternatively, (C2) the carbinol-functional polyorganosiloxane may comprise a carbinol-functional polyorganosiloxane resin, such as a carbinol-functional polyorganosilicate resin and/or a carbinol-functional silsesquioxane resin. Such resins may be prepared, for example, by hydroformylating an alkenyl-functional polyorganosiloxane resin as described below and subsequently hydrogenating the resulting aldehyde-functional polyorganosiloxane resin. The carbinol-functional polyorganosilicate resin comprises monofunctional units (“M′” units) of formula R^{M′}₃SiO_{1/2} and tetrafunctional silicate units (“Q” units) of formula SiO_{4/2}, where each R^{M′} may be independently selected from the group consisting of R⁴ and R^{Car} as described above. Alternatively, each R^{M′} may be selected from the group consisting of an alkyl group, a carbinol-functional group of the formula shown above, and an aryl group. Alternatively, each R^{M′} may be selected from methyl, (propyl-carbinol) and phenyl. Alternatively, at least one-third, alternatively at least two thirds of the R^{M′} groups are methyl groups. Alternatively, the M′ units may be exemplified by (Me₃SiO_{1/2}), (Me₂PhSiO_{1/2}), and (Me₂R^{Car}SiO_{1/2}), where R^{Car} is as described in formula (C2-1). The polyorganosilicate resin is soluble in solvents such as by liquid hydrocarbons, such as benzene, ethylbenzene, toluene, xylene, and heptane, or in liquid non-functional organosilicon compounds such as low viscosity linear and cyclic polydiorganosiloxanes.

When prepared, the polyorganosilicate resin comprises the M′ and Q units described above, and the polyorganosiloxane further comprises units with silicon bonded hydroxyl groups, and/or hydrolyzable groups, described by moiety (ZO_{1/2}), above, and may comprise neopentamer of formula Si(OSiR^{M′}₃)₄, where R^{M′} is as described above, e.g., the neopentamer may be tetrakis(trimethylsiloxy)silane. ²⁹Si NMR and ¹³C NMR spectroscopies may be used to measure hydroxyl and alkoxy content and molar ratio of M′ and Q units, where said ratio is expressed as {M′(resin)}/{Q(resin)}, excluding M′ and Q units from the neopentamer. M′/Q ratio represents the molar ratio of the total number of triorganosiloxy groups (M′ units) of the resinous portion of the polyorganosilicate resin to the total number of silicate groups (Q units) in the resinous portion. M′/Q ratio may be 0.5/1 to 1.5/1, alternatively 0.6/1 to 0.9/1.

The Mn of the polyorganosilicate resin depends on various factors including the types of hydrocarbon groups represented by R^{M′} that are present. The Mn of the polyorganosilicate resin refers to the number average molecular weight measured using GPC, when the peak representing the neopentamer is excluded from the measurement. The Mn of the polyorganosilicate resin may be 1,500 Da to 30,000 Da, alternatively 1,500 Da to 15,000 Da; alternatively >3,000 Da to 8,000 Da. Alternatively, Mn of the polyorganosilicate resin may be 3,500 Da to 8,000 Da.

Alternatively, the polyorganosilicate resin may comprise unit formula (C2-17): (R⁴₃SiO_{1/2})ₘₘ(R⁴₂R^{Car}SiO_{1/2})ₙₙ(SiO_{4/2})ₒₒ(ZO_{1/2})ₕ, where Z, R⁴, and R^{Car}, and subscript h are as described above in formula (C2-1), and subscripts mm, nn and oo have average values such that mm≥0, nn>0, oo>0, and 0.5≤(mm+nn)/oo≤4. Alternatively, 0.6<(mm+nn)/oo≤4; alternatively 0.7≤(mm+nn)/oo≤4, and alternatively 0.8≤(mm+nn)/oo≤4.

Alternatively, (C2) the carbinol-functional polyorganosiloxane may comprise (C2-18) a carbinol-functional silsesquioxane resin, i.e., a resin containing trifunctional (T′) units of unit formula: (R⁴₃SiO_{1/2})ₐ(R⁴₂R^{Car}SiO_{1/2})_{b}(R⁴₂SiO_{2/2})_{c}(R⁴R^{CarA}SiO_{2/2})_{d}(R⁴SiO_{3/2})ₑ(R^{Car}SiO_{3/2})_{f}(ZO_{1/2})ₕ; where R⁴ and R^{Car} are as described above in formula (C2-1), subscript f>1, 2<(e+f)<10,000; 0<(a+b)/(e+f)<3; 0<(c+d)/(e+f)<3; and 0<h/(e+f)<1.5. Alternatively, the carbinol-functional silsesquioxane resin may comprise unit formula (C2-19): (R⁴SiO_{3/2})ₑ(R^{Car}SiO_{3/2})_{f}(ZO_{1/2})ₕ, where R⁴, R^{Car}, Z, and subscripts h, e and f are as described above. Alternatively, the carbinol-functional silsesquioxane resin may further comprise difunctional (D′) units of formulae (R⁴₂SiO_{2/2})_{c}(R⁴R^{Car}SiO_{2/2}) a in addition to the T units described above, i.e., a D′T′ resin, where subscripts c and d are as described above. Alternatively, the carbinol-functional silsesquioxane resin may further comprise monofunctional (M′) units of formulae (R⁴₃SiO_{1/2})ₐ(R⁴₂R^{Car}SiO_{1/2})_{b}, i.e., an M′D′T′ resin, where subscripts a and b are as described above for unit formula (C2-1).

Starting material (C) may be any one of the carbinol-functional organosilicon compounds described above. Alternatively, starting material (C) may comprise a mixture of two or more of the carbinol-functional organosilicon compounds. The amount of starting material (C) is not critical. However, starting materials (A) and (C) may be present in a weight ratio (A)/(C) of 0.01/1 to 99/1; alternatively 0.05/1 to 95/1.

Carbinol-functional organosilicon compounds are known in the art and may be made by known methods. For example, U.S. Pat. No. 5,290,901 to Burns, et al. discloses a method for preparation of carbinol-functional organosiloxanes. Carbinol-functional organosilicon compounds are also commercially available. For example, bis(3-hydroxypropyl)-1,1,3,3-tetramethyl-disiloxane is commercially available from Gelest, Inc. of Morrisville, Pennsylvania, USA. Alternatively, bis-hydroxyethoxypropyl polydimethylsiloxane (DOWSIL™ 5562 Carbinol Fluid) and a carbinol ended linear siloxane with tradename DOWSIL™ 2-5558 are commercially available from Dow Silicones Corporation of Midland, Michigan, USA. Alternatively, the carbinol-functional organosilicon compound may be prepared by hydrogenation of an aldehyde-functional organosilicon compound.

### Aldehyde-Functional Organosilicon Compound

Aldehyde-functional organosilicon compounds suitable for use in the method described herein are known and may be made by known methods, such as those described in U.S. Pat. No. 4,424,392 to Petty; U.S. Pat. No. 5,021,601 to Frances et al.; U.S. Pat. No. 5,739,246 to Graiver et al.; U.S. Pat. No. 7,696,294 to Asirvatham; and U.S. Pat. No. 7,999,053 to Sutton et al.; European Patent Application Publication EP 0 392 948 A1 to Frances; and PCT Patent Application Publication WO2006027074 to Kühnle et al.

Alternatively, the aldehyde-functional organosilicon compound may be prepared by a hydroformylation process. This hydroformylation process comprises 1) combining, under conditions to catalyze hydroformylation reaction, starting materials comprising (A) a gas comprising hydrogen and carbon monoxide, (B) an alkenyl-functional organosilicon compound, and (C) hydroformylation reaction catalyst such as a rhodium/bisphosphite ligand complex catalyst, thereby forming a hydroformylation reaction product comprising the aldehyde-functional organosilicon compound.

The hydroformylation process described herein employs starting materials comprising: (A) a gas comprising hydrogen and carbon monoxide, (B) an alkenyl-functional organosilicon compound, and (C) a rhodium/bisphosphite ligand catalyst. The starting materials may optionally further comprise: (D) a solvent.

Starting material (A), the gas used in the hydroformylation process, comprises carbon monoxide (CO) and hydrogen gas (H₂). For example, the gas may be syngas. As used herein, “syngas” (from synthesis gas) refers to a gas mixture that contains varying amounts of CO and H₂. Production methods are well known and include, for example: (1) steam reforming and partial oxidation of natural gas or liquid hydrocarbons, and (2) the gasification of coal and/or biomass. CO and H₂ typically are the main components of syngas, but syngas may contain carbon dioxide and inert gases such as CH₄, N₂ and Ar. The molar ratio of H₂ to CO(H₂:CO molar ratio) varies greatly but may range from 1:100 to 100:1, alternatively 1:10 and 10:1. Syngas is commercially available and is often used as a fuel source or as an intermediate for the production of other chemicals. Alternatively, CO and H₂ from other sources (i.e., other than syngas) may be used as starting material (A) herein. Alternatively, the H₂:CO molar ratio in starting material (A) for use herein may be 3:1 to 1:3, alternatively 2:1 to 1:2, and alternatively 1:1.

The alkenyl-functional organosilicon compound has, per molecule, at least one alkenyl group covalently bonded to silicon. Alternatively, the alkenyl-functional organosilicon compound may have, per molecule, more than one alkenyl group covalently bonded to silicon. Starting material (B) may be one alkenyl-functional organosilicon compound. Alternatively, starting material (B) may comprise two or more alkenyl-functional organosilicon compounds that differ from one another. For example, the alkenyl-functional organosilicon compound may comprise one or both of (B1) a silane and (B2) a polyorganosiloxane.

Starting material (B1), the alkenyl-functional silane, may have formula (B1-1): R^{A}ₓSiR⁴₍₄₋ₓ₎, where each R^{A} is an independently selected alkenyl group; each R⁴ is independently selected from the group consisting of an alkyl group of 1 to 18 carbon atoms, an aryl group of 6 to 18 carbon atoms, an acyloxy group of 2 to 18 carbon atoms, and a hydrocarbonoxy-functional group of 1 to 18 carbon atoms as described above; and subscript x is 1 to 4 as described above.

The alkenyl group for R^{A} may have terminal alkenyl functionality, e.g., R^{A} may have formula

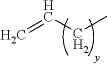

where subscript y is 0 to 6. Alternatively, each R^{A} may be independently selected from the group consisting of vinyl, allyl, and hexenyl. Alternatively, each R^{A} may be independently selected from the group consisting of vinyl and allyl. Alternatively, each R^{A} may be independently selected from the group consisting of vinyl and hexenyl. Alternatively, each R^{A} may be vinyl. Alternatively, each R^{A} may be allyl. Alternatively, each R^{A} may be hexenyl.

Alkenyl-functional acyloxysilanes and methods for their preparation are known in the art, for example, in U.S. Pat. No. 5,387,706 to Rasmussen, et al. and U.S. Pat. No. 5,902,892 to Larson, et al.

Suitable alkenyl-functional silanes are exemplified by alkenyl-functional trialkylsilanes such as vinyltrimethylsilane, vinyltriethylsilane, and allyltrimethylsilane; alkenyl-functional trialkoxysilanes such as allyltrimethoxysilane, vinyltrimethoxysilane, vinyltriethoxysilane, vinyltriisopropoxysilane, and vinyltris(methoxyethoxy)silane; alkenyl-functional dialkoxysilanes such as vinylphenyldiethoxysilane, vinylmethyldimethoxysilane, and vinylmethyldiethoxysilane; alkenyl-functional monoalkoxysilanes such as trivinylmethoxysilane; alkenyl-functional triacyloxysilanes such as vinyltriacetoxysilane, and alkenyl-functional diacyloxysilanes such as vinylmethyldiacetoxysilane. All of these alkenyl-functional silanes are commercially available from Gelest Inc. of Morrisville, Pennsylvania, USA. Furthermore, alkenyl-functional silanes may be prepared by known methods, such as those disclosed in U.S. Pat. No. 4,898,961 to Baile, et al. and U.S. Pat. No. 5,756,796 to Davern, et al.

Alternatively, (B) the alkenyl-functional organosilicon compound may comprise (B2) an alkenyl-functional polyorganosiloxane. Said polyorganosiloxane may be cyclic, linear, branched, resinous, or a combination of two or more thereof. Said polyorganosiloxane may comprise unit formula (B2-1): (R⁴₃SiO_{1/2})ₐ(R⁴₂R^{A}SiO_{1/2})_{b}(R⁴₂SiO_{2/2})_{c}(R⁴R^{A}SiO_{2/2})ₐ(R⁴SiO_{3/2})ₑ(R^{A}SiO_{3/2})_{f}(SiO_{4/2})_{g}(ZO_{1/2})ₕ; where R^{A} is an alkenyl group as described above for formula (B1-1), and R⁴, Z, and subscripts a, b, c, d, e, f, and g have values as described above with respect to formula (C2-1) for the carbinol-functional polyorganosiloxane.

Alternatively, (B2) the alkenyl-functional polyorganosiloxane may comprise (B2-2) a linear polydiorganosiloxane having, per molecule, at least one alkenyl group; alternatively at least two alkenyl groups (e.g., when in formula (B2-1) above, subscripts e=f=g=0). For example, said polydiorganosiloxane may comprise unit formula (B2-3): (R⁴₃SiO_{1/2})ₐ(R^{A}R⁴₂SiO_{1/2})_{b}(R⁴₂SiO_{2/2})_{c}(R^{A}R⁴SiO_{2/2})ₐ, where R^{A} is as described above for formula (B1-1), and R⁴ and subscripts a, b, c, and d, are as described above for formula (C2-3).

Alternatively, the polydiorganosiloxane of unit formula (B2-3) may be selected from the group consisting of: unit formula (B2-4): (R⁴₂R^{A}SiO_{1/2})₂(R⁴₂SiO_{2/2})ₘ(R⁴R^{A}SiO_{2/2})ₙ, unit formula (B2-5): (R⁴₃SiO_{1/2})₂(R⁴₂SiO_{2/2})ₒ(R⁴R^{A}SiO₂₂)ₚ, or a combination of both (B2-4) and (B2-5). In formulae (B2-4) and (B2-5), each R^{A} is as described above for formula (B1-1), R⁴ is as described above for formula (C2-1), and subscripts m, n, o, and p are as described above for formulas (C2-4) and (C2-5).

Starting material (B2) may comprise an alkenyl-functional polydiorganosiloxane such as i) bis-dimethylvinylsiloxy-terminated polydimethylsiloxane, ii) bis-dimethylvinylsiloxy-terminated poly(dimethylsiloxane/methylvinylsiloxane), iii) bis-dimethylvinylsiloxy-terminated polymethylvinylsiloxane, iv) bis-trimethylsiloxy-terminated poly(dimethylsiloxane/methylvinylsiloxane), v) bis-trimethylsiloxy-terminated polymethylvinylsiloxane, vi) bis-dimethylvinylsiloxy-terminated poly(dimethylsiloxane/methylphenylsiloxane/methylvinylsiloxane), vii) bis-dimethylvinylsiloxy-terminated poly(dimethylsiloxane/methylphenylsiloxane), viii) bis-dimethylvinylsiloxy-terminated poly(dimethylsiloxane/diphenylsiloxane), ix) bis-phenyl, methyl, vinyl-siloxy-terminated polydimethylsiloxane, x) bis-dimethylhexenylsiloxy-terminated polydimethylsiloxane, xi) bis-dimethylhexenylsiloxy-terminated poly(dimethylsiloxane/methylhexenylsiloxane), xii) bis-dimethylhexenylsiloxy-terminated polymethylhexenylsiloxane, xiii) bis-trimethylsiloxy-terminated poly(dimethylsiloxane/methylhexenylsiloxane), xiv) bis-trimethylsiloxy-terminated polymethylhexenylsiloxane, xv) bis-dimethylhexenyl-siloxy terminated poly(dimethylsiloxane/methylphenylsiloxane/methylhexenylsiloxane), xvi) bis-dimethylvinylsiloxy-terminated poly(dimethylsiloxane/methylhexenylsiloxane), xvii) bis-dimethylhexenyl-siloxy-terminated poly(dimethylsiloxane/methylphenylsiloxane), xviii) dimethylhexenyl-siloxy-terminated poly(dimethylsiloxane/diphenylsiloxane), and xix) a combination of two or more of i) to xviii).

Methods of preparing linear alkenyl-functional polydiorganosiloxanes described above for starting material (B2), such as hydrolysis and condensation of the corresponding organohalosilanes and oligomers or equilibration of cyclic polydiorganosiloxanes, are known in the art, see for example U.S. Pat. Nos. 3,284,406; 4,772,515; 5,169,920; 5,317,072; and 6,956,087, which disclose preparing linear polydiorganosiloxanes with alkenyl groups. Examples of linear polydiorganosiloxanes having alkenyl groups are commercially available from, e.g., Gelest Inc. of Morrisville, Pennsylvania, USA under the tradenames DMS-V00, DMS-V03, DMS-V05, DMS-V21, DMS-V22, DMS-V25, DMS-V-31, DMS-V33, DMS-V34, DMS-V35, DMS-V41, DMS-V42, DMS-V43, DMS-V46, DMS-V51, DMS-V52.

Alternatively, (B2) the alkenyl-functional polyorganosiloxane may be cyclic, e.g., when in unit formula (B2-1), subscripts a=b=c=e=f=g=h=0. The cyclic alkenyl-functional polydiorganosiloxane may have unit formula (B2-7): (R⁴R^{A}SiO_{2/2})ₐ, where R^{A} is as described above for formula (B1-1), R⁴ is as described above for formula (C2-1), and subscript d is as described above for formula (C2-7). Examples of cyclic alkenyl-functional polydiorganosiloxanes include 2,4,6-trimethyl-2,4,6-trivinyl-cyclotrisiloxane, 2,4,6,8-tetramethyl-2,4,6,8-tetravinyl-cyclotetrasiloxane, 2,4,6,8,10-pentamethyl-2,4,6,8,10-pentavinyl-cyclopentasiloxane, and 2,4,6,8,10,12-hexamethyl-2,4,6,8,10,12-hexavinyl-cyclohexasiloxane. These cyclic alkenyl-functional polydiorganosiloxanes are known in the art and are commercially available from, e.g., Sigma-Aldrich of St. Louis, Missouri, USA; Milliken of Spartanburg, South Carolina, USA; and other vendors.

Alternatively, the cyclic alkenyl-functional polydiorganosiloxane may have unit formula (B2-8): (R⁴₂SiO_{2/2})_{c}(R⁴R^{A}SiO_{2/2})ₐ, where R^{A} is as described above for formula (B1-1), R⁴ is as described above for formula (C2-1), and subscripts c and d are as described above for formula (C2-8).

Alternatively, (B2) the alkenyl-functional polyorganosiloxane may be oligomeric, e.g., when in unit formula (B2-1) above the quantity (a+b+c+d+e+f+g)≤50, alternatively ≤ 40, alternatively ≤30, alternatively ≤25, alternatively ≤20, alternatively ≤10, alternatively ≤5, alternatively ≤4, alternatively ≤3. The oligomer may be cyclic, linear, branched, or a combination thereof. The cyclic oligomers are as described above as starting material (B2-6).

Examples of linear alkenyl-functional polyorganosiloxane oligomers may have formula (B2-10):

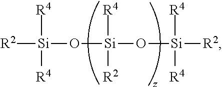

where R⁴ is as described above for formula (C2-1), each R² is independently selected from the group consisting of R⁴ and R^{A}, with the proviso that at least one R², per molecule, is R^{A}, and subscript z is 0 to 48. Examples of linear alkenyl-functional polyorganosiloxane oligomers may have include 1,3-divinyl-1,1,3,3-tetramethyldisiloxane; 1,1,1,3,3-pentamethyl-3-vinyl-disiloxane; 1,1,1,3,5,5,5-heptamethyl-3-vinyl-trisiloxane, all of which are commercially available, e.g., from Gelest, Inc. of Morrisville, Pennsylvania, USA or Sigma-Aldrich of St. Louis, Missouri, USA.

Alternatively, the alkenyl-functional polyorganosiloxane oligomer may be branched. The branched oligomer may have general formula (B2-11): R^{A}SiR¹²₃, where R^{A} is as described above for formula (B1-1), and each R¹² is selected from R¹³ and —OSi(R¹⁴)₃; where each R¹³ is a monovalent hydrocarbon group; where each R¹⁴ is selected from R¹³, —OSi(R¹⁵)₃, and —[OSiR¹³₂]ᵢᵢOSiR¹³₃; where each R¹⁵ is selected from R¹³, —OSi(R¹⁶)₃, and —[OSiR¹³₂]ᵢᵢOSiR¹³₃; where each R¹⁶ is selected from R¹³ and —[OSiR¹³₂]ᵢᵢOSiR¹³₃; and where subscript ii has a value such that 0≤ii≤100. At least two of R¹² may be —OSi(R¹⁴)₃. Alternatively, all three of R¹² may be —OSi(R¹⁴)₃.

Alternatively, in formula (B2-11) when each R¹² is —OSi(R¹⁴)₃, each R¹⁴ may be a —OSi(R¹⁵)₃ moiety such that the branched polyorganosiloxane oligomer has the following structure:

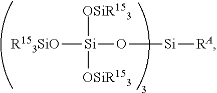

where R^{A} is as described above for formula (B1-1), and R 15 is as described above for formula (C2-11).

Alternatively, in formula (B2-11), when each R¹² is —OSi(R¹⁴)₃, one R¹⁴ may be R¹³ in each —OSi(R¹⁴)₃ such that each R¹² is —OSiR¹³(R¹⁴)₂. Alternatively, two R¹⁴ in —OSiR¹³(R¹⁴)₂ may each be —OSi(R¹⁵)₃ moieties such that the branched polyorganosiloxane oligomer has the following structure:

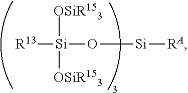

where R^{A} is as described above for formula (B1-1), and R¹³ and R¹⁵ is as described above for formula (C2-11).

Alternatively, in formula (B2-11), one R¹² may be R¹³, and two of R¹² may be —OSi(R¹⁴)₃. When two of R¹² are —OSi(R¹⁴)₃, and one R¹⁴ is R¹³ in each —OSi(R¹⁴)₃ then two of R¹² are —OSiR¹³(R¹⁴)₂. Alternatively, each R¹⁴ in —OSiR¹³(R¹⁴)₂ may be —OSi(R¹⁵)₃ such that the branched polyorganosiloxane oligomer has the following structure:

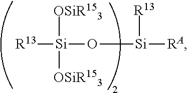

where R^{A} is as described above for formula (B1-1), and R¹³ and R¹⁵ are as described above for formula (C2-11). Alternatively, the alkenyl-functional branched polyorganosiloxane may have 3 to 16 silicon atoms per molecule, alternatively 4 to 16 silicon atoms per molecule, and alternatively 4 to 10 silicon atoms per molecule. Examples of alkenyl-functional branched polyorganosiloxane oligomers include vinyl-tris(trimethyl)siloxy)silane (also named 1,1,1,5,5,5-hexamethyl-3-((trimethylsilyl)oxy)-3-vinyltrisiloxane), which has formula:

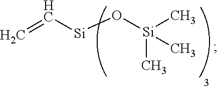

methyl-vinyl-di((1,1,1,3,5,5,5-heptamethyltrisiloxan-3-yl)oxy)-silane (also named 1,1,1,3,5,7,9,9,9-nonamethyl-3,7-bis((trimethylsilyl)oxy)-5-vinylpentasiloxane), which has formula

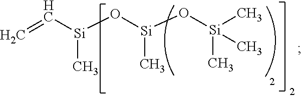

vinyl-tris((1,1,1,3,5,5,5-heptamethyltrisiloxan-3-yl)oxy)-silane (also named 5-((1,1,1,3,5,5,5-heptamethyltrisiloxan-3-yl)oxy)-1,1,1,3,7,9,9,9-octamethyl-3,7-bis((trimethylsilyl)oxy)-5-vinylpentasiloxane), which has formula

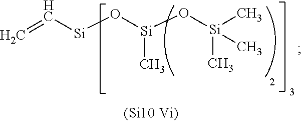

and (hex-5-en-1-yl)-tris((1,1,1,3,5,5,5-heptamethyltrisiloxan-3-yl)oxy)-silane (also named 5-((1,1,1,3,5,5,5-heptamethyltrisiloxan-3-yl)oxy)-5-(hex-5-en-1-yl)-1,1,1,3,7,9,9,9-octamethyl-3,7-bis((trimethylsilyl)oxy)pentasiloxane), which has formula

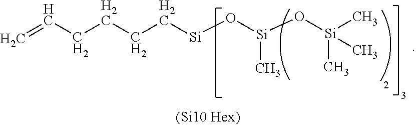

Branched alkenyl-functional polyorganosiloxane oligomers described above may be prepared by known methods, such as those disclosed in “Testing the Functional Tolerance of the Piers-Rubinsztajn Reaction: A new Strategy for Functional Silicones” by Grande, et al. Supplementary Material (ESI) for Chemical Communications, @ The Royal Society of Chemistry 2010.

Alternatively, (B2) the alkenyl-functional polyorganosiloxane may be branched, such as the branched oligomer described above and/or a branched alkenyl-functional polyorganosiloxane that may have, e.g., more alkenyl groups per molecule and/or more polymer units than the branched oligomer described above (e.g., in formula (B2-1) when the quantity (a+b+c+d+e+f+g)>50). The branched alkenyl-functional polyorganosiloxane may have (in formula (B2-1)) a quantity (e+f+g) sufficient to provide >0 to 5 mol % of trifunctional and/or quadrifunctional units to the branched alkenyl-functional polyorganosiloxane.

For example, the branched alkenyl-functional polyorganosiloxane may comprise a Q branched polyorganosiloxane of unit formula (B2-13): (R⁴₃SiO_{1/2})_{q}(R⁴₂R^{A}SiO_{1/2})ᵣ(R⁴₂SiO_{2/2})ₛ(SiO_{4/2})ₜ, where R^{A} is as described above for formula (B1-1), R⁴ is as described above for formula (C2-1), and subscripts q, r, s, and t are as described above for unit formula (C2-13). Suitable Q branched polyorganosiloxanes for starting material (B2-12) are known in the art and can be made by known methods, exemplified by those disclosed in U.S. Pat. No. 6,806,339 to Cray, et al. and U.S. Patent Publication 2007/0289495 to Cray, et al.

Alternatively, the branched alkenyl-functional polyorganosiloxane may comprise formula (B2-14): [R^{A}R⁴₂Si—(O—SiR⁴₂)ₓ—O]_{(4-w)}—Si—[O—(R⁴₂SiO)ᵥSiR⁴₃]_{w}, where R^{A} is as described above for formula (B1-1), R⁴ is as described above for formula (C2-1); and subscripts v, w, and x are as described above for formula (C2-14). Branched polyorganosiloxane suitable for starting material (B2-14) may be prepared by known methods such as heating a mixture comprising a polyorganosilicate resin, and a cyclic polydiorganosiloxane or a linear polydiorganosiloxane, in the presence of a catalyst, such as an acid or phosphazene base, and thereafter neutralizing the catalyst.

Alternatively, the branched alkenyl-functional polyorganosiloxane for starting material (B2-11) may comprise a T branched polyorganosiloxane (silsesquioxane) of unit formula (B2-15): (R⁴₃SiO_{1/2})ₐₐ(R^{A}R⁴₂SiO_{1/2})_{bb}(R⁴₂SiO_{2/2})_{cc}(R^{A}R⁴SiO_{2/2})ₑₑ(R⁴SiO_{3/2})_{dd}, where R^{A} is as described above for formula (B1-1), R⁴ is as described above for formula (C2-1), and subscripts aa, bb, cc, dd, and ee are as described above for formula (C2-11). The values for subscript bb may be sufficient to provide the silsesquioxane of unit formula (B2-15) with an alkenyl content of 0.1% to 1%, alternatively 0.2% to 0.6%, based on the weight of the silsesquioxane. Suitable T branched polyorganosiloxanes (silsesquioxanes) for starting material (B2-15) are exemplified by those disclosed in U.S. Pat. No. 4,374,967 to Brown, et al; U.S. Pat. No. 6,001,943 to Enami, et al.; U.S. Pat. No. 8,546,508 to Nabeta, et al.; and U.S. Pat. No. 10,155,852 to Enami.

Alternatively, (B2) the alkenyl-functional polyorganosiloxane may comprise an alkenyl-functional polyorganosilicate resin, which comprises monofunctional units (“M” units) of formula R^{M}₃SiO_{1/2} and tetrafunctional silicate units (“Q” units) of formula SiO_{4/2}, where each R^{M} is an independently selected monovalent hydrocarbon group; each R^{M} may be independently selected from the group consisting of R⁴ and R^{A} as described above. Alternatively, each R^{M} may be selected from the group consisting of alkyl, alkenyl and aryl. Alternatively, each R^{M} may be selected from methyl, vinyl and phenyl. Alternatively, at least one-third, alternatively at least two thirds of the R^{M} groups are methyl groups. Alternatively, the M units may be exemplified by (Me₃SiO_{1/2}), (Me₂PhSiO_{1/2}), and (Me₂ ViSiO_{1/2}). The polyorganosilicate resin is soluble in solvents such as those described herein as starting material (D), exemplified by liquid hydrocarbons, such as benzene, ethylbenzene, toluene, xylene, and heptane, or in liquid non-functional organosilicon compounds such as low viscosity linear and cyclic polydiorganosiloxanes.

When prepared, the polyorganosilicate resin comprises the M and Q units described above, and the polyorganosiloxane further comprises units with silicon bonded hydroxyl groups, and/or hydrolyzable groups, described by moiety (ZO_{1/2}), above in formula (C2-1), and may comprise neopentamer of formula Si(OSiR^{M}₃)₄, where R^{M} is as described above, e.g., the neopentamer may be tetrakis(trimethylsiloxy)silane. ²⁹Si NMR and ¹³C NMR spectroscopies may be used to measure hydroxyl and alkoxy content and molar ratio of M and Q units, where said ratio is expressed as {M(resin)}/{Q(resin)}, excluding M and Q units from the neopentamer. M/Q ratio represents the molar ratio of the total number of triorganosiloxy groups (M units) of the resinous portion of the polyorganosilicate resin to the total number of silicate groups (Q units) in the resinous portion. M/Q ratio may be 0.5/1 to 1.5/1, alternatively 0.6/1 to 0.9/1.

The Mn of the polyorganosilicate resin depends on various factors including the types of hydrocarbon groups represented by R^{M} that are present. The Mn of the polyorganosilicate resin refers to the number average molecular weight measured using GPC, when the peak representing the neopentamer is excluded from the measurement. The Mn of the polyorganosilicate resin may be 1,500 Da to 30,000 Da; alternatively 1,500 Da to 15,000 Da; alternatively >3,000 Da to 8,000 Da. Alternatively, Mn of the polyorganosilicate resin may be 3,500 Da to 8,000 Da.

U.S. Pat. No. 8,580,073 at col. 3, line 5 to col. 4, line 31, and U.S. Patent Publication 2016/0376482 at paragraphs to are hereby incorporated by reference for disclosing MQ resins, which are suitable polyorganosilicate resins for use as starting material (B2). The polyorganosilicate resin can be prepared by any suitable method, such as cohydrolysis of the corresponding silanes or by silica hydrosol capping methods. The polyorganosilicate resin may be prepared by silica hydrosol capping processes such as those disclosed in U.S. Pat. No. 2,676,182 to Daudt, et al.; U.S. Pat. No. 4,611,042 to Rivers-Farrell et al.; and U.S. Pat. No. 4,774,310 to Butler, et al. The method of Daudt, et al. described above involves reacting a silica hydrosol under acidic conditions with a hydrolyzable triorganosilane such as trimethylchlorosilane, a siloxane such as hexamethyldisiloxane, or mixtures thereof, and recovering a copolymer having M units and Q units. The resulting copolymers generally contain from 2 to 5 percent by weight of hydroxyl groups.

The intermediates used to prepare the polyorganosilicate resin may be triorganosilanes and silanes with four hydrolyzable substituents or alkali metal silicates. The triorganosilanes may have formula R^{M}₃SiX, where R^{M} is as described above and X represents a hydroxyl group or a hydrolyzable substituent, e.g., of formula (ZO_{1/2}) described above in formula (C2-1). Silanes with four hydrolyzable substituents may have formula SiX²₄, where each X² is independently selected from the group consisting of halogen, alkoxy, and hydroxyl. Suitable alkali metal silicates include sodium silicate.

The polyorganosilicate resin prepared as described above typically contain silicon bonded hydroxyl groups, e.g., of formula, HOSiO_{3/2}. The polyorganosilicate resin may comprise up to 3.5% of silicon bonded hydroxyl groups, as measured by FTIR spectroscopy and/or NMR spectroscopy, as described above. For certain applications, it may be desirable for the amount of silicon bonded hydroxyl groups to be below 0.7%, alternatively below 0.3%, alternatively less than 1%, and alternatively 0.3% to 0.8%. Silicon bonded hydroxyl groups formed during preparation of the polyorganosilicate resin can be converted to trihydrocarbon siloxane groups or to a different hydrolyzable group by reacting the silicone resin with a silane, disiloxane, or disilazane containing the appropriate terminal group. Silanes containing hydrolyzable groups may be added in molar excess of the quantity required to react with the silicon bonded hydroxyl groups on the polyorganosilicate resin.

Alternatively, the polyorganosilicate resin may further comprise 2% or less, alternatively 0.7% or less, and alternatively 0.3% or less, and alternatively 0.3% to 0.8% of units containing hydroxyl groups, e.g., those represented by formula XSiO_{3/2} where R^{M} is as described above, and X represents a hydrolyzable substituent, e.g., OH. The concentration of silanol groups (where X=OH) present in the polyorganosilicate resin may be determined using FTIR spectroscopy and/or NMR as described above.

For use herein, the polyorganosilicate resin further comprises one or more terminal alkenyl groups per molecule. The polyorganosilicate resin having terminal alkenyl groups may be prepared by reacting the product of Daudt, et al. with an alkenyl group-containing endblocking agent and an endblocking agent free of aliphatic unsaturation, in an amount sufficient to provide from 3 to 30 mole percent of alkenyl groups in the final product. Examples of endblocking agents include, but are not limited to, silazanes, siloxanes, and silanes. Suitable endblocking agents are known in the art and exemplified in U.S. Pat. No. 4,584,355 to Blizzard, et al.; U.S. Pat. No. 4,591,622 to Blizzard, et al.; and 4,585,836 Homan, et al. A single endblocking agent or a mixture of such agents may be used to prepare such resin.

Alternatively, the polyorganosilicate resin may comprise unit formula (B2-17): (R⁴₃SiO_{1/2})ₘₘ(R⁴₂R^{A}SiO_{1/2})ₙₙ(SiO_{4/2})ₒₒ(ZO_{1/2})ₕ, where R^{A} is as described above for formula (B1-1), Z, R⁴, and subscript h are as described above for formula (C2-1), and subscripts mm, nn and oo are as described above for unit formula (C2-17).

Alternatively, (B2) the alkenyl-functional polyorganosiloxane may comprise (B2-18) an alkenyl-functional silsesquioxane resin, i.e., a resin containing trifunctional (T) units of unit formula: (R⁴₃SiO_{1/2})ₐ(R⁴₂R^{A}SiO_{1/2})_{b}(R⁴₂SiO_{2/2})_{c}(R⁴R^{A}SiO_{2/2})_{d}(R⁴SiO_{3/2})ₑ(R^{A}SiO_{3/2})_{f}(ZO_{1/2})ₕ; where R^{A} is as described above for formula (B1-1); Z and R⁴ are as described above for formula (C2-1); and subscripts a, b, c, d, e, f, and h are as described above for formula (C2-18). Alternatively, the alkenyl-functional silsesquioxane resin may comprise unit formula (B2-19): (R⁴SiO_{3/2})ₑ(R^{A}SiO_{3/2})_{f}(ZO_{1/2})ₕ, where R^{A} is as described above for formula (B1-1); Z and R⁴ are as described above for formula (C2-1); and subscripts h, e and f are as described above for formula (C2-19). Alternatively, the alkenyl-functional silsesquioxane resin may further comprise difunctional (D) units of formulae (R⁴₂SiO_{2/2})_{c}(R⁴R^{A}SiO_{2/2})_{d} in addition to the T units described above, i.e., a DT resin, where subscripts c and d are as described above for formula (B2-1). Alternatively, the alkenyl-functional silsesquioxane resin may further comprise monofunctional (M) units of formulae (R⁴₃SiO_{1/2})ₐ(R⁴₂R^{A}SiO_{1/2})_{b}, i.e., an MDT resin, where subscripts a and b are as described above for unit formula (B2-1).

Alkenyl-functional silsesquioxane resins are commercially available, for example. RMS-310, which comprises unit formula (B2-20): (Me₂ViSiO_{1/2})₂₅(PhSiO_{3/2})₇₅ dissolved in toluene, is commercially available from Dow Silicones Corporation of Midland, Michigan, USA. Alkenyl-functional silsesquioxane resins may be produced by the hydrolysis and condensation or a mixture of trialkoxy silanes using the methods as set forth in “Chemistry and Technology of Silicone” by Noll, Academic Press, 1968, chapter 5, p 190-245. Alternatively, alkenyl-functional silsesquioxane resins may be produced by the hydrolysis and condensation of a trichlorosilane using the methods as set forth in U.S. Pat. No. 6,281,285 to Becker, et al. and U.S. Pat. No. 5,010,159 to Bank, et al. Alkenyl-functional silsesquioxane resins comprising D units may be prepared by known methods, such as those disclosed in U.S. Patent Application 2020/0140619 to Swier, et al. and PCT Publication WO2018/204068 to Swier, et al.

Starting material (B) may be any one of the alkenyl-functional organosilicon compounds described above. Alternatively, starting material (B) may comprise a mixture of two or more of the alkenyl-functional organosilicon compounds.

Starting material (C), the hydroformylation reaction catalyst for use in the method for making the aldehyde-functional organosilicon compound comprises an activated complex of rhodium and a close ended bisphosphite ligand. The bisphosphite ligand may be symmetric or asymmetric. Alternatively, the bisphosphite ligand may be symmetric. The bisphosphite ligand may have formula (C1):

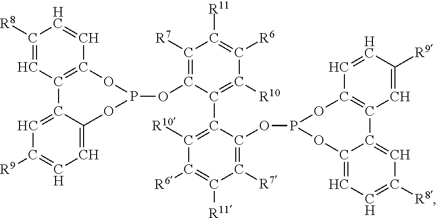

where R⁶ and R⁶′ are each independently selected from the group consisting of hydrogen, an alkyl group of at least one carbon atom, a cyano group, a halogen group, and an alkoxy group of at least one carbon atom; R⁷ and R⁷′ are each independently selected from the group consisting of an alkyl group of at least 3 carbon atoms and a group of formula —SiR¹⁷₃, where each R¹⁷ is an independently selected monovalent hydrocarbon group of 1 to 20 carbon atoms; R⁸, R⁸′, R⁹, and R⁹′ are each independently selected from the group consisting of hydrogen, an alkyl group, a cyano group, a halogen group, and an alkoxy group; and R¹⁰, R¹⁰′, R¹¹, and R¹¹′ are each independently selected from the group consisting of hydrogen and an alkyl group. Alternatively, one of R⁷ and R⁷′ may be hydrogen.

In formula (C1), R⁶ and R⁶′ may be alkyl groups of least one carbon atom, alternatively 1 to 20 carbon atoms. Suitable alkyl groups for R⁶ and R⁶′ may be linear, branched, cyclic, or combinations of two or more thereof. The alkyl groups are exemplified by methyl, ethyl, propyl (including n-propyl and/or isopropyl), butyl (including n-butyl, tert-butyl, sec-butyl, and/or isobutyl); pentyl, hexyl, heptyl, octyl, decyl, dodecyl, undecyl, and octadecyl (and branched isomers having 5 to 20 carbon atoms), and the alkyl groups are further exemplified by cycloalkyl groups such as cyclopropyl, cyclobutyl, cyclopentyl, and cyclohexyl. Alternatively, the alkyl group for R⁶ and R⁶′ may be selected from the group consisting of ethyl, propyl and butyl; alternatively propyl and butyl. Alternatively, the alkyl group for R⁶ and R⁶′ may be butyl. Alternatively, R⁶ and R⁶′ may be alkoxy groups, wherein the alkoxy group may have formula-OR⁶″, where R⁶″ is an alkyl group as described above for R⁶ and R⁶′.

Alternatively, in formula (C1), R⁶ and R⁶′ may be independently selected from alkyl groups of 1 to 6 carbon atoms and alkoxy groups of 1 to 6 carbon atoms. Alternatively, R⁶ and R⁶′ may be alkyl groups of 2 to 4 carbon atoms. Alternatively, R⁶ and R⁶ may be alkoxy groups of 1 to 4 carbon atoms. Alternatively, R⁶ and R⁶′ may be butyl groups, alternatively tert-butyl groups. Alternatively, R⁶ and R⁶′ may be methoxy groups.

In formula (C1), R⁷ and R⁷′ may be alkyl groups of least three carbon atoms, alternatively 3 to 20 carbon atoms. Suitable alkyl groups for R⁷ and R⁷′ may be linear, branched, cyclic, or combinations of two or more thereof. The alkyl groups are exemplified by propyl (including n-propyl and/or isopropyl), butyl (including n-butyl, tert-butyl, sec-butyl, and/or isobutyl); pentyl, hexyl, heptyl, octyl, decyl, dodecyl, undecyl, and octadecyl (and branched isomers having 5 to 20 carbon atoms), and the alkyl groups are further exemplified by cycloalkyl groups such as cyclopropyl, cyclobutyl, cyclopentyl, and cyclohexyl. Alternatively, the alkyl group for R⁷ and R⁷′ may be selected from the group consisting of propyl and butyl. Alternatively, the alkyl group for R⁷ and R⁷′ may be butyl.

Alternatively, in formula (C1), R⁷ and R⁷′ may be a silyl group of formula —SiR¹⁷₃, where each R¹⁷ is an independently selected monovalent hydrocarbon group of 1 to 20 carbon atoms. The monovalent hydrocarbon group may be an alkyl group of 1 to 20 carbon atoms, as described above for R⁶ and R⁶′.

Alternatively, in formula (C1), R⁷ and R⁷′ may each be independently selected alkyl groups, alternatively alkyl groups of 3 to 6 carbon atoms. Alternatively, R⁷ and R⁷′ may be alkyl groups of 3 to 4 carbon atoms. Alternatively, R⁷ and R⁷′ may be butyl groups, alternatively tert-butyl groups.

In formula (C1), R⁸, R⁸′, R⁹, R⁹′ may be alkyl groups of at least one carbon atom, as described above for R⁶ and R⁶′. Alternatively, R⁸ and R⁸′ may be independently selected from the group consisting of hydrogen and alkyl groups of 1 to 6 carbon atoms. Alternatively, R⁸ and R⁸′ may be hydrogen. Alternatively, in formula (C1), R⁹, and R⁹′ may be independently selected from the group consisting of hydrogen and alkyl groups of 1 to 6 carbon atoms. Alternatively, R⁹ and R⁹′ may be hydrogen.

In formula (C1), R¹⁰ and R¹⁰′ may be hydrogen atoms or alkyl groups of least one carbon atom, alternatively 1 to 20 carbon atoms. The alkyl groups for R¹⁰ and R¹⁰′ may be as described above for R⁶ and R⁶′. Alternatively, R¹⁰ and R¹⁰′ may be methyl. Alternatively, R¹⁰ and R¹⁰′ may be hydrogen.

In formula (C1), R¹¹ and R¹¹′ may be hydrogen atoms or alkyl groups of least one carbon atom, alternatively 1 to 20 carbon atoms. The alkyl groups for R¹¹ and R¹¹′ may be as described above for R⁶ and R⁶′. Alternatively, R¹¹ and R¹¹′ may be hydrogen.

Alternatively, the ligand of formula (C1) may be selected from the group consisting of (C1-1) 6,6′-[[3,3′,5,5′-tetrakis(1,1-dimethylethyl)-1,1′-biphenyl]-2,2′-diyl]bis(oxy)]bis-dibenzo[d,f][1,3,2]dioxaphosphepin; (C1-2) 6,6′-[(3,3′-di-tert-butyl-5,5′-dimethoxy-1,1′-biphenyl-2,2′-diyl)bis(oxy)]bis(dibenzo[d,f][1,3,2]dioxaphosphepin); and a combination of both (C1-1) and (C1-2).

Alternatively, the ligand may comprise 6,6′-[[3,3′,5,5′-tetrakis(1,1-dimethylethyl)-1,1′-biphenyl]-2,2′-diyl]bis(oxy)]bis-dibenzo[d,f][1,3,2]dioxaphosphepin, as disclosed at col. 11 of U.S. Pat. No. 10,023,516 (see also U.S. Pat. No. 7,446,231, which discloses this compound as Ligand D at col. 22 and U.S. Pat. No. 5,727,893 at col. 20, lines 40-60 as ligand F).

Alternatively, the ligand may comprise biphephos, which is commercially available from Sigma Aldrich and may be prepared as described in U.S. Pat. No. 9,127,030. (See also U.S. Pat. No. 7,446,231 ligand B at col. 21 and U.S. Pat. No. 5,727,893 at col. 20, lines 5-18 as ligand D).

Starting material (C), the rhodium/bisphosphite ligand complex catalyst, may be prepared by methods known in the art, such as those disclosed in U.S. Pat. No. 4,769,498 to Billig, et al. at col. 20, line 50-col. 21, line 40 and U.S. Pat. No. 10,023,516 to Brammer et al. col. 11, line 35-col. 12, line 12 by varying appropriate starting materials. For example, the rhodium/bisphosphite ligand complex may be prepared by a process comprising combining a rhodium precursor and the bisphosphite ligand (C1) described above under conditions to form the complex, which complex may then be introduced into a hydroformylation reaction medium comprising one or both of starting materials (A) and/or (B), described above. Alternatively, the rhodium/bisphosphite ligand complex may be formed in situ by introducing the rhodium catalyst precursor into the reaction medium, and introducing (C1) the bisphosphite ligand into the reaction medium (e.g., before, during, and/or after introduction of the rhodium catalyst precursor), for the in situ formation of the rhodium/bisphosphite ligand complex. The rhodium/bisphosphite ligand complex can be activated by heating and/or exposure to starting material (A) to form the (C) rhodium/bisphosphite ligand complex catalyst. Rhodium catalyst precursors are exemplified by rhodium dicarbonyl acetylacetonate, Rh₂O₃, Rh₄(CO)₁₂, Rh₆(CO)₁₆, and Rh(NO₃)₃.

For example, a rhodium precursor, such as rhodium dicarbonyl acetylacetonate, optionally starting material (D), a solvent, and (C1) the bisphosphite ligand may be combined, e.g., by any convenient means such as mixing. The resulting rhodium/bisphosphite ligand complex may be introduced into the reactor, optionally with excess bisphosphite ligand. Alternatively, the rhodium precursor, (D) the solvent, and the bisphosphite ligand may be combined in the reactor with starting material (A) and/or (B), the alkenyl-functional organosilicon compound; and the rhodium/bisphosphite ligand complex may form in situ. The relative amounts of bisphosphite ligand and rhodium precursor are sufficient to provide a molar ratio of bisphosphite ligand/Rh of 10/1 to 1/1, alternatively 5/1 to 1/1, alternatively 3/1 to 1/1, alternatively 2.5/1 to 1.5/1. In addition to the rhodium/bisphosphite ligand complex, excess (e.g., not complexed) bisphosphite ligand may be present in the reaction mixture. The excess bisphosphite ligand may be the same as, or different from, the bisphosphite ligand in the complex.

The amount of (C) the rhodium/bisphosphite ligand complex catalyst (catalyst) is sufficient to catalyze hydroformylation of (B) the alkenyl-functional organosilicon compound. The exact amount of catalyst will depend on various factors including the type of alkenyl-functional organosilicon compound selected for starting material (B), its exact alkenyl content, and the reaction conditions such as temperature and pressure of starting material (A). However, the amount of (C) the hydroformylation reaction catalyst may be sufficient to provide a rhodium metal concentration of at least 0.1 ppm, alternatively 0.15 ppm, alternatively 0.2 ppm, alternatively 0.25 ppm, and alternatively 0.5 ppm, based on the weight of (B) the alkenyl-functional organosilicon compound. At the same time, the amount of (C) the hydroformylation reaction catalyst may be sufficient to provide a rhodium metal concentration of up to 300 ppm, alternatively up to 100 ppm, alternatively up to 20 ppm, and alternatively up to 5 ppm, on the same basis. Alternatively, the amount of (C) the hydroformylation reaction catalyst may be sufficient to provide 0.1 ppm to 300 ppm, alternatively 0.2 ppm to 100 ppm, alternatively, 0.25 ppm to 20 ppm, and alternatively 0.5 ppm to 5 ppm, based on the weight of (B) the alkenyl-functional organosilicon compound.

The hydroformylation process reaction may run without additional solvents. Alternatively, the hydroformylation process reaction may be carried out with a solvent, for example to facilitate mixing and/or delivery of one or more of the starting materials described above, such as (C) the hydroformylation reaction catalyst and/or starting material (B) the alkenyl-functional organosilicon compound, when a solvent is used for an alkenyl-functional polyorganosilicate resin that is selected for starting material (B). The solvent is exemplified by aliphatic or aromatic hydrocarbons, which can dissolve the starting materials, e.g., toluene, xylene, benzene, hexane, heptane, decane, cyclohexane, or a combination of two or more thereof. Additional solvents include THF, dibutyl ether, diglyme, and Texanol. Without wishing to be bound by theory, it is thought that solvent may be used to reduce the viscosity of the starting materials. The amount of solvent is not critical, however, when present, the amount of solvent may be 5% to 70% based on weight of starting material (B) the alkenyl-functional organosilicon compound.

In the process described herein, step 1) is performed at relatively low temperature. For example, step 1) may be performed at a temperature of at least 30° C., alternatively at least 50° C., and alternatively at least 70° C. At the same time, the temperature in step 1) may be up to 150° C.; alternatively up to 100° C.; alternatively up to 90° C., and alternatively up to 80° C. Without wishing to be bound by theory, it is thought that lower temperatures, e.g., 30° C. to 90° C., alternatively 40° C. to 90° C., alternatively 50° C. to 90° C., alternatively 60° C. to 90° C., alternatively 70° C. to 90° C., alternatively 80° C. to 90° C., alternatively 30° C. to 60° C., alternatively 50° C. to 60° C. may be desired for achieving high selectivity and ligand stability.

In the process described herein, step 1) may be performed at a pressure of at least 101 kPa (ambient), alternatively at least 206 kPa (30 psi), and alternatively at least 344 kPa (50 psi). At the same time, pressure in step 1) may be up to 6,895 kPa (1,000 psi), alternatively up to 1,379 kPa (200 psi), alternatively up to 1000 kPa (145 psi), and alternatively up to 689 kPa (100 psi). Alternatively, step 1) may be performed at 101 kPa to 6,895 kPa; alternatively 344 kPa to 1,379 kPa; alternatively 101 kPa to 1,000 kPa; and alternatively 344 kPa to 689 kPa. Without wishing to be bound by theory, it is thought that using relatively low pressures, e.g., <6,895 kPa in the process herein may be beneficial; the ligands described herein allow for low pressure hydroformylation processes, which have the benefits of lower cost and better safety than high pressure hydroformylation processes. Furthermore, the hydroformylation process has the benefit of being robust in that a wide variety of alkenyl-functional organosilicon compounds can be converted to aldehyde-functional organosilicon compounds (from a silane to a polyorganosiloxane resin), as shown the examples below.

The hydroformylation process may be carried out in a batch, semi-batch, or continuous mode, using one or more suitable reactors, such as a fixed bed reactor, a fluid bed reactor, a continuous stirred tank reactor (CSTR), or a slurry reactor. The selection of (B) the alkenyl-functional organosilicon compound, and (C) the hydroformylation reaction catalyst, and whether (D) the solvent is used may impact the size and type of reactor used. One reactor, or two or more different reactors, may be used. The hydroformylation process may be conducted in one or more steps, which may be affected by balancing capital costs and achieving high catalyst selectivity, activity, lifetime, and ease of operability, as well as the reactivity of the particular starting materials and reaction conditions selected, and the desired product.

Alternatively, the hydroformylation process may be performed in a continuous manner. For example, the process used may be as described in U.S. Pat. No. 10,023,516 except that the olefin feed stream and catalyst described therein are replaced with (B) the alkenyl-functional organosilicon compound and (C) the rhodium/bisphosphite ligand complex catalyst, each described herein.

Step 1) of the hydroformylation process forms a reaction fluid comprising the aldehyde-functional organosilicon compound. The reaction fluid may further comprise additional materials, such as those which have either been deliberately employed, or formed in situ, during step 1) of the process. Examples of such materials that can also be present include unreacted (B) alkenyl-functional organosilicon compound, unreacted (A) carbon monoxide and hydrogen gases, and/or in situ formed side products, such as ligand degradation products and adducts thereof, and high boiling liquid aldehyde condensation byproducts, as well as (D) a solvent, if employed. The term “ligand degradation product” includes but is not limited to any and all compounds resulting from one or more chemical transformations of at least one of the ligand molecules used in the process.

The hydroformylation process may further comprise one or more additional steps such as: 2) recovering (C) the rhodium/bisphosphite ligand complex catalyst from the reaction fluid comprising the aldehyde-functional organosilicon compound. Recovering (C) the rhodium/bisphosphite ligand complex catalyst may be performed by methods known in the art, including but not limited to adsorption and/or membrane separation (e.g., nanofiltration). Suitable recovery methods are as described, for example, in U.S. Pat. No. 5,681,473 to Miller, et al.; U.S. Pat. No. 8,748,643 to Priske, et al.; and 10,155,200 to Geilen, et al.

However, one benefit of the process described herein is that (C) the hydroformylation reaction catalyst need not be removed and recycled. Due to the low level of Rh needed, it may be more cost effective not to recover and recycle (C) the hydroformylation reaction catalyst; and the aldehyde-functional organosilicon compound produced by the process may be stable even when the hydroformylation reaction catalyst is not removed. Furthermore, without wishing to be bound by theory, it is thought that (C) the hydroformylation reaction catalyst may also catalyze the hydrogenation reaction of the aldehyde-functional organosilicon compound to form the carbinol-functional organosilicon compound, as described herein below. Therefore, alternatively, the hydroformylation process described above may be performed without step 2).

Alternatively, the hydroformylation process may further comprise 3) purification of the reaction product. For example, the aldehyde-functional organosilicon compound may be isolated from the additional materials, described above, by any convenient means such as stripping and/or distillation, optionally with reduced pressure. Alternatively, step 3) may be omitted, for example, to leave (C) the hydroformylation reaction catalyst in the hydroformylation reaction product comprising the aldehyde-functional organosilicon compound.

The aldehyde-functional organosilicon compound is useful as a starting material in the process above for preparing a carbinol-functional organosilicon compound. Starting material (E) is the aldehyde-functional organosilicon compound, which has, per molecule, at least one aldehyde-functional group covalently bonded to silicon. Alternatively, the aldehyde-functional organosilicon compound may have, per molecule, more than one aldehyde-functional group covalently bonded to silicon. The aldehyde-functional group covalently bonded to silicon may have formula:

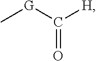

where G is a divalent hydrocarbon group free of aliphatic unsaturation that has 2 to 8 carbon atoms. G may be linear or branched. Examples of divalent hydrocarbyl groups for G include alkane-diyl groups of empirical formula —CᵣH₂ᵣ—, where subscript r is 2 to 8. The alkane-diyl group may be a linear alkane-diyl, e.g., —CH₂—CH₂—, —CH₂—CH₂—CH₂—, —CH₂—CH₂—CH₂—CH₂—, or —CH₂—CH₂—CH₂—CH₂—CH₂—CH₂—, or a branched alkane-diyl, e.g.,

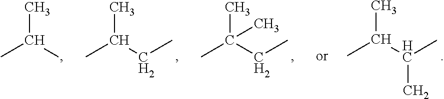

Alternatively, each G may be an alkane-diyl group of 2 to 6 carbon atoms; alternatively of 2, 3, or 6 carbon atoms. The aldehyde-functional organosilicon compound may be one aldehyde-functional organosilicon compound. Alternatively, two or more aldehyde-functional organosilicon compounds that differ from one another may be used in the process described herein. For example, the aldehyde-functional organosilicon compound may comprise one or both of an aldehyde-functional silane and an aldehyde-functional polyorganosiloxane.

The aldehyde-functional organosilicon compound may comprise (E1) an aldehyde-functional silane of formula (E1-1): R^{Ald}ₓSiR⁴₍₄₋ₓ₎, where each R^{Ald} is an independently selected group of the formula

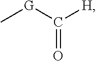

as described above; and R⁴ and subscript x are as described above, e.g., each R⁴ is independently selected from the group consisting of an alkyl group of 1 to 18 carbon atoms, an aryl group of 6 to 18 carbon atoms, an acyloxy group of 2 to 18 carbon atoms, and an hydrocarbonoxy-functional group of 1 to 18 carbon atoms; and subscript x is 1 to 4 (as described above for formula (C1-1).

Suitable aldehyde-functional silanes are exemplified by aldehyde-functional trialkylsilanes such as (propyl-aldehyde)-trimethylsilane, (propyl-aldehyde)-triethylsilane, and (butyl-aldehyde)trimethylsilane; aldehyde-functional trialkoxysilanes such as (butyl-aldehyde)trimethoxysilane, (propyl-aldehyde)-trimethoxysilane, (propyl-aldehyde)-triethoxysilane, (propyl-aldehyde)-triisopropoxysilane, and (propyl-aldehyde)-tris(methoxyethoxy)silane; aldehyde-functional dialkoxysilanes such as (propyl-aldehyde)-phenyldiethoxysilane, (propyl-aldehyde)-methyldimethoxysilane, and (propyl-aldehyde)-methyldiethoxysilane; aldehyde-functional monoalkoxysilanes such as tri (propyl-aldehyde)-methoxysilane; aldehyde-functional triacyloxysilanes such as (propyl-aldehyde)-triacetoxysilane, and aldehyde-functional diacyloxysilanes such as (propyl-aldehyde)-methyldiacetoxysilane.

Alternatively, the aldehyde-functional organosilicon compound may comprise (E2) an aldehyde-functional polyorganosiloxane. Said aldehyde-functional polyorganosiloxane may be cyclic, linear, branched, resinous, or a combination of two or more thereof. Said aldehyde-functional polyorganosiloxane may comprise unit formula (E2-1): (R⁴₃SiO_{1/2})ₐ(R⁴₂R^{Ald}SiO_{1/2})_{b}(R⁴₂SiO_{2/2})_{c}(R⁴R^{Ald}SiO_{2/2})_{d}(R⁴SiO_{3/2})ₑ(R^{Ald}SiO_{3/2})_{f}(SiO_{4/2})_{g}(ZO_{1/2})ₕ; where each R^{Ald} is an independently selected aldehyde group of the formula

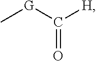

as described above, and R⁴, Z, and subscripts a, b, c, d, e, f, g, and h are as described above for formula (C2-1).

Alternatively, (E2) the aldehyde-functional polyorganosiloxane may comprise (E2-2) a linear polydiorganosiloxane having, per molecule, at least one aldehyde-functional group; alternatively at least two aldehyde-functional groups (e.g., when in the formula (E2-1) for the aldehyde-functional polyorganosiloxane above, subscripts e=f=g=0). For example, said polydiorganosiloxane may comprise unit formula (E2-3): (R⁴₃SiO_{1/2})ₐ(R^{Ald}R⁴₂SiO_{1/2})_{b}(R⁴₂SiO_{2/2})_{c}(R^{Ald}R⁴SiO_{2/2})ₐ, where R^{Ald} is as described above for formula (E1-1), R⁴ is as described above for starting material (C2-1), and subscripts a, b, c, and d are as described above for starting material (C2-3).

Alternatively, the linear aldehyde-functional polydiorganosiloxane of unit formula (E2-3) may be selected from the group consisting of: unit formula (E2-4): (R⁴₂R^{Ald}SiO_{1/2})₂(R⁴₂SiO_{2/2})ₘ(R⁴R^{Ald}SiO_{2/2})ₙ, unit formula (E2-5): (R⁴₃SiO_{1/2})₂(R⁴₂SiO_{2/2})ₒ(R⁴R^{Ald}SiO_{2/2})ₚ, or a combination of both (E2-4) and (E2-5).

In formulae (E2-4) and (E2-5), each R⁴ is as described above for formula (C2-1), R^{Ald} is as described above for formula (E1-1), and subscripts m, n, o, and p are as described above for starting materials (C2-4) and (C2-5).

Starting material (E2-2) may comprise an aldehyde-functional polydiorganosiloxane such as i) bis-dimethyl(propyl-aldehyde)siloxy-terminated polydimethylsiloxane, ii) bis-dimethyl(propyl-aldehyde)siloxy-terminated poly(dimethylsiloxane/methyl(propyl-aldehyde)siloxane), iii) bis-dimethyl(propyl-aldehyde)siloxy-terminated polymethyl(propyl-aldehyde)siloxane, iv) bis-trimethylsiloxy-terminated poly(dimethylsiloxane/methyl(propyl-aldehyde)siloxane), v) bis-trimethylsiloxy-terminated polymethyl(propyl-aldehyde)siloxane, vi) bis-dimethyl(propyl-aldehyde)siloxy-terminated poly(dimethylsiloxane/methylphenylsiloxane/methyl(propyl-aldehyde)siloxane), vii) bis-dimethyl(propyl-aldehyde)siloxy-terminated poly(dimethylsiloxane/methylphenylsiloxane), viii) bis-dimethyl(propyl-aldehyde)siloxy-terminated poly(dimethylsiloxane/diphenylsiloxane), ix) bis-phenyl, methyl, (propyl-aldehyde)-siloxy-terminated polydimethylsiloxane, x) bis-dimethyl(heptyl-aldehyde)siloxy-terminated polydimethylsiloxane, xi) bis-dimethyl(heptyl-aldehyde)siloxy-terminated poly(dimethylsiloxane/methyl(heptyl-aldehyde)siloxane), xii) bis-dimethyl(heptyl-aldehyde)siloxy-terminated polymethyl(heptyl-aldehyde)siloxane, xiii) bis-trimethylsiloxy-terminated poly(dimethylsiloxane/methyl(heptyl-aldehyde)siloxane), xiv) bis-trimethylsiloxy-terminated polymethyl(heptyl-aldehyde)siloxane, xv) bis-dimethyl(heptyl-aldehyde)-siloxy terminated poly(dimethylsiloxane/methylphenylsiloxane/methyl(heptyl-aldehyde)siloxane), xvi) bis-dimethyl(propyl-aldehyde)siloxy-terminated poly(dimethylsiloxane/methyl(heptyl-aldehyde)siloxane), xvii) bis-dimethyl(heptyl-aldehyde)-siloxy-terminated poly(dimethylsiloxane/methylphenylsiloxane), xviii) dimethyl(heptyl-aldehyde)-siloxy-terminated poly(dimethylsiloxane/diphenylsiloxane), and xix) a combination of two or more of i) to xviii).

Alternatively, (E2) the aldehyde-functional polyorganosiloxane may be cyclic, e.g., when in unit formula (E2-1), subscripts a=b=c=e=f=g=h=0. The (E2-6) cyclic aldehyde-functional polydiorganosiloxane may have unit formula (E2-7): (R⁴R^{Ald}SiO_{2/2})ₐ, where R^{Ald} is as described above for formula (E1-1), and R⁴ and subscript d are as described above for formula (C2-1). Examples of cyclic aldehyde-functional polydiorganosiloxanes include 2,4,6-trimethyl-2,4,6-tri (propyl-aldehyde)-cyclotrisiloxane, 2,4,6,8-tetramethyl-2,4,6,8-tetra(propyl-aldehyde)-cyclotetrasiloxane, 2,4,6,8,10-pentamethyl-2,4,6,8,10-penta (propyl-aldehyde)-cyclopentasiloxane, and 2,4,6,8,10,12-hexamethyl-2,4,6,8,10,12-hexa (propyl-aldehyde)-cyclohexasiloxane.

Alternatively, (E2-6) the cyclic aldehyde-functional polydiorganosiloxane may have unit formula (E2-8): (R⁴₂SiO_{2/2})_{c}(R⁴R^{Ald}SiO_{2/2})ₐ, where R^{Ald} is as described above for formula (E1-1), R⁴ is as described above for formula (C2-1), and subscripts c and d are as described above for formula (C2-6).

Alternatively, (E2) the aldehyde-functional polyorganosiloxane may be (E2-9) oligomeric, e.g., when in unit formula (E2-1) above the quantity (a+b+c+d+e+f+g)≤50, as described above for formula (C2-1). The cyclic oligomers are as described above as starting material (E2-6).

Examples of linear aldehyde-functional polyorganosiloxane oligomers may have formula (E2-10):

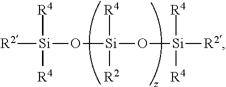

where R⁴ is as described above for formula (C2-1), each R²′ is independently selected from the group consisting of R⁴ and R^{Ald}, with the proviso that at least one R²′, per molecule, is R^{Ald}, and subscript z is 0 to 48. Examples of linear aldehyde-functional polyorganosiloxane oligomers include 1,3-di(propyl-aldehyde)-1,1,3,3-tetramethyldisiloxane; 1,1,1,3,3-pentamethyl-3-(propyl-aldehyde)-disiloxane; and 1,1,1,3,5,5,5-heptamethyl-3-(propyl-aldehyde)-trisiloxane.

Alternatively, the aldehyde-functional polyorganosiloxane oligomer may be branched. The branched oligomer may have general formula (E2-11): R^{Ald}SiR¹²₃, where R^{Ald} is as described above for formula (E1-1) and each R¹² is selected from R¹³ and —OSi(R¹⁴)₃; where each R¹³ is a monovalent hydrocarbon group; where each R¹⁴ is selected from R¹³, —OSi(R¹⁵)₃, and —[OSiR¹³₂]; OSiR¹³₃; where each R¹⁵ is selected from R¹³, —OSi(R¹⁶)₃, and —[OSiR¹³₂]: OSiR¹³₃; where each R¹⁶ is selected from R¹³ and — [OSiR¹³₂]ᵢᵢOSiR¹³₃; and where subscript ii has a value such that 0≤ii≤100. At least two of R¹² may be —OSi(R¹⁴) 3. Alternatively, all three of R¹² may be —OSi(R¹⁴)₃.

Alternatively, in formula (E2-11) when each R¹² is —OSi(R¹⁴)₃, each R¹⁴ may be —OSi(R¹⁵) 3 moieties such that the branched polyorganosiloxane oligomer has the following structure:

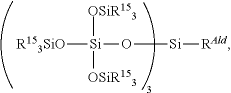

where R^{Ald} is as described above for formula (E1-1), and R¹⁵ are as described above for formula (C2-11).

Alternatively, in formula (E2-11), when each R¹² is —OSi(R¹⁴)₃, one R¹⁴ may be R¹³ in each —OSi(R¹⁴)₃ such that each R¹² is —OSiR¹³(R¹⁴)₂. Alternatively, two R¹⁴ in —OSiR¹³(R¹⁴)₂ may each be —OSi(R¹⁵)₃ moieties such that the branched aldehyde-functional polyorganosiloxane oligomer has the following structure:

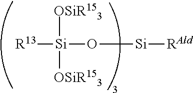

where R^{Ald} is as described above for formula (E1-1), and R¹³ and R¹⁵ are as described above for formula (C2-11). Alternatively, each R¹⁵ may be an R¹³, and each R¹³ may be methyl.

Alternatively, in formula (E2-11), one R¹² may be R¹³, and two of R¹² may be —OSi(R¹⁴)₃. When two of R¹² are —OSi(R¹⁴)₃, and one R¹⁴ is R¹³ in each —OSi(R¹⁴)₃ then two of R¹² are —OSiR¹³(R¹⁴)₂. Alternatively, each R¹⁴ in —OSiR¹³(R¹⁴)₂ may be —OSi(R¹⁵)₃ such that the branched polyorganosiloxane oligomer has the following structure:

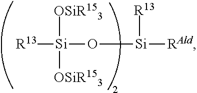

where R^{Ald} is as described above for formula (E1-1), and R¹³ and R¹⁵ are as described above for formula (C2-11). Alternatively, the aldehyde-functional branched polyorganosiloxane may have 3 to 16 silicon atoms per molecule, alternatively 4 to 16 silicon atoms per molecule, and alternatively 4 to 10 silicon atoms per molecule. Examples of aldehyde-functional branched polyorganosiloxane oligomers include 3-(1,1,1,5,5,5-hexamethyl-3-((trimethylsilyl)oxy)trisiloxan-3-yl)propanal (which can also be named propyl-aldehyde-tris(trimethyl)siloxy)silane), which has formula:

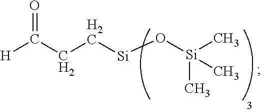

3-(1,1,1,3,5,7,9,9,9-nonamethyl-3,7-bis((trimethylsilyl)oxy)pentasiloxan-5-yl)propanal (which can also be named methyl-(propyl-aldehyde)-di((1,1,1,3,5,5,5-heptamethyltrisiloxan-3-yl)oxy)-silane), which has formula

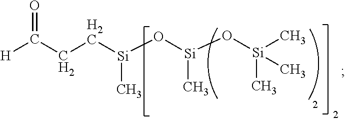

3-(5-((1,1,1,3,5,5,5-heptamethyltrisiloxan-3-yl)oxy)-1,1,1,3,7,9,9,9-octamethyl-3,7-bis((trimethylsilyl)oxy)pentasiloxan-5-yl)propanal (which can also be named (propyl-aldehyde)-tris((1,1,1,3,5,5,5-heptamethyltrisiloxan-3-yl)oxy)-silane), which has formula

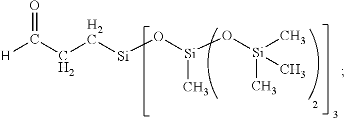

and 7-(5-((1,1,1,3,5,5,5-heptamethyltrisiloxan-3-yl)oxy)-1,1,1,3,7,9,9,9-octamethyl-3,7-bis((trimethylsilyl)oxy)pentasiloxan-5-yl) heptanal (which can also be named (heptyl-aldehyde)-tris((1,1,1,3,5,5,5-heptamethyltrisiloxan-3-yl)oxy)-silane), which has formula

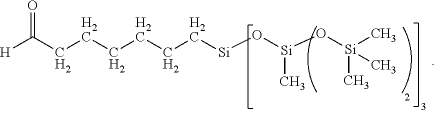

Alternatively, (E2) the aldehyde-functional polyorganosiloxane may be branched, such as the branched oligomer described above and/or a branched aldehyde-functional polyorganosiloxane that may have, e.g., more aldehyde groups per molecule and/or more polymer units than the branched oligomer described above (e.g., in formula (E2-1) when the quantity (a+b+c+d+e+f+g)>50). The branched aldehyde-functional polyorganosiloxane may have (in formula (E2-1)) a quantity (e+f+g) sufficient to provide >0 to 5 mol % of trifunctional and/or quadrifunctional units to the branched aldehyde-functional polyorganosiloxane.

For example, the branched aldehyde-functional polyorganosiloxane may comprise a Q branched polyorganosiloxane of unit formula (E2-13): (R⁴₃SiO_{1/2}) q (R⁴₂R^{Ald}SiO_{1/2}) r (R⁴₂SiO_{2/2}) s (SiO_{4/2}) t, where R^{Ald} is as described above for formula (E1-1), and R⁴ is as described above for formula (C2-1), and subscripts q, r, s, and t are as described above for formula (C2-13).

Alternatively, the branched aldehyde-functional polyorganosiloxane may comprise formula (E2-14): [R^{Ald}R⁴₂Si—(O—SiR⁴₂)ₓ—O]_{(4-w)}—Si—[O—(R⁴₂SiO)ᵥSiR⁴₃]_{w}, where R^{Ald} is as described above for formula (E1-1), R⁴ is as described above for formula (C2-1), and subscripts v, w, and x are as described above for formula (C2-14).

Alternatively, the branched aldehyde-functional polyorganosiloxane for starting material (E2-11) may comprise a T branched polyorganosiloxane (silsesquioxane) of unit formula (E2-15): (R⁴₃SiO_{1/2})ₐₐ(R^{Ald}R⁴₂SiO_{1/2})_{bb}(R⁴₂SiO_{2/2})_{cc}(R^{Ald}R⁴SiO_{2/2})ₑₑ(R⁴SiO_{3/2}) dd, where R^{Ald} is as described above for formula (E1-1), R⁴ is as described above for formula (C2-1), and subscripts aa, bb, cc, dd, and ee are as described above for formula (C2-15). The values for subscript bb may be sufficient to provide the silsesquioxane of unit formula (E2-15) with an aldehyde content of 0.1% to 1%, alternatively 0.2% to 0.6%, based on the weight of the silsesquioxane.

Alternatively, (E2) the aldehyde-functional polyorganosiloxane may comprise an aldehyde-functional polyorganosiloxane resin, such as an aldehyde-functional polyorganosilicate resin and/or an aldehyde-functional silsesquioxane resin. Such resins may be prepared, for example, by hydroformylating an alkenyl-functional polyorganosiloxane resin, as described above. The aldehyde-functional polyorganosilicate resin comprises monofunctional units (“M′” units) of formula R^{M′}₃SiO_{1/2} and tetrafunctional silicate units (“Q” units) of formula SiO_{4/2}, where each R^{M′} may be independently selected from the group consisting of R⁴ and R^{Ald} as described above for formulas (C2-1) and (E1-1), respectively. Alternatively, each R^{M′} may be selected from the group consisting of an alkyl group, an aldehyde-functional group of the formula shown above, and an aryl group. Alternatively, each R^{M′} may be selected from methyl, (propyl-aldehyde) and phenyl. Alternatively, at least one-third, alternatively at least two thirds of the R^{M′} groups are methyl groups. Alternatively, the M′ units may be exemplified by (Me₃SiO_{1/2}), (Me₂PhSiO_{1/2}), and (Me₂R^{Ald}SiO_{1/2}). The polyorganosilicate resin is soluble in solvents such as those described herein as starting material (D), exemplified by liquid hydrocarbons, such as benzene, ethylbenzene, toluene, xylene, and heptane, or in liquid non-functional organosilicon compounds such as low viscosity linear and cyclic polydiorganosiloxanes.

When prepared, the polyorganosilicate resin comprises the M′ and Q units described above, and the polyorganosiloxane further comprises units with silicon bonded hydroxyl groups, and/or hydrolyzable groups, described by moiety (ZO_{1/2}), above, and may comprise neopentamer of formula Si(OSiR^{M′}₃)₄, where R^{M′} is as described above, e.g., the neopentamer may be tetrakis(trimethylsiloxy)silane. ²⁹Si NMR and ¹³C NMR spectroscopies may be used to measure hydroxyl and alkoxy content and molar ratio of M′ and Q units, where said ratio is expressed as {M′(resin)}/{Q(resin)}, excluding M′ and Q units from the neopentamer. M′/Q ratio represents the molar ratio of the total number of triorganosiloxy groups (M′ units) of the resinous portion of the polyorganosilicate resin to the total number of silicate groups (Q units) in the resinous portion. M′/Q ratio may be 0.5/1 to 1.5/1, alternatively 0.6/1 to 0.9/1.

The Mn of the polyorganosilicate resin depends on various factors including the types of hydrocarbon groups represented by R^{M′} that are present. The Mn of the polyorganosilicate resin refers to the number average molecular weight measured using GPC, when the peak representing the neopentamer is excluded from the measurement. The Mn of the polyorganosilicate resin may be 1,500 Da to 30,000 Da, alternatively 1,500 Da to 15,000 Da; alternatively >3,000 Da to 8,000 Da. Alternatively, Mn of the polyorganosilicate resin may be 3,500 Da to 8,000 Da.

Alternatively, the polyorganosilicate resin may comprise unit formula (E2-17): (R⁴₃SiO_{1/2})ₘₘ(R⁴₂R^{Ald}SiO_{1/2})ₙₙ(SiO_{4/2})ₒₒ(ZO_{1/2}) h, where R^{Ald} is as described above for formula (E1-1), Z and R⁴ are as described above for formula (C2-1), and subscripts mm, nn, oo, and h are as described above for formula (C2-17).

Alternatively, (E2) the aldehyde-functional polyorganosiloxane may comprise (E2-18) an aldehyde-functional silsesquioxane resin, i.e., a resin containing trifunctional (T′) units of unit formula: (R⁴₃SiO_{1/2})ₐ(R⁴₂R^{Ald}SiO_{1/2})_{b}(R⁴₂SiO_{2/2})_{c}(R⁴R^{Ald}SiO_{2/2})_{d}(R⁴SiO_{3/2})ₑ(R^{Ald}SiO_{3/2}) (ZO_{1/2})ₕ; where R^{Ald} is as described above for formula (E1-1), R⁴ is as described above for formula (C2-1), and subscripts a, b, c, d, e, f, and h are as described above for formula (C2-18). Alternatively, the aldehyde-functional silsesquioxane resin may comprise unit formula (E2-19): (R⁴SiO_{3/2})ₑ(R^{Ald}SiO_{3/2})_{f}(ZO_{1/2})ₕ, where R^{Ald} is as described above for formula (E1-1), R⁴ and Z are as described above for formula (C2-1), and subscripts h, e and f are as described above for formula (C2-19). Alternatively, the alkenyl-functional silsesquioxane resin may further comprise difunctional (D′) units of formulae (R⁴₂SiO_{2/2})_{c}(R⁴R^{Ald}SiO_{2/2})_{d} in addition to the T units described above, i.e., a D′T′ resin, where subscripts c and d are as described above for formula (C2-1). Alternatively, the alkenyl-functional silsesquioxane resin may further comprise monofunctional (M′) units of formulae (R⁴₃SiO_{1/2})ₐ(R⁴₂R^{Ald}SiO_{1/2})_{b}, i.e., an M′D′T′ resin, where subscripts a and b are as described above for unit formula (C2-1).

Starting material (E) may be any one of the aldehyde-functional organosilicon compounds described above. Alternatively, starting material (E) may comprise a mixture of two or more of the aldehyde-functional organosilicon compounds.

The process for preparing the carbinol-functional organosilicon compound may comprise:
I) combining, under conditions to catalyze hydrogenation reaction, starting materials comprising
   (E) the aldehyde-functional organosilicon compound described above,
   (F) hydrogen, and
   (G) a hydrogenation catalyst, thereby forming a hydrogenation reaction product comprising the carbinol-functional organosilicon compound.

The process may optionally further comprise, before step I), i) combining, under conditions to catalyze hydroformylation reaction, starting materials comprising (A) the gas comprising hydrogen and carbon monoxide, (B) the alkenyl-functional organosilicon compound, and (C) the rhodium/bisphosphite ligand complex catalyst, thereby forming a hydroformylation reaction product comprising the aldehyde-functional organosilicon compound as described above. The process may optionally further comprise, before step I) and after step i), step ii) recovering (C) the rhodium/bisphosphite ligand complex catalyst from the reaction product comprising the aldehyde-functional organosilicon compound. The process may optionally further comprise, before step I) and after step i), iii) purifying the reaction product; thereby isolating the aldehyde-functional organosilicon compound from the additional materials, as described above.

### (F) Hydrogen

Hydrogen is known in the art and commercially available from various sources, e.g., Air Products of Allentown, Pennsylvania, USA. Hydrogen may be used in a superstoichiometric amount with respect to the aldehyde-functionality of starting material (E), the aldehyde-functional organosilicon compound described above, to permit complete hydrogenation.

### (G) Hydrogenation Catalyst

The hydrogenation catalyst used in the process for preparing the carbinol-functional organosilicon compound may be a heterogeneous hydrogenation catalyst, a homogenous hydrogenation catalyst, or a combination thereof. Alternatively, the hydrogenation catalyst may be a heterogeneous hydrogenation catalyst. Suitable heterogeneous hydrogenation catalysts comprise a metal selected from the group consisting cobalt (Co), copper (Cu), nickel (Ni), palladium (Pd), platinum (Pt), ruthenium (Ru), and a combination of two or more thereof. Alternatively, the hydrogenation catalyst may comprise Co, Cu, Ni, Pd, or a combination of two or more thereof. Alternatively, the hydrogenation catalyst may comprise Co, Cu, Ni, or a combination of two or more thereof. The hydrogenation catalyst may include a support, such as alumina (Al₂O₃), silica (SiO₂), silicon carbide (SiC), or carbon (C). Alternatively, the hydrogenation catalyst may be selected from the group consisting of Raney nickel, Raney copper, Ru/C, Ru/Al₂O₃, Pd/C, Pd/Al₂O₃, Cu/C, Cu/Al₂O₃, Cu/SiO₂, Cu/SiC, Cu/C, and a combination of two or more thereof.

Alternatively, heterogeneous hydrogenation catalysts for hydrogenation of aldehydes may include a support material on which copper, chromium, nickel, or two or more thereof are applied as active components. Exemplary catalysts include copper at 0.3 to 15%; nickel at 0.3% to 15%, and chromium at 0.05% to 3.5%. The support material may be, for example, porous silicon dioxide or aluminium oxide. Barium may optionally be added to the support material. Chromium free hydrogenation catalysts may alternatively be used. For example a Ni/Al₂O₃ or Co/Al₂O₃ may be used, or a copper oxide/zinc oxide containing catalyst, which further comprises potassium, nickel, and/or cobalt; and additionally an alkali metal. Suitable hydrogenation catalysts are disclosed for example, in U.S. Pat. No. 7,524,997 or U.S. Pat. No. 9,567,276 and the references cited therein.

Examples of suitable heterogeneous hydrogenation catalysts for use herein include Raney Nickel such as Raney Nickel 2400, Ni-3288, Raney Copper, Hysat 401 salt (Cu), Ruthenium on carbon (Ru/C), platinum on carbon (Pt/C), copper on silicon carbide (Cu/SiC).

Alternatively, a homogeneous hydrogenation reaction catalyst may be used herein. The homogeneous hydrogenation catalyst may be a metal complex, where the metal may be selected from the group consisting of Co, Fe, Ir, Rh, and Ru. Examples of suitable homogeneous hydrogenation catalysts are exemplified by [RhCl(PPh₃)₃] (Wilkinson's catalyst); [Rh(NBD)(PR′₃)₂]+ClO₄— (where R′ is an alkyl group, e.g. Et); [RuCl₂ (diphosphine)(1,2-diamine)] (Noyori catalysts); RuCl₂(TRIPHOS) (where TRIPHOS=PhP[(CH₂CH₂PPh₂)₂]; Ru(II)(dppp)(glycine) complexes (where dppp=1,3-bis(diphenylphosphino)propane); RuCl₂(PPh₃)₃; RuCl₂(CO)₂(PPh₃)₂; IrH₃(PPh₃)₃; [Ir(H₂)(CH₃COO)(PPh₃)₃]; cis-[Ru—Cl2(ampy)(PP)][where ampy=2-(aminomethyl)pyridine; and PP=1,4-bis-(diphenylphosphino) butane, 1,1′-ferrocenediyl-bis(diphenylphosphine)]; Pincer RuCl(CNNR)(PP) complexes [where PP=1,3-bis(diphenylphosphino)propane, 1,4-bis(diphenylphosphino) butane, 1,1′-ferrocenediyl-bis(diphenylphosphine); and HCNNR=4-substituted-aminomethyl-benzo[h]quinoline; R=Me, Ph]; [RuCl₂ (dppb) (ampy)] (where dppb=1,4-Bis(diphenylphosphino) butane, ampy=2-aminomethyl pyridine); [Fe(PNPMeiPr)(CO)(H)(Br)]; [Fe(PNPMe-iPr)(H)₂(CO)]; and a combination thereof.

The amount of hydrogenation catalyst used in the process depends on various factors including whether the process will be run in a batch or continuous mode, the selection of aldehyde-functional organosilicon compound, whether a heterogeneous or homogeneous hydrogenation catalyst is selected, and reaction conditions such as temperature and pressure. However, when the process is run in a batch mode the amount of catalyst may be 1 weight % to 20 weight %, alternatively 5 weight % to 10 weight %, based on weight of the aldehyde-functional organosilicon compound. Alternatively, the amount of catalyst may be at least 1, alternatively at least 4, alternatively at least 6.5, and alternatively at least 8, weight %; while at the same time the amount of catalyst may be up to 20, alternatively up to 14, alternatively up to 13, alternatively up to 10, and alternatively up to 9, weight %, on the same basis. Alternatively, when the process will be run in a continuous mode, e.g., by packing a fixed bed reactor with a heterogeneous hydrogenation catalyst, the amount of the hydrogenation catalyst may be sufficient to provide a reactor volume (filled with hydrogenation catalyst) to achieve a space time of 10 hr⁻¹, or catalyst surface area sufficient to achieve 10 kg/hr substrate per m² of catalyst.

### (H) Solvent

A solvent that may optionally be used in the process for hydrogenation reaction may be selected from those solvents that are neutral to the reaction. The following are specific examples of such solvents: monohydric alcohols such as ethanol and isopropyl alcohol; dioxane, ethers such as THF; aliphatic hydrocarbons, such as hexane, heptane, and paraffinic solvents; and aromatic hydrocarbons such as benzene, toluene, and xylene; chlorinated hydrocarbons, and water. These solvents can be used individually or in combinations of two or more.

The hydrogenation reaction can be performed using pressurized hydrogen. Hydrogen (gauge) pressure may be 10 psig (68.9 kPa) to 3000 psig (20684 kPa), alternatively 10 psig to 2000 psig (13790 kPa), alternatively 10 psig to 800 psig (5516 kPa), alternatively 50 psig (345 kPa) to 200 psig (1379 kPa). The reaction may be carried out at a temperature of 0 to 200° C. Alternatively, a temperature of 50 to 150° C. may be suitable for shortening the reaction time. Alternatively, the hydrogen (gauge) pressure used may be at least 25, alternatively at least 50, alternatively at least 100, alternatively at least 150, and alternatively at least 164, psig; while at the same time the hydrogen gauge pressure may be up to 800, alternatively up to 400, alternatively up to 300, alternatively up to 200, and alternatively up to 194, psig. The temperature for hydrogenation reaction may be at least 50, alternatively at least 65, alternatively at least 80° C., while at the same time the temperature may be up to 200, alternatively up to 150, alternatively up to 120° C.

The hydrogenation reaction can be carried out as a batch process or as a continuous process. In a batch process, the reaction time depends on various factors including the amount of the catalyst and reaction temperatures, however, the hydrogenation reaction may be performed for 1 minute to 24 hours. Alternatively, the hydrogenation reaction may be performed for at least 1 minute, alternatively at least 2 minutes, alternatively at least 1 hour, alternatively at least 2.5 hours, alternatively at least 3 hours, alternatively at least 3.3 hours, alternatively at least 3.7 hours, alternatively at least 4 hours, alternatively at least 4.4 hours, and alternatively at least 5.5 hours; while at the same time, the hydrogenation reaction may be performed for up to 24 hours, alternatively up to 22.5 hours, alternatively up to 22 hours, alternatively up to 12 hours, alternatively up to 7 hours, and alternatively up to 6 hours.

Alternatively, in a batch process, the terminal point of a hydrogenation reaction can be considered to be the time during which the decrease in pressure of hydrogen is no longer observed after the reaction is continued for an additional 1 to 2 hours. If hydrogen pressure decreases in the course of the reaction, it may be desirable to repeat the introduction of hydrogen and to maintain it under increased pressure to shorten the reaction time. Alternatively, the reactor can be re-pressurized with hydrogen 1 or more times to achieve sufficient supply of hydrogen for reaction of the aldehyde while maintaining reasonable reactor pressures.

After completion of the hydrogenation reaction, the hydrogenation catalyst may be separated in a pressurized inert (e.g., nitrogenous) atmosphere by any convenient means, such as filtration or adsorption, e.g., with diatomaceous earth or activated carbon, settling, centrifugation, by maintaining the catalyst in a structured packing or other fixed structure, or a combination thereof.

The carbinol functional organosilicon compound prepared as described above has, per molecule, at least one carbinol-functional group covalently bonded to silicon. Alternatively, the carbinol-functional organosilicon compound may have, per molecule, more than one carbinol-functional group covalently bonded to silicon. The carbinol-functional group covalently bonded to silicon, R^{Car}, may have formula:

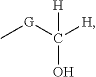

where G is a divalent hydrocarbon group free of aliphatic unsaturation that has 2 to 8 carbon atoms, as described and exemplified above. Examples of the carbinol functional organosilicon compound prepared by this process are as described and exemplified above.

### (D) Solvent

Starting material (D) is the solvent that may optionally be used in the method for making the polyether-functional organosilicon compound. The solvent may be added to facilitate mixing and/or delivery of one or more of the starting materials described above. For example, (B) the halogenated triarylborane Lewis acid may be delivered in a solvent. Alternatively, (C) the carbinol-functional organosilicon compound may be delivered in a solvent, for example, when the carbinol-functional organosilicon compound comprises a carbinol-functional polyorganosiloxane resin.

Suitable solvents include those that will not react with the starting materials used in step (1). Solvents for use in step (1) include liquid hydrocarbons. For example, the hydrocarbon solvent may be an aromatic hydrocarbon such as benzene, ethylbenzene, toluene, xylene, or an aliphatic hydrocarbon such as heptane, or a combination of both an aromatic hydrocarbon and an aliphatic hydrocarbon. Alternatively, the solvent may comprise a liquid non-functional organosilicon compound such as low viscosity linear and cyclic polydiorganosiloxanes. The amount of solvent is not critical and depends on various factors including whether (C) the carbinol-functional organosilicon compound is a solid under ambient conditions (e.g., a carbinol-functional polyorganosiloxane resin), and the type of reactor selected for alkoxylation. However the amount of solvent used during the alkoxylation reaction in step (1) may be 1% to 90% based on combined weights of (A) the epoxide, (B) the halogenated triarylborane Lewis acid, and (C) the carbinol-functional organosilicon compound.

### Polyether-Functional Organosilicon Compound

The polyether-functional organosilicon compound prepared by the method described herein has at least one polyether group bonded to a silicon atom via an Si—C linkage, per molecule. Alternatively, the polyether-functional organosilicon compound may have at least two polyether groups per molecule. The polyether-functional organosilicon compound may have a formula corresponding to any one or more of formulas (C1) and (C2-1) to (C2-19) for the carbinol-functional organosilicon compound, with the proviso that at least one R^{Car} group, per molecule, is replaced a polyether group (R^{PE}, which is formed via alkoxylation of the epoxide with the carbinol group). Alternatively, the polyether-functional organosilicon compound may have a formula corresponding to any one or more of formulas (C1) and (C2-1) to (C2-19) for the carbinol-functional organosilicon compound, with the proviso that each R^{Car} group in the molecule, is replaced a polyether group, R^{PE}. R^{PE} may have formula:

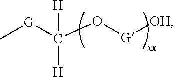

where G is as described above, each G′ is an independently selected divalent organic group derived from ring opening of (A) the epoxide, and subscript xx is an integer ≥2, alternatively 2 to 100, alternatively 2 to 15. For example, when ethylene oxide is used as starting material (A), R^{PE} may have formula:

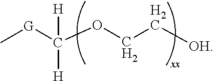

When a mixture of ethylene oxide and propylene oxide is used as starting material (A), then R^{PE} may have unit formula:

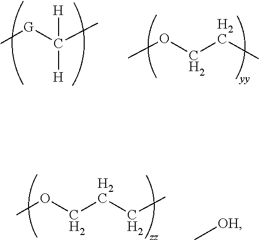

where subscript yy≥1, subscript zz>1, and a quantity (yy+zz)=xx. Alternatively, when starting material (A) is glycidol, R^{PE} may have formula:

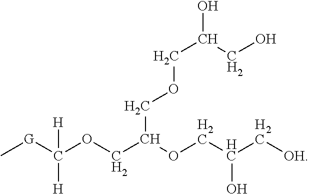

Such polyether-functional organosilicon compounds are exemplified below in the EXAMPLES and the Embodiments of the Invention.

### Examples

The following examples are provided to illustrate the invention to one skilled in the art and are not to be construed to limit the invention set forth in the claims. Starting materials used in these examples are described in Table 1, below.

TABLE 1
Starting Materials

| | Material | Chemical Description, Chemical formula, or | |
|---|---|---|---|
| Type | Name | Structure | Source |
| Solvent 1 | Toluene | PhCH₃ | Fisher Chemical |
| Solvent 2 | Hexane | CH₃(CH₂)₄CH₃ | Fisher Chemical |
| Starting mono- carbinol | MD^{PrOH}M | 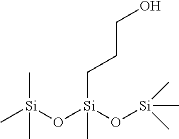 | Made at Dow by hydroformylating the vinylsiloxane, followed by hydrogenation of the aldehyde* |
| Starting di- | BY16-201 | Bis-carbinol-terminated polydimethylsiloxane | Dow |
| carbinol 1 | | with the average formula shown in Example 1 | |
| Starting di- | M^{PrOH}M^{PrOH} | Bis(3-hydroxypropyl)-1,1,3,3-tetramethyl- | Gelest |
| carbinol 2 | | disiloxane | |
| Starting | Polysiloxane | A carbinol-functional polyorganosiloxane of | Made at Dow by |
| polysiloxane | tetracarbinol | unit formula | hydroformylating |
| tetra- | | (R⁴₃SiO_{1/2})₂(R⁴₂SiO_{2/2})₈(R⁴RCarsiO_{2/2})₄, where | the vinylsiloxane, |
| carbinol | | each R⁴ was methyl and each R^{Car} was —CH₂— | followed by |
| | | CH₂—CH₂—OH | hydrogenation of |
| | | | the aldehyde* |
| Starting trisiloxane carbinol 1 | MD^{PrOH}M | 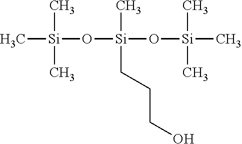 | |
| Starting trisiloxane carbinol 2 | MD^{PrOEO}M | 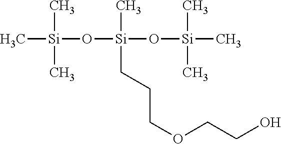 [SMILES: C[Si](C)(C)O[Si](C)(CCCOCCO)O[Si](C)(C)C] | |
| Catalyst | FAB | Tris(pentafluorophenyl)borane | Sigma-Aldrich |
| Catalyst | Catalyst 1 | tris(3,5-bis(trifluoromethyl)phenyl)borane THF | Made at Dow, |
| | | adduct | WO 2019055740 |
| Catalyst | Catalyst 2 | bis(3,5-bis(trifluoromethyl)phenyl)(2,4,6- | Made at Dow, |
| | | trifluorophenyl)borane THF adduct | WO 2019055740 |
| Comparative | Boron | BF₃•(OCH₂CH₃)₂ | Sigma-Aldrich |
| Catalyst | trifluoride | | |
| | etherate | | |
| Comparative | DMC | Double metal cyanides | Dow |
| Catalyst | | | |
| Adsorbent | Activated | Activated carbon black | Sigma-Aldrich |
| | charcoal, lot | | |
| | SHBL 9630 | | |

Reference Example A—Reactions were run in parallel pressure reactors (PPR) with addition of suitable alkylene oxides by aliquots and in a batch reactor with continuous addition of the alkylene oxide. The relevant parameters included starting material structure and composition, type of alkylene oxide, catalyst structure, catalyst loading, and reaction time.

Reference Example B—The product structures and composition were supported by ¹H, ¹³C, and ²⁹Si Nuclear Magnetic Resonance (NMR). Product molecular weights such as Mn and Mw along with polydispersity indexes (PDI) were determined by Gel Permeation Chromatography (GPC). Water in the starting carbinol-functional organosilicon compounds was measured by Karl Fisher technique and usually did not exceed 100 ppm.

NMR: ¹H, ¹³C, and ²⁹Si NMR spectra were recorded on a Varian 400-NMR spectrometer (400 MHZ, ¹H) with an autosampler. Chemical shifts (8) for ¹H and ¹³C spectra were referenced to internal solvent resonances and are reported relative to tetramethyl silane. Predicted chemical shifts for ¹H and ¹³C spectra were obtained using Perkin-Elmer ChemDraw Version 18.2.0.48 software.

GPC: Samples were dissolved in tetrahydrofuran (THF) stabilized with 250 ppm butylated hydroxyl toluene (BHT) at a concentration of 2.0 mg/mL. Samples were shaken to dissolve solids for GPC analysis. GPC/SEC analysis was performed using an Agilent 1260 Infinity system equipped with a refractive index detector and columns with a linear MW operating range up to 30,000 g/mol. Samples (100 μL) were eluted through one PL-gel 3 μm×50×7.5 mm guard column followed by two PL-gel 3 μm×300×7.5 mm Mixed-E columns maintained at 35° C. with THE stabilized with BHT at a flowrate of 1.00 mL/min. The total run time was 23.00 min. Agilent EasiVial PS-L polystyrene standards were diluted to 1.5 mL with THF stabilized with BHT and analyzed at the same run conditions described above to create a 12-point MW calibration curve. This third order calibration curve was applied to sample results to determine MW properties.

In this Example 1, to 34 g (0.02 moL) of a bis-carbinol-terminated polydimethylsiloxane with average formula

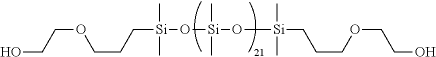

was added 0.068 g (2000 ppm) of tris(pentafluorophenyl)borane (FAB) and dissolved with stirring. This solution was charged by syringe to a batch reactor under nitrogen and heated to 60° C. Ethylene oxide (21.36 g; 0.48 moL) was added with a rate of 1 mL/min at 60° C. with stirring. At the end of the addition in about 30 min, stirring at 60° C. continued for 3 more hours. The residual ethylene oxide was purged with nitrogen, mixture was cooled, and the recovered product (52 g) was analyzed by 1H NMR. The NMR test results confirmed that the SPE product had the structure shown below.

The GPC analysis of the SPE product is shown below in Table 2.

TABLE 2
GPC analysis:

| Material | Mn | Mw | PDI |
|---|---|---|---|
| Starting Material | 2019 | 2831 | 1.40 |
| SPE Product | 3609 | 6291 | 1.74 |

The silicone—polyether product contained on average 23.8 added ethylene oxide units per formula or on average 11.9 ethylene oxide units per chain and corresponded to the following average formula:

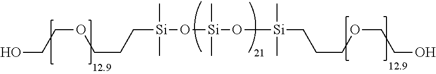

In these Examples 2-4, the experiment described in Example 1 was repeated in Parallel Pressure Reactors (PPR) except that trifluoroborane (2000 ppm, added as trifluoroborane etherate) was used in place of FAB. The description of the PPR is given in Examples 14-36. The reactions were carried out at 60° C. for 4 hours. The products were analyzed by GPC and NMR. There was no reaction and the starting material bis-carbinol-terminated polydimethylsiloxane remained intact as shown in Table 3, below.

TABLE 3

| | PO | PO per | EO | EO per | | | |
|---|---|---|---|---|---|---|---|
| Example | design | chain | design | chain | Mn | Mw | PDI |
| 2 | 20 | none | — | — | 2138 | 3024 | 1.41 |
| 3 | — | — | 12 | none | 2126 | 3056 | 1.44 |
| 4 | — | — | 24 | none | 2130 | 3057 | 1.44 |

Examples 2, 3, and 4 showed that not all fluorinated boron containing Lewis acid catalysts worked under the conditions tested. When boron trifluoride (as described in U.S. Pat. No. 5,391,679) was used, the desired SPE products were not obtained.

In this Example 5, to 36.0 g (0.03 mol) of a bis-trimethylsiloxy-terminated siloxane having pendant carbinol-functional groups (polysiloxane tetracarbinol) with average unit formula (R⁴₃SiO_{1/2})₂(R⁴₂SiO_{2/2}) 8 (R⁴R^{Car}SiO_{2/2})₄, where each R⁴ was methyl and R^{Car} was —CH₂—CH₂—CH₂—OH was added 0.072 g (2000 ppm) FAB and dissolved with stirring. This solution was charged by syringe to a batch reactor under nitrogen and heated to 60° C. Ethylene oxide (16.02 g; 0.36 moL) was charged at the rate of 1 mL/min at 60° C. with stirring. Once all ethylene oxide was added, stirring at 60° C. continued for 3 more hours. The reactor was cooled, purged with nitrogen, and the very viscous SPE product was recovered in the amount of 52 g. This SPE had unit formula (R⁴₃SiO_{1/2})₂(R⁴₂SiO_{2/2})₈(R⁴R^{PE}SiO_{2/2})₄, where R^{PE} had formula

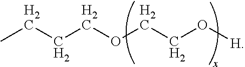

This SPE contained on average 5.7 added ethylene oxide units per chain, where x=5.7 in the unit formula. NMR analysis confirmed the SPE had the unit formula above. GPC analysis of the polysiloxane tetracarbinol starting material and the SPE product prepared therefrom are shown below in Table 4:

TABLE 4
GPC Analysis

| Material | Mn | Mw | PDI |
|---|---|---|---|
| Polysiloxane Tetracarbinol | 2024 | 3392 | 1.68 |
| SPE Product | 5,730 | 20,687 | 3.61 |

In this Example 6, to 27.5 g (0.0229 mol) of the polysiloxane tetracarbinol described in Example 5 was added 0.055 g (2000 ppm) FAB and dissolved with stirring. This solution was charged by syringe to a batch reactor under nitrogen and heated to 60° C. Ethylene oxide (44.05 g; 1.00 moL) was charged at the rate of 1 mL/min at 60° C. with stirring. Once all ethylene oxide was added, stirring at 60° C. continued for 3 more hours. The residual ethylene oxide was purged with nitrogen and the mixture was cooled, resulting in a white rubbery polymer in the amount of 55 g, which was not soluble in acetone, methanol, water, THF, toluene, chloroform or their mixtures. This polymer was partially dissolved in dmso-d6 and 1H NMR showed presence of aldehyde protons at 9.7 ppm and acetals at 4.5-5.00 ppm, suggesting extensive crosslinking.

In this Example 7, to 30.6 g (0.122 mol) of bis(3-hydroxypropyl)-1,1,3,3-tetramethyldisiloxane of the formula:

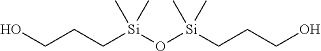

was added 0.061 g (2000 ppm) FAB and dissolved with stirring. This solution was charged by syringe to a batch reactor under nitrogen and heated to 60° C. Ethylene oxide (44.05 g; 1.00 moL) was charged at the rate of 1 mL/min at 60° C. with stirring. Once all ethylene oxide was added, stirring at 60° C. continued for 1 more hour. The reactor was cooled, purged with nitrogen, and the liquid product was recovered in 71.7 g yield. The product contained a SPE, which had 8.8 added ethylene oxide units per molecule of starting material, or on average 4.4 ethylene oxide units per chain. NMR analysis confirmed the SPE had the formula below, where each y had an average value of 4.4:

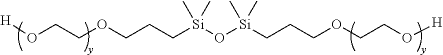

The starting material had MW=250.49, and GPC analysis of the product SPE is in Table 5, below.

TABLE 5

| Material | Mn | Mw | PDI |
|---|---|---|---|
| SPE Product | 1069 | 1588 | 1.49 |

In these Examples 8-9, the alkoxylation reactions were conducted in a Parallel Pressure Reactor (PPR) setup containing 6 modules each having 8 cells with glass inserts and equipped with removable polyetheretherketone (PEEK) paddles for mechanical stirring. The set-up was located in the nitrogen glove box. 3-(3-Hydroxypropyl) heptamethyltrisiloxane (0.98 g; 3.5 mmoL) containing 0.5% FAB was charged by syringe to the glass insert of the PPR under nitrogen. The glass insert and the fitting stir paddle were loaded to the PPR wells. The reactor cells were sealed and charged at room temperature by the robot with ethylene oxide (1.85 g; 42 mmoL) in two aliquots spaced by 45 min intervals and then stirred at 25° C. The mixtures were prepared in replicates. In 20 hours, pressure curves showed consumption of the ethylene oxide. The cells were vented and purged with nitrogen to remove residual ethylene oxide. Small samples were taken for NMR and GPC analyses. The resulting SPE contained 11.9 added ethylene oxide units per molecule of starting material. If the catalyst loading was 0.2 wt %, the resulting SPE contained only 6.7 added ethylene oxide units.

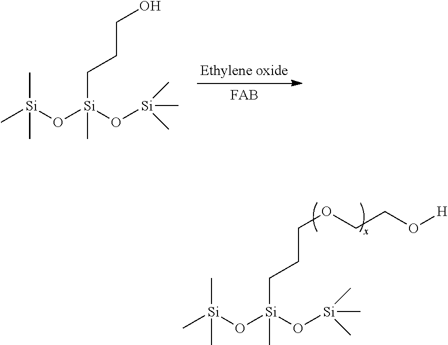

As shown in the reaction scheme above, in Example 8, x was 11.9 when catalyst loading was 0.5%, and x was 6.7 in Example 9 when catalyst loading was 0.2%. Results are shown below in Table 6.

TABLE 6
Results of Examples 8 and 9

| Example | FAB, wt % | #EO/OH ¹H NMR | Mn | Mw | PDI |
|---|---|---|---|---|---|
| 8 | 0.5 | 11.9 | 1059 | 1295 | 1.22 |
| 9 | 0.2 | 6.7 | 627 | 764 | 1.22 |

Using FAB as the catalyst under the conditions tested produced desired SPEs with mono- and di-carbinols in Examples 1, 7, 8, and 9 in either the batch or parallel pressure reactors (PPR). It was possible to make ethoxylated tetracarbinol using FAB with a low proportion of ethylene oxide monomer, albeit the molecular weight distribution of the obtained polymer was wide under the conditions tested in Example 5. However, the same reaction resulted in crosslinking with a higher proportion of ethylene oxide as disclosed in Example 6. Without wishing to be bound by theory, it is thought that this occurred due to the ability of FAB to transform small amounts of epoxides into the corresponding aldehydes which formed acetal bridges with end hydroxyl groups of alkoxylated carbinols. Tricarbinols, tetracarbinols and higher carbinols formed two, three, and higher dimensional networks resulting in cross-linked polymers. Use of Catalyst 1 and Catalyst 2 lead to significantly less acetal formation under the conditions tested, and therefore, they produced higher quality alkoxylates with narrow MW distribution not only for siloxane-based mono- and di-carbinols, but also for polycarbinols.

In this Example 10 the polysiloxane tetracarbinol of Example 5 was diluted with hexane and stirred with activated carbon overnight, followed by filtering off the carbon and removing the hexane (solvent) in vacuum. The purified polysiloxane tetracarbinol (30.2 g; 0.025 mol) was charged to a batch reactor under nitrogen and heated to 50° C. with stirring. Then 0.300 g (1 wt %) triorganoboron Catalyst 2 (bis(3,5-bis(trifluoromethyl)phenyl)(2,4,6-trifluorophenyl)borane THF adduct) was dissolved in 3 mL of anhydrous toluene and added to the reactor by syringe. Ethylene oxide (44.05 g; 1.00 moL) was manually charged in 2-3 mL portions at 50° C. for 2 hours with stirring. Once all ethylene oxide was added, stirring at 50° C. continued for one more hour. The reactor was cooled, purged with nitrogen, and the product was recovered in 65.5 g yield. ¹H and ¹³C NMR analysis revealed that the SPE in the product contained on average 13.6 added ethylene oxide units per chain, where the unit formula was as shown in Example 5 except the value x was 13.6. The GPC analyses of the tetracarbinol polysiloxane starting material and the resulting SPE are shown below in Table 7. 1H NMR analysis confirmed the SPE with the unit formula below formed.

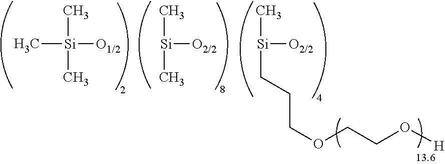

TABLE 7
GPC analyses

| Material | Mn | Mw | PDI |
|---|---|---|---|
| Tetracarbinol Polysiloxane | 1784 | 2847 | 1.60 |
| SPE Product | 5094 | 8759 | 1.72 |

The ²⁹Si NMR spectrum of the product contained only visible peaks positioned at −22.17 ppm and 7.00 ppm attesting to the absence of polysiloxane backbone decomposition.

In these Examples 11-14, the procedure of Example 10 was repeated using the starting polysiloxane tetracarbinol of Example 5 that was purified by treating with activated carbon two times consecutively and various loadings of Catalyst 2. The polysiloxane tetracarbinol had Mₙ 1870, M_{w} 2823 and PD 1.51. The resulting SPE characterization results are listed in Table 8.

TABLE 8

| | Temperature | Catalyst 2, | EO units per | | | |
|---|---|---|---|---|---|---|
| Example | ° C. | wt % | chain, x | Mn | Mw | PDI |
| 11 | 50 | 1.0 | 14.5 | 4289 | 6691 | 1.56 |
| 12 | 50 | 0.5 | 13.5 | 3752 | 5800 | 1.55 |
| 13^{a} | 50 | 0.25 | 16.0 | 3986 | 6367 | 1.60 |
| 14 | 40 | 0.10 | 13.7 | 3836 | 6345 | 1.65 |

In Example 13, superscript “a” denotes that the amount of EO added to the polysiloxane tetracarbinol was deliberately increased to obtain the product with higher proportion of EO.

In this Example 15, Example 14 was repeated using the temperature 50° C. in place of 40° C. After only 4 mL of ethylene oxide was consumed, the reaction slowed. Without wishing to be bound by theory, it is thought that at the extremely low level of catalyst used, the treatment with activated carbon may have been insufficient to completely remove the impurity from the polysiloxane tetracarbinol starting material used in this example. Furthermore, it is thought that remaining impurity may react faster with the halogenated triarylborane Lewis acid catalyst at 50° C. than the ethoxylation reaction can proceed, and that the impurity may have inactivated the catalyst at the 50° C. temperature.

In these Examples 16-27, the carbinol-functional organosilicon compound starting material was optionally treated overnight with 10% activated charcoal with stirring, and then filtered using a Whatman 0.2 mu Nylon membrane filter. The alkoxylation reactions were conducted in a Parallel Pressure Reactor (PPR) setup containing 6 modules each having 8 cells with glass inserts and equipped with removable polyetheretherketone (PEEK) paddles for mechanical stirring. The set-up was located in the nitrogen glove box.

The polysiloxane tetracarbinol containing 0.5 wt % Catalyst 2 was prepared as a stock solution. The stock solution in an amount of 1.208 g, 0.604 g or 0.242 g was charged by syringe to 48 glass inserts of the Parallel Pressure Reactors (PPR) under nitrogen. Additional calculated amounts of the polysiloxane tetracarbinol (0.604 g and 0.966 g) were added to the selective cells to dilute the mixtures to make 0.25% and 0.1% of the catalyst. The glass inserts and the fitting stir paddles were loaded to the PPR wells. The reactor cells were sealed, heated to 40° C. or 50° C., and charged by the robot with ethylene oxide (1.938 g) in four aliquots spaced by 45 min intervals. The mixtures were prepared in replicates. The pressure curves showed the consumption of the ethylene oxide following each injection. In 6 hours the cells were cooled, vented, and purged with nitrogen to remove residual ethylene oxide. Small samples were taken from each reactor for NMR and GPC analyses. The results for selected samples are shown in Table 9.

TABLE 9

| | | Tem- | Catalyst | | | | |
|---|---|---|---|---|---|---|---|
| Example | Carbon | perature | 2, | EO per | | | |
| # | treatment | ° C. | wt % | chain, x | Mn | Mw | PDI |
| 16 | none | 50 | 0.5 | 2.5 | 2414 | 3744 | 1.55 |
| 17 | none | 50 | 0.25 | 2.6 | 2456 | 3817 | 1.55 |
| 18 | none | 50 | 0.1 | 0.5 | 1963 | 3015 | 1.54 |
| 19 | one time | 50 | 0.5 | 13.9 | 4822 | 7613 | 1.58 |
| 20 | one time | 50 | 0.2 | 2.3 | 2357 | 3749 | 1.59 |
| 21 | one time | 50 | 0.1 | 1.9 | 2225 | 3413 | 1.53 |
| 22 | two times | 50 | 0.5 | 13.2 | 4536 | 7412 | 1.63 |
| 23 | two times | 50 | 0.25 | 12.3 | 4451 | 6765 | 1.52 |
| 24 | two times | 50 | 0.1 | 1.8 | 2256 | 3526 | 1.56 |
| 25 | two times | 40 | 0.5 | 15.8 | 4471 | 7121 | 1.59 |
| 26 | two times | 40 | 0.25 | 13.5 | 4474 | 6632 | 1.48 |
| 27 | two times | 40 | 0.1 | 10.5 | 3761 | 5729 | 1.52 |

Without wishing to be bound by theory, it is thought that the data in Table 9 show that removing impurities from the carbinol-functional organosilicon compound before alkoxylation can improve reaction performance and the resulting SPE. For example, Example 24 and Example 27 were run at the same conditions except for the temperature. Example 27, at the lower temperature, showed better ethylene oxide incorporation as shown by high EO per chain than Example 24. This was a surprising result because alkoxylation reactions typically run faster at increased temperatures, but in Examples 24 and 27 the opposite was true. Without wishing to be bound by theory, it is thought that because some impurity is still present in the starting material even after two carbon treatments, the remaining impurity reacts with the halogenated triarylborane Lewis acid and decreases its catalytic activity. It is thought that this decrease occurs to a lesser extent at 40° C. (lower temperature) in example 27, than at 50° C. (higher temperature) in example 24. However, it is thought that the ethoxylation rate is also less at 40° C. than at 50° C. Since examples 24 and 17 show better EO incorporation at 40° C. than at 50° C. using the same carbinol-functional organosilicon starting material, it is thought that when the temperature is decreased 10° C., both catalyst deactivation rate and ethoxylation rate slow down, but the catalyst deactivation rate slows down to a larger degree than the ethoxylation rate. In other words, catalyst deactivation rate is significantly enhanced at elevated temperature while ethoxylation rate is only slightly increased.

The inventors surprisingly discovered that the low loading of Catalyst 2 of 0.1 wt % could be used at a relatively low temperature of 40° C. in Example 14. When the temperature was increased to 50° C. under otherwise identical conditions, the desired ethoxylated product was not produced using the same Catalyst 2 loading in Example 15 but the desired ethoxylated product was produced with required higher catalyst loadings in Examples 11-13. Without wishing to be bound by theory, it is thought that the lower temperature reduced the rate of catalyst deactivation with remaining starting material impurities to a larger extent than it decreased the ethoxylation rate. Therefore, without wishing to be bound by theory, it is thought that this shows that when the starting materials contain catalyst deactivating impurities, it is beneficial to conduct a starting material purification step before the alkoxylation reaction. For example, 2 treatments with activated charcoal to remove impurities allowed for lower loading of Catalyst 2 than 1 treatment with activated charcoal as shown in Examples 16 to 27.

In these Examples 28-35, the carbinol-functional organosilicon compound was treated one time with activated charcoal. The alkoxylation reactions were conducted in a Parallel Pressure Reactor (PPR) setup containing 6 modules each having 8 cells with glass inserts and equipped with removable polyetheretherketone (PEEK) paddles for mechanical stirring. The set-up was located in the nitrogen glove box.

Stock solutions of polysiloxane tetracarbinol containing 1.0 wt % Catalyst 1 or Catalyst 2 were prepared. One of the stock solutions in an amount of 1.208 g or 0.604 g was charged by syringe to 48 glass inserts of the Parallel Pressure Reactors (PPR) under nitrogen. Additional calculated amounts of the polysiloxane tetracarbinol (0.604 g) were added to selected cells to dilute the mixtures to make 0.5 wt % of the catalyst. The glass inserts and the fitting stir paddles were loaded to the PPR wells. The reactor cells were sealed, heated to 50° C. or 60° C., and charged by the robot with ethylene oxide (1.938 g) in four aliquots spaced by 45 min intervals. The mixtures were prepared in replicates. The pressure curves showed the consumption of the ethylene oxide following each injection. In 6 hours the cells were cooled, vented, and purged with nitrogen to remove residual ethylene oxide. Small samples were taken from each reactor for NMR and GPC analyses. The results are shown in Table 10.

TABLE 10

| Example | | Catalyst | Temp | # EO per | | | |
|---|---|---|---|---|---|---|---|
| # | Catalyst | wt % | ° C. | chain | Mn | Mw | PDI |
| 28 | Catalyst 1 | 0.5 | 50 | 12.5 | 3896 | 10271 | 2.64 |
| 29 | Catalyst 2 | 0.5 | 50 | 14.2 | 4134 | 6432 | 1.56 |
| 30 | Catalyst 1 | 0.5 | 60 | 11.3 | 3505 | 8635 | 2.46 |
| 31 | Catalyst 2 | 0.5 | 60 | 5.7 | 2695 | 4364 | 1.62 |
| 32 | Catalyst 1 | 1 | 60 | 12.2 | 3474 | 10076 | 2.90 |
| 33 | Catalyst 2 | 1 | 60 | 14.9 | 4450 | 9710 | 2.18 |
| 34 | Catalyst 1 | 1 | 50 | 13.1 | 3490 | 10175 | 2.92 |
| 35 | Catalyst 2 | 1 | 50 | 14.8 | 4655 | 9771 | 2.10 |

The data in Table 10 showed that catalyst selection, catalyst amount, and temperature impacted the properties of the SPE product. More ethylene oxide groups could be incorporated at higher catalyst loadings and lower temperatures. Without wishing to be bound by theory, it is thought that the properties of the SPE (Mw, Mn, PDI, and amount of alkylene oxide incorporated) can be selected by varying the catalyst choice, catalyst amount and temperature. Examples 29 and 31 show similar results as examples 24 and 27 discussed above. When Catalyst 2 was used and all reaction conditions were kept constant except temperature, ethoxylation improved at 50 C as compared to 60 C, as shown by the increased value of EO per chain in Example 29 (14.2) as compared to Example 31 (5.7).

In these Examples 36-38, propoxylation was demonstrated as follows. The starting polysiloxane tetracarbinol (of the structure in Example 5) was treated two times with activated charcoal from Sigma-Aldrich. The alkoxylation reactions were conducted in a Parallel Pressure Reactor (PPR) setup containing 6 modules each having 8 cells with glass inserts and equipped with removable poly(ether etherketone) PEEK paddles for mechanical stirring. The set-up was located in the nitrogen box.

The polysiloxane tetracarbinol containing 0.5 wt % Catalyst 2 was prepared as a stock solution. The stock solution in amounts of 1.208 g, 0.604 g and 0.242 g was charged by syringe to 8 glass inserts of the Parallel Pressure Reactors (PPR) under nitrogen. Additional calculated amounts of the polysiloxane tetracarbinol (0.604 g and 0.966 g) were added to the selective cells to dilute the mixtures to 0.25 wt % and 0.1 wt % of the catalyst. The glass inserts and the fitting stir paddles were loaded to the PPR wells. The reactor cells were sealed, heated to 50° C., and charged by the robot with propylene oxide (1.938 g) in four aliquots spaced by 45 min intervals. The mixtures were prepared in replicates. The pressure curves showed the consumption of the propylene oxide following each injection. In 6 hours the cells were cooled, vented, and purged with nitrogen to remove residual ethylene oxide. Small samples were taken from each reactor for NMR and GPC analyses. The results for selected samples are shown in Table 11.

TABLE 11

| | Catalyst wt | # PO per | | | |
|---|---|---|---|---|---|
| Example # | % | chain | Mn | Mw | PDI |
| 36 | 0.5 | 12.4 | 3500 | 6689 | 1.91 |
| 37 | 0.25 | 8.8 | 3895 | 5907 | 1.52 |
| 38 | 0.1 | 2.0 | 2319 | 3407 | 1.47 |

Examples 36-38 show the method described herein works with varying levels of catalyst and different alkylene oxides.

In these Examples 39-44, polysiloxane tetracarbinol of the unit formula in Example 5, the starting trisiloxane carbinol 1 in Table 1, and the starting trisiloxane carbinol 2 in Table 1 were dried by purging with nitrogen at 110° C. for 12 hours. One of the resulting dried siloxane carbinols (2 g) and a catalyst were added in a nitrogen glove box to a 20 mL vial containing a magnetic stir bar. The vials were heated to a designated temperature and stirred for 4 hours. Then the vials were examined and mixtures analyzed by ²⁹Si NMR. The results are listed in Table 12.

TABLE 12
Stability of carbinol-functional siloxanes in the presence of
different catalysts kept at elevated temperatures for 4 hours.

| | | | Catalyst | | | | M(OZ) | Cyclics | Me₃SiOZ |
|---|---|---|---|---|---|---|---|---|---|
| | | | loading | Temp | Visual | | (mol | (mol | (mol |
| Ex. | Carbinol | Catalyst | (ppm) | (° C.) | observation | Degradation | %) | %) | %) |
| 39 | Tetracarbinol | None | 0 | 160 | clear | + | 2.3 | 0 | 0 |
| 40 | Tetracarbinol | FAB | 1000 | 160 | clear | + | 4.5 | 0.06 | 0.007 |
| 41 | Tetracarbinol | DMC/ | 500/5000 | 160 | hazy | +++ | 6.8 | 3.4 | 0 |
| | | Al(OiPr)₃ | | | | | | | |
| 42 | Tetracarbinol | NaOH | 4000 | 160 | solidified | − | — | — | — |
| 43 | MD^{PrOH}M | FAB | 1000 | 120 | clear | +++ | 2 | — | 8 |
| 44 | MD^{PrO-EO}M | FAB | 1000 | 120 | clear | no | 0 | — | 0 |

In Table 12, the number of + indicates the degree of siloxane bond degradation: + denotes degradation <5%, ++ denotes degradation 5-10%, +++ denotes degradation >10%. The degradation % was calculated based on total Si integration in ²⁹Si NMR. Z=H, Me, Pr; “cyclics” are cyclic PDMS like D4. The data in Table 12 show that comparative alkoxylation catalysts, such as DMC/Al(OiPr)₃, and NaOH significantly degraded the siloxane backbone under the conditions tested.

In this Example 45, an ethoxylation with the polysiloxane tetracarbinol using the double metal cyanide (DMC) catalyst was attempted. The alkoxylation reaction was carried out in a Parallel Pressure Reactor (PPR) setup under nitrogen. The polysiloxane tetracarbinol (1.225 g) containing 500 ppm DMC and 6000 ppm aluminum iso-propoxide (Al(OiPr)₃) was charged by syringe to the glass inserts of the Parallel Pressure Reactors (PPR) under nitrogen. The glass inserts and the fitting stir paddles were loaded to the PPR wells. The reactor cells were sealed, heated to 160° C., and charged by the robot with ethylene oxide (2.22 g) in three aliquots spaced by 60 min intervals. The mixtures were prepared in replicates. The pressure curves showed full consumption of ethylene oxide in 4 hours. The cells were cooled, vented, and purged with nitrogen. Small samples were taken from each reactor for NMR analyses.

A quantitative 13C NMR analysis revealed that 19% of the hydroxyl groups of the tetracarbinol groups did not react and that the reaction gave a high proportion of ethylene oxide homopolymerization with the molar ratio of the polyethylene glycol byproduct to the ethoxylated polysiloxane tetracarbinol of 1.1 to 1. ¹H NMR diffusion chromatography supported that the reaction product comprised a blend of polyethylene glycol and the ethoxylated tetracarbinol. The reaction product also exhibited decomposition of the polysiloxane backbone as the result of ethoxylation conditions, which was evidenced by a ²⁹Si NMR spectrum that showed 7% degradation overall (˜20% for the M portion) based on integration.

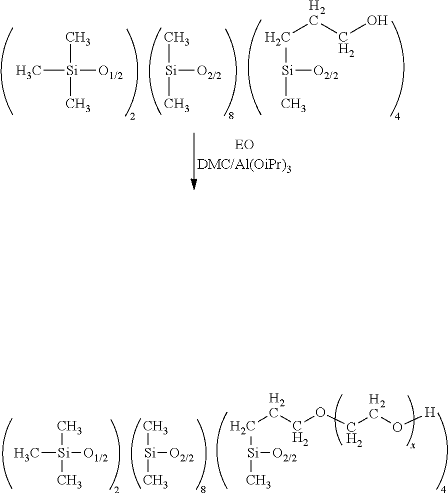

Examples 41, 42, and 45 showed that certain catalysts used previously for alkoxylation (such as NaOH and DMC) required high temperatures and resulted in partial decomposition of the polysiloxane backbone. In contrast, Example 1 showed the benefit of the fluorinated triarylborane Lewis acid used herein as the catalyst in that the polysiloxane backbone did not degrade.

In this Example 46, samples were prepared as follows:

### General Procedure for Preparation of Raney Ni Active Catalyst

The purchased 50 wt % Raney Ni™ in water was washed several times using deionized water in a plastic funnel. Special care was taken to ensure that the catalyst was always immersed in water (Raney Ni™ is highly pyrophoric). Then, the water was exchanged with isopropanol (IPA) by gradual siphoning of the water via vacuum while adding the solvent. The catalyst was further washed with IPA several times and transferred in a glass bottle as a suspension.

### General Procedure for the Hydroformylation/Hydrogenation One Pot Reaction

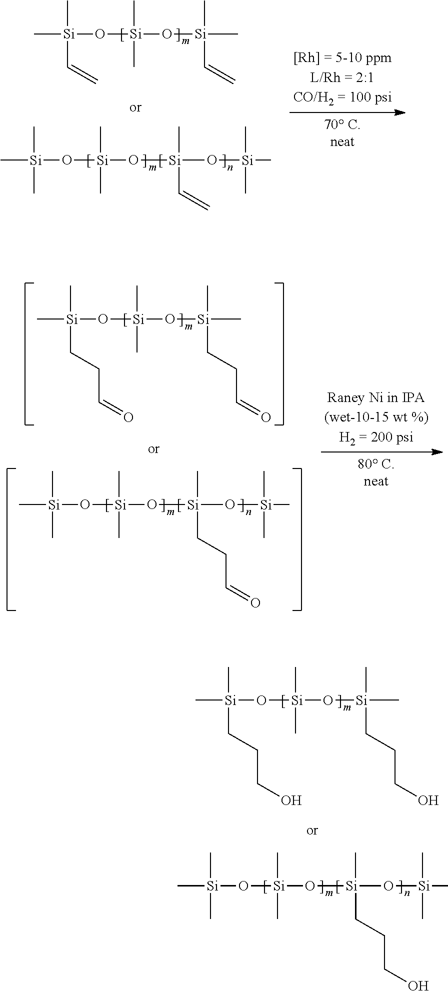

### General Reaction Scheme for the Hydroformylation/Hydrogenation One Pot Reaction

In a nitrogen filled glove box, a stock solution of catalyst was prepared with Rh(acac)(CO)₂ (8.2 mg), 6,6′-[[3,3′,5,5′-tetrakis(1,1-dimethylethyl)-1,1′-biphenyl]-2,2′-diyl]bis(oxy)]bis-dibenzo[d,f][1,3,2]dioxaphosphepin prepared as described in U.S. Pat. No. 10,227,365 to Miller, et al. ligand (53 mg) and toluene (130 g) which were weighed into a 200 mL glass bottle. Desired quantity from this stock solution was transferred into an airtight syringe with a metal valve and subsequently removed from the glove box. In a ventilated fume hood, the vinyl silane substrate was transferred into the Parr reactor. The reactor was sealed and loaded onto the holder. The reactor was pressurized with nitrogen up to 100 psi and was carefully relieved through a valve connected to the headspace three times. The reactor was then pressure tested by pressurizing to 200 psi with N₂. After releasing the pressure, the catalyst solution was added to the reactor via the septa port. The reactor was pressured with syngas to 100 psi and carefully relieved three times. It was then pressured to 100 psi, then agitation (800 rpm) and heating (70° C.) were initiated. Typical reaction times were 4-6 h. To monitor the reaction, the reactor temperature was cooled to below 60° C., the pressure was vented, and a sample was carefully drawn via the dip tube and was analyzed by 1H NMR. Once the reaction was complete, the reactor was cooled to ambient temperature and the pressure vented. The reactor was then pressured with N₂ and released 3 times before unlocking the seal and lowering the reactor.

Required amount of Raney Ni™ (10-15 wt %) was scooped out of the storage jar minimizing the amount of IPA taken and loaded carefully into the reactor vessel. The reactor was quickly reassembled and purged with N₂ three times. A pressure test was then performed by pressurizing the reactor to 400 psi of N₂. The reactor was pressurized with hydrogen and carefully relieved three times. It was then pressurized to 200 psi with hydrogen, agitation (800 rpm) and heating (80° C.) were initiated. To monitor the reaction, the reactor temperature was cooled to below 60° C., the pressure was vented, and a sample was carefully drawn via the dip tube and was analyzed by ¹H NMR. Once the reaction was complete, the reactor was cooled to ambient temperature and the pressure vented. The reactor was then purged with N₂ three times before unlocking the seal and lowering the reactor. The slurry was transferred to an Erlenmeyer flask with a minimal amount of toluene. The slurry was then filtered via vacuum filtration followed by stripping of solvent using a rotary evaporator (20 Torr, 50° C.). The crude carbinol was finally pressure filtered under N₂ using a 0.2-micron PTFE filter to obtain carbinol as an optically clear fluid.

SPE #4 M^{ProH}D₁₆M^{PrOH} (HF-4)

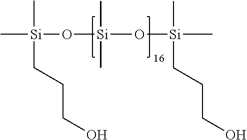

According to the above general procedure, a HF-4 dicarbinol was made in a 2 L Pressure Reactor. The final weight of the produced carbinol is around 530 g.

### Ethoxylation of HF-4 Dicarbinol

The general ethoxylated reaction is shown below:

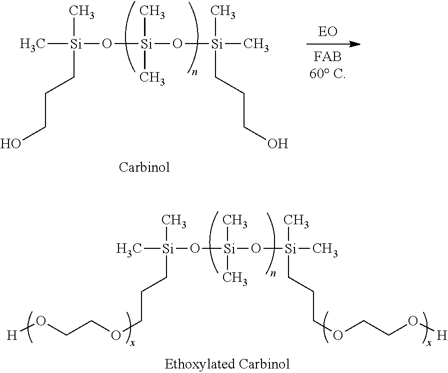

75 g (0.0592 moL) of a bis-carbinol-terminated polydimethylsiloxane HF-4 with average formula

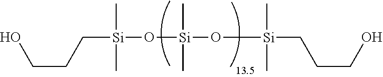

was added 0.075 g (1000 ppm) of tris(pentafluorophenyl)borane (FAB) and dissolved with stirring. This solution was charged by syringe to a batch reactor under nitrogen and heated to 60° C. Ethylene oxide (44.1 g; 1.0 moL) was added with a rate of 1 mL/min at 60° C. with stirring. At the end of the addition in about 1 hour, stirring at 60° C. continued for 3 more hours. The residual ethylene oxide was purged with nitrogen, mixture was cooled, and the recovered product (106.4 g) was analyzed by 1H NMR. The NMR test results confirmed that the SPE product had the structure shown below.

¹H NMR (CDCl₃, δ, ppm) for the starting dicarbinol HF-4:0.05 (m, 92H), 0.52 (m, 4H), 1.60 (m, 4H), 3.51 (m, 4H).

¹H NMR (CDCl₃, δ, ppm) for the ethoxylated product: 0.05 (m, 93.8H), 0.49 (m, 4H), 1.58 (m, 4H), 3.6 (broad m, 60.6H).

The GPC analysis of the SPE product is shown below in the Table.

| Material | Mn | Mw | PDI |
|---|---|---|---|
| Starting HF-4 | 1316 | 1632 | 1.24 |
| SPE Product | 2398 | 3671 | 1.53 |

The silicone—polyether product contained on average 7.1 added ethylene oxide units per chain and corresponded to the following average formula:

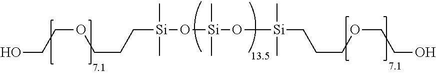

### INDUSTRIAL APPLICABILITY

The technical problems to be addressed by the present invention include providing a method to synthesize a silicone polyether, which has defined functionality, retains the polysiloxane structure, and is free of unsaturated polyether components. Commercial production of silicone polyethers relies upon platinum catalyzed hydrosilylation of SiH containing polyalkylsiloxanes with allyl polyethers. Allyl polyethers are used in excess because they partially isomerize during the course of reaction to form unreactive 2-propenyl polyethers with an internal C═C double bond. Both allyl polyether and 2-propenyl polyether remain as undesirable side products in the resulting alkoxylated polysiloxane products, which can lead to bimodal or polymodal molecular weight distributions and high PDIs. Hydrolysis of 2-propenyl polyether in the presence of water can generate propionaldehyde, resulting in unwanted side reactions and unpleasant smell.

The silicone polyether prepared by the method described herein may have one or more of the following benefits over silicone polyethers prepared via hydrosilylation reaction: lower PDI and better purity. For example, silicone polyethers prepared by hydrosilylation with allyl polyether as a starting material contain a 2-propenyl polyether side product, which can hydrolyze to form propionaldehyde that may generate undesired odor and promote secondary reactions. Furthermore, silicone polyethers prepared via hydrosilylation reaction typically have a bimodal or polymodal molecular weight distribution measured by GPC, but the silicone polyethers prepared by the method described herein may have a single peak measured by GPC.

### Definitions and Usage of Terms

All amounts, ratios, and percentages herein are by weight, unless otherwise indicated. The amounts of all starting materials in a composition total 100% by weight. The SUMMARY and ABSTRACT are hereby incorporated by reference. The articles ‘a’, ‘an’, and ‘the’ each refer to one or more, unless otherwise indicated by the context of specification. The singular includes the plural unless otherwise indicated. The transitional phrases “comprising”, “consisting essentially of”, and “consisting of” are used as described in the Manual of Patent Examining Procedure Ninth Edition, Revision 08.2017, Last Revised January 2018 at section § 2111.03 I., II., and III. The abbreviations used herein have the definitions in Table Z.

TABLE Z
Abbreviations

| Abbreviation | Definitions |
|---|---|
| acac | acetyl acetonate |
| ° C. | degrees Celsius |
| D | Difunctional siloxy unit, trimethylsiloxy unit of formula Me₂SiO_{2/2} |
| D^{al} | Difunctional siloxy unit, allylmethylsiloxy unit of formula |
| | (Allyl)(Me)SiO_{2/2} |
| D^{hex} | Difunctional siloxy unit, hexenylmethylsiloxy unit of formula |
| | (Hex)(Me)SiO_{2/2} |
| D^{Pr-ald} | Difunctional siloxy unit, propylaldehyde,methylsiloxy unit of formula (Pr- |
| | ald)(Me)SiO_{2/2} |
| D^{vi} | Difunctional siloxy unit, vinylmethylsiloxy unit of formula (Vi)(Me)SiO_{2/2} |
| EO | ethylene oxide |
| Et | ethyl |
| FTIR | Fourier transform infra-red |
| g | gram |
| GPC | gel permeation chromatography |
| h | hour |
| Hex | hexenyl |
| iPr | isopropyl |
| kPa | kiloPascals |
| M | Monofunctional siloxy unit, trimethylsiloxy unit of formula R₃SiO_{1/2} or |
| | Me₃SiO_{1/2} |
| M^{al} | Monofunctional siloxy unit, allyldimethylsiloxy unit of formula |
| | (Allyl)(Me₂)SiO_{1/2} |
| M^{hex} | Monofunctional siloxy unit, hexenyldimethylsiloxy unit of formula |
| | (Hex)(Me₂)SiO_{1/2} |
| M^{Pr-ald} | Monofunctional siloxy unit, propyladehyde, dimethylsiloxy unit of formula |
| | (Pr-ald)(Me₂)SiO_{1/2} |
| M^{vi} | Monofunctional siloxy unit, vinyldimethylsiloxy unit of formula |
| | (Vi)(Me₂)SiO_{1/2} |
| Me | methyl |
| mg | milligram |
| min | minute |
| mL | milliliter |
| mm | millimeter |
| mmol | millimole |
| Mn | number average molecular weight measured by GPC |
| Mw | weight average molecular weight measured by GPC |
| mPa · s | milliPascal seconds |
| NBD | norbornadiene |
| NMR | nuclear magnetic resonance |
| PDI | Polydispersity index (calculated as Mw/Mn) |
| Ph | phenyl |
| PO | propylene oxide |
| ppm | parts per million by weight |
| Pr | propyl |
| Pr-ald | propyl-aldehyde |
| psi | pounds per square inch |
| Q | tetrafunctional siloxy unit of formula SiO_{4/2} |
| RPM | revolutions per minute |
| RT | room temperature of 25 ± 5° C. |
| SPE | silicone polyether |
| TDCC | The Dow Chemical Company of Midland, Michigan, USA |
| THF | tetrahydrofuran |
| μm | micrometer |
| Vi | vinyl |

The following test methods were used herein. FTIR: The concentration of silanol groups present in the polyorganosiloxane resins (e.g., polyorganosilicate resins and/or silsesquioxane resins) was determined using FTIR spectroscopy according to ASTM Standard E-168-16. GPC: The molecular weight distribution of the polyorganosiloxanes was determined by GPC using an Agilent Technologies 1260 Infinity chromatograph and toluene as a solvent. The instrument was equipped with three columns, a PL gel 5 μm 7.5×50 mm guard column and two PLgel 5 μm Mixed-C 7.5×300 mm columns. Calibration was made using polystyrene standards. Samples were made by dissolving polyorganosiloxanes in toluene (˜1 mg/mL) and then immediately analyzing the solution by GPC (1 mL/min flow, 35° C. column temperature, 25-minute run time). ²⁹Si NMR: Alkenyl content of starting material (B) can be measured by the technique described in “The Analytical Chemistry of Silicones” ed. A. Lee Smith, Vol. 112 in Chemical Analysis, John Wiley & Sons, Inc. (1991). Viscosity: Viscosity may be measured at 25° C. at 0.1 to 50 RPM on a Brookfield DV-III cone & plate viscometer with #CP-52 spindle, e.g., for polymers (such as certain (B2) alkenyl-functional polyorganosiloxanes) with viscosity of 120 mPa·s to 250,000 mPa·s. One skilled in the art would recognize that as viscosity increases, rotation rate decreases and would be able to select appropriate spindle and rotation rate.

The aldehyde-functional organosilicon compounds, and hydrogenation reaction product mixtures, in the examples above, were analyzed by ¹H, ¹³C NMR and ²⁹Si NMR, GC/MS, GPC and viscosity. The conversion and yield in the examples above were mainly based on ¹H NMR data.

### Embodiments of the Invention

In a first embodiment, a method for making a polyether-functional organosilicon compound comprises:
(1) combining, at a temperature up to 100° C. for a time up to 10 hours, starting materials comprising
   (A) an alkylene oxide;
   (B) a fluorinated triarylborane Lewis acid; and
   (C) a carbinol-functional organosilicon compound.

In a second embodiment, in the method of the first embodiment, the alkylene oxide is selected from the group consisting of ethylene oxide, propylene oxide, and a combination of both ethylene oxide and propylene oxide.

In a third embodiment, in the method of the first embodiment or the second embodiment, (B) the fluorinated triarylborane Lewis acid has formula

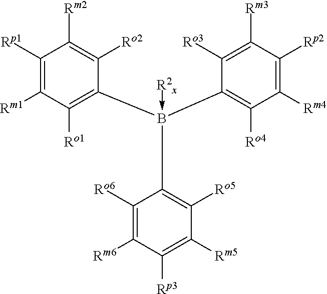

where each of R^{o1-6}, each of R^{m1-6}, and each of R^{p1-3} is independently selected from H, F, or CF₃; with the provisos that not all of R^{o1-6}, R^{m1-6}, and R^{p1-3} are simultaneously H, and no more than two of R^{o1-6} are simultaneously CF₃; subscript x is 0 or 1, and R² comprises a functional group or a functional polymer group.

In a fourth embodiment, in the method of the third embodiment, (B) the fluorinated triarylborane Lewis acid is selected from the group consisting of tris(3,5-bis(trifluoromethyl)phenyl)borane THF adduct; bis(3,5-bis(trifluoromethyl)phenyl)(2,4,6-trifluorophenyl)borane THF adduct; and tris(pentafluorophenyl)borane.

In a fifth embodiment, in the method of the fourth embodiment, (C) the carbinol-functional organosilicon compound has 1 or 2 carbinol-functional groups per molecule, and (B) the fluorinated triarylborane Lewis acid is tris(pentafluorophenyl)borane.

In a sixth embodiment, in the method of the fourth embodiment, (C) the carbinol-functional organosilicon compound has more than 2 carbinol-functional groups per molecule, and (B) the fluorinated triarylborane Lewis acid is selected from the group consisting of tris(3,5-bis(trifluoromethyl)phenyl)borane THF adduct; and bis(3,5-bis(trifluoromethyl)phenyl)(2,4,6-trifluorophenyl)borane THF adduct.

In a seventh embodiment, in the method of any one of the preceding embodiments, (B) the fluorinated triarylborane Lewis acid is used in an amount of 50 ppm to 10,000 ppm by weight, based on combined weights of (A) the alkylene oxide, (B) the fluorinated triarylborane Lewis acid, and (C) the carbinol-functional organosilicon compound.

In an eighth embodiment, in the method of any one of the preceding embodiments, (C) the carbinol functional organosilicon compound comprises a group, R^{Car}, of formula

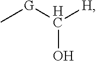

where G is a divalent hydrocarbon group free of aliphatic unsaturation that has 2 to 8 carbon atoms.

In a ninth embodiment, in the method of the eighth embodiment, (C) the carbinol functional organosilicon compound comprises a carbinol-functional silane of formula: R^{Car}SiR⁴₍₄₋ₓ₎, where each R^{Car} is an independently selected carbinol group of 3 to 9 carbon atoms of formula

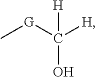

where G is a divalent hydrocarbon group free of aliphatic unsaturation that has 2 to 8 carbon atoms; each R⁴ is independently selected from the group consisting of an alkyl group of 1 to 18 carbon atoms, an aryl group of 6 to 18 carbon atoms, an acyloxy group of 2 to 18 carbon atoms, and a hydrocarbonoxy-functional group of 1 to 18 carbon atoms; and subscript x is 1 to 4.

In a tenth embodiment, in the method of the eighth embodiment, (C) the carbinol functional organosilicon compound comprises a carbinol-functional polyorganosiloxane of unit formula (C2-1): (R⁴₃SiO_{1/2})ₐ(R⁴₂R^{Car}SiO_{1/2})_{b}(R⁴₂SiO_{2/2})_{c}(R⁴R^{Car}SiO_{2/2})_{d}(R⁴SiO_{3/2})ₑ(R^{Car}SiO_{3/2})_{f}(SiO_{4/2})_{g}(ZO_{1/2})ₕ; where
each R^{Car} is an independently selected carbinol group of 3 to 9 carbon atoms of formula

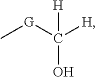

where G is a divalent hydrocarbon group free of aliphatic unsaturation that has 2 to 8 carbon atoms;
each R⁴ is independently selected from the group consisting of an alkyl group of 1 to 18 carbon atoms, an aryl group of 6 to 18 carbon atoms, an acyloxy group of 2 to 18 carbon atoms, and a hydrocarbonoxy-functional group of 1 to 18 carbon atoms;
each Z is independently selected from the group consisting of a hydrogen atom and R⁵,
   where each R⁵ is independently selected from the group consisting of an alkyl group of 1 to 18 carbon atoms and an aryl group of 6 to 18 carbon atoms;
subscripts a, b, c, d, e, f, and g represent numbers of each unit in formula (C2-1) and have values such that
   subscript a≥0,
   subscript b≥0,
   subscript c≥0,
   subscript d≥0,
   subscript e≥0,
   subscript f≥0,
   subscript g≥0; and
   subscript h has a value such that 0≥h/(e+f+g)≥1.5, 10,000≥ (a+b+c+d+e+f+g)≥2, and a quantity (b+d+f)≥1.

In an eleventh embodiment, in the method of the tenth embodiment, (C) the carbinol-functional polyorganosiloxane comprises a linear polydiorganosiloxane of unit formula (C2-3): (R⁴₃SiO_{1/2})ₐ(R^{Car}R⁴₂SiO_{1/2})_{b}(R⁴₂SiO_{2/2})_{c}(R^{Car}R⁴SiO_{2/2})_{d}, where R^{Car} and R⁴ are as described above, subscript a is 0, 1, or 2; subscript b is 0, 1, or 2, subscript c≥0, subscript d≥0, with the provisos that a quantity (b+d)≥1, a quantity (a+b)=2, and a quantity (a+b+c+d)≥2.

In a twelfth embodiment, in the method of the eleventh embodiment, (C) the linear polydiorganosiloxane has a unit formula selected from the group consisting of
unit formula (C2-4): (R⁴₂R^{Car}SiO_{1/2})₂(R⁴₂SiO_{2/2})ₘ(R⁴R^{Car}SiO_{2/2})ₙ,
unit formula (C2-5): (R⁴₃SiO_{1/2})₂(R⁴₂SiO_{2/2})ₒ(R⁴R^{Car}SiO_{2/2})ₚ, and
a combination of both (C2-4) and (C2-5), where in formulae (C2-4) and (C2-5),
   each R⁴ and each R^{Car} are as described above,
   subscript m is 0 or a positive number (e.g., 2 to 2,000);
   subscript n is 0 or a positive number (e.g., 0 to 2000);
   subscript o is 0 or a positive number, (e.g., 0 to 2000), and
   subscript p is at least 2, (e.g., 2 to 2000).

In a thirteenth embodiment, in the method of the tenth embodiment, (C) the carbinol-functional polyorganosiloxane comprises a cyclic polydiorganosiloxane of unit formula (C2-7): (R⁴R^{Car}SiO_{2/2})_{d}, where R^{Car} and R⁴ are as described above, and subscript d is 3 to 12,

In a fourteenth embodiment, in the method of the tenth embodiment, (C) the carbinol-functional polyorganosiloxane comprises a cyclic polydiorganosiloxane of unit formula (C2-8): (R⁴₂SiO_{2/2})_{c}(R⁴R^{Car}SiO_{2/2}) d, where R⁴ and R^{Car} are as described above, subscript c is >0 to 6 and subscript d is 3 to 12.

In a fifteenth embodiment, in the method of the eighth embodiment, (C) the carbinol functional organosilicon compound comprises an oligomeric polyorganosiloxane of formula (C2-10):

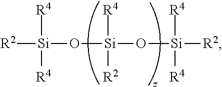

where R⁴ is as described above, each R² is independently selected from the group consisting of R⁴ and R^{Car}, as described above, with the proviso that at least one R², per molecule, is R^{Car}, and subscript z is 0 to 48.

In a sixteenth embodiment, in the method of the eighth embodiment, (C) the carbinol functional organosilicon compound comprises a branched carbinol-functional polyorganosiloxane of general formula (C2-11): R^{Car}SiR¹²₃, where R^{Car} is as described above, and each R¹² is selected from R¹³ and —OSi(R¹⁴)₃; where each R¹³ is a monovalent hydrocarbon group; where each R¹⁴ is selected from R¹³, —OSi(R¹⁵)₃, and —[OSiR¹³₂]ᵢᵢOSiR¹³₃; where each R¹⁵ is selected from R¹³, —OSi(R¹⁶)₃, and —[OSiR¹³₂]ᵢᵢOSiR¹³₃; where each R¹⁶ is selected from R¹³ and —[OSiR¹³₂]; OSiR¹³₃; and where subscript ii has a value such that 0≤ii≤100.

In a seventeenth embodiment, in the method of the sixteenth embodiment, (C) the branched carbinol-functional polyorganosiloxane comprises a branched oligomer of structure:

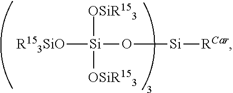

where R^{Car} and R¹⁵ are as described above.

In an eighteenth embodiment, in the method of the sixteenth embodiment, (C) the branched carbinol-functional polyorganosiloxane comprises a branched oligomer of structure:

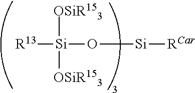

where R^{Car}, R¹³, and R¹⁵ are as described above.

In a nineteenth embodiment, in the method of the sixteenth embodiment, (C) the branched carbinol-functional polyorganosiloxane comprises a branched polyorganosiloxane oligomer of structure:

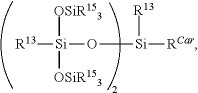

where R^{Car}, R¹³, and R¹⁵ are as described above.

In a twentieth embodiment, in the method of the tenth embodiment, the carbinol functional organosilicon compound comprises a Q-branched polyorganosiloxane of unit formula (C2-13): (R⁴₃SiO_{1/2})_{q}(R⁴₂R^{Car}SiO_{1/2})ᵣ(R⁴₂SiO_{2/2})ₛ(SiO_{4/2})ₜ, where R⁴ and R^{Car} are as described above, and subscripts q, r, s, and t have average values such that 2≥q≥0, 4≥r≥0, 995≥s≥4, t=1, (q+r)=4, and (q+r+s+t) has a value sufficient to impart a viscosity >170 mPa·s measured by rotational viscometry to the branched polyorganosiloxane.

In a twenty-first embodiment, in the method of the tenth embodiment, the carbinol functional organosilicon compound comprises a Q-branched polyorganosiloxane comprising formula (C2-14): [R^{Car}R⁴₂Si—(O—SiR⁴₂)ₓ—O]_{(4-w)}—Si—[O—(R⁴₂SiO)ᵥSiR⁴₃]_{w}, where R^{Car} and R⁴ are as described above; and subscripts v, w, and x have values such that 200≥v≥1, 2≥w≥0, and 200≥x≥1.

In a twenty-second embodiment, in the method of the tenth embodiment, the carbinol functional organosilicon compound comprises a T-branched polyorganosiloxane of unit formula (C2-15): (R⁴₃SiO_{1/2})ₐₐ(R^{Car}R⁴₂SiO_{1/2})_{bb}(R⁴₂SiO_{2/2})_{cc}(R^{Car}R⁴SiO_{2/2})ₑₑ(R+SiO_{3/2})_{dd}, where R⁴ and R^{Car} are as described above, subscript aa≥0, subscript bb>0, subscript cc is 15 to 995, subscript dd>0, and subscript ee≥0.

In a twenty-third embodiment, in the method of the tenth embodiment, the carbinol functional organosilicon compound comprises a polyorganosilicate resin comprising unit formula (C2-17): (R⁴₃SiO_{1/2})ₘₘ(R⁴₂R^{Car}SiO_{1/2})ₙₙ(SiO_{4/2})ₒₒ(ZO_{1/2}) h, where Z, R⁴, and R^{Car}, and subscript h are as described above and subscripts mm, nn and oo have average values such that mm≥0, nn>0, oo>0, and 0.5≤(mm+nn)/oo≤4.

In a twenty-fourth embodiment, in the method of the tenth embodiment, the carbinol functional organosilicon compound comprises a silsesquioxane resin of unit formula: (R⁴₃SiO_{1/2})ₐ(R⁴₂R^{Car}SiO_{1/2})_{b}(R⁴₂SiO_{2/2})_{c}(R⁴R^{Car}SiO_{2/2})_{d}(R⁴SiO_{3/2})ₑ(R^{Car}SiO_{3/2})_{f}(ZO_{1/2})ₕ; where R⁴ and R^{Car} are as described above, subscript f>1,2<(e+f)<10,000; 0<(a+b)/(e+f)<3; 0< (c+d)/(e+f)<3; and 0<h/(e+f)<1.5.

In a twenty-fifth embodiment, in the method of the tenth embodiment, the carbinol functional organosilicon compound comprises a silsesquioxane resin may comprising unit formula (C2-19): (R⁴SiO_{3/2})ₑ(R^{Car}SiO_{3/2})_{f}(ZO_{1/2})ₕ, where R⁴, R^{Car}, Z, and subscripts h, e and f are as described above.

In a twenty-sixth embodiment, in the method of the twenty-fifth embodiment, the silsesquioxane resin further comprises units of formulae (R⁴₂SiO_{2/2})_{c}(R⁴R^{Car}SiO_{2/2})_{d}, where R⁴, R^{Car}, and subscripts c and d are as described above.

In a twenty-seventh embodiment, in the method of the twenty-sixth embodiment, the silsesquioxane resin further comprises units of formulae (R⁴₃SiO_{1/2})ₐ(R⁴₂R^{Car}SiO_{1/2})_{b}, where R⁴, R^{Car}, and subscripts a and b are as described above.

In a twenty-eighth embodiment, in the method of any one of the preceding embodiments, the temperature in step (1) is 20° C. to 100° C.

In a twenty-ninth embodiment, in the method of any one of the preceding embodiments, the time in step (1) is 1 to 10 hours.

In a thirtieth embodiment, the method of any one of the preceding embodiments further comprises adding a solvent before or during step (1).

In a thirty-first embodiment, in the method of the thirtieth embodiment, (B) the fluorinated triarylborane Lewis acid is dissolved in the solvent before step (1).

In a thirty-second embodiment, the method of any one of the preceding embodiments further comprises (2) recovering the polyether-functional organosilicon compound after step (1).

In a thirty-third embodiment, the method of any one of the preceding embodiments further comprises removing an impurity from (C) the carbinol-functional organosilicon compound before step (1).

In a thirty-fourth embodiment, in the method of the thirty-third embodiment, removing the impurity is performed by contacting (C) the carbinol-functional organosilicon compound with an adsorbent.

In a fortieth embodiment, a polyether-functional organosilicon compound is prepared by the method of any one of the preceding embodiments.

In a forty-first embodiment, the polyether-functional organosilicon compound of the fortieth embodiment comprises a polyether-functional polyorganosiloxane of unit formula (i2-1): (R⁴₃SiO_{1/2})ₐ(R⁴₂R^{PE}SiO_{1/2})_{b}(R⁴₂SiO_{2/2})_{c}(R⁴R^{PE}SiO_{2/2})_{d}(R⁴SiO_{3/2})ₑ(R^{PE}SiO_{3/2})_{f}(SiO_{4/2})_{g}(ZO_{1/2})ₕ; where
each R^{PE} is a polyether group derived from alkoxylation of a carbinol group in starting material (C), the carbinol functional organosilicon compound, with (A) the alkylene oxide;
each R⁴ is independently selected from the group consisting of an alkyl group of 1 to 18 carbon atoms, an aryl group of 6 to 18 carbon atoms, an acyloxy group of 2 to 18 carbon atoms, and a hydrocarbonoxy-functional group of 1 to 18 carbon atoms;
each Z is independently selected from the group consisting of a hydrogen atom and R⁵,
   where each R⁵ is independently selected from the group consisting of an alkyl group of 1 to 18 carbon atoms and an aryl group of 6 to 18 carbon atoms;
subscripts a, b, c, d, e, f, and g represent numbers of each unit in formula (i2-1) and have values such that
   subscript a≥0,
   subscript b≥0,
   subscript c≥0,
   subscript d≥0,
   subscript e≥0,
   subscript f≥0,
   subscript g≥0; and
   subscript h has a value such that 0≥ h/(e+f+g)≥1.5, 10,000≥ (a+b+c+d+e+f+g)≥2, and a quantity (b+d+f)≥1.

In a forty-second eleventh embodiment, in the method of the forty-first embodiment, (i) the polyether-functional polyorganosiloxane comprises a linear polydiorganosiloxane of unit formula (i2-3): (R⁴₃SiO_{1/2})ₐ(R^{PE}R⁴₂SiO_{1/2})_{b}(R⁴₂SiO_{2/2})_{c}(R^{PE}R⁴SiO_{2/2})ₐ, where R^{PE} and R⁴ are as described above, subscript a is 0, 1, or 2; subscript b is 0, 1, or 2, subscript c≥0, subscript d≥0, with the provisos that a quantity (b+d)≥1, a quantity (a+b)=2, and a quantity (a+b+c+d)≥2.

In a twelfth embodiment, in the method of the eleventh embodiment, the linear polydiorganosiloxane has a unit formula selected from the group consisting of
unit formula (i2-4): (R⁴₂R^{PE}SiO_{1/2})₂(R⁴₂SiO_{2/2})ₘ(R⁴R^{PE}SiO_{2/2})ₙ,
unit formula (i2-5): (R⁴₃SiO_{1/2})₂(R⁴₂SiO_{2/2})ₒ(R⁴R^{PE}SiO_{2/2})ₚ, and
a combination of both (12-4) and (12-5), where in formulae (i2-4) and (i2-5),
   each R⁴ and each R^{PE} are as described above,
   subscript m is 0 or a positive number (e.g., 2 to 2,000);
   subscript n is 0 or a positive number (e.g., 0 to 2000);
   subscript o is 0 or a positive number, (e.g., 0 to 2000), and
   subscript p is at least 2, (e.g., 2 to 2000).

In a thirteenth embodiment, in the method of the forty-first embodiment, (i) the polyether-functional polyorganosiloxane comprises a cyclic polydiorganosiloxane of unit formula (i2-7): (R⁴R^{PE}SiO_{2/2})_{d}, where R^{PE} and R⁴ are as described above, and subscript d is 3 to 12,

In a fourteenth embodiment, in the method of the forty-first embodiment, (i) the polyether-functional polyorganosiloxane comprises a cyclic polydiorganosiloxane of unit formula (i2-8): (R⁴₂SiO_{2/2})_{c}(R⁴R^{PE}SiO_{2/2})_{d}, where R⁴ and R^{PE} are as described above, subscript c is >0 to 6 and subscript d is 3 to 12.

In a fifteenth embodiment, in the method of the eighth embodiment, (i) the polyether functional organosilicon compound comprises an oligomeric polyorganosiloxane of formula (i2-10):

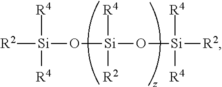

where R⁴ is as described above, each R² is independently selected from the group consisting of R⁴ and R^{PE}, as described above, with the proviso that at least one R², per molecule, is R^{PE}, and subscript z is 0 to 48.

In a sixteenth embodiment, in the method of the eighth embodiment, (i) the polyether functional organosilicon compound comprises a branched polyether-functional polyorganosiloxane of general formula (i2-11): R^{PE}SiR¹²₃, where R^{PE} is as described above, and each R¹² is selected from R¹³ and —OSi(R¹⁴)₃; where each R¹³ is a monovalent hydrocarbon group; where each R¹⁴ is selected from R¹³, —OSi(R¹⁵)₃, and —[OSiR¹³₂]ᵢᵢOSiR¹³₃; where each R¹⁵ is selected from R¹³, —OSi(R¹⁶)₃, and —[OSiR¹³₂]ᵢᵢOSiR¹³₃; where each R¹⁶ is selected from R¹³ and —[OSiR¹³₂]ᵢᵢOSiR¹³₃; and where subscript ii has a value such that 0≤ii≤100.

In a seventeenth embodiment, in the method of the sixteenth embodiment, (i) the branched polyether-functional polyorganosiloxane comprises a branched oligomer of structure:

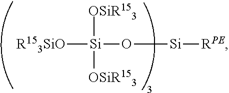

where R^{PE} and R¹⁵ are as described above.

In an eighteenth embodiment, in the method of the sixteenth embodiment, (i) the branched polyether-functional polyorganosiloxane comprises a branched oligomer of structure:

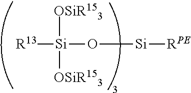

where R^{PE}, R¹³, and R¹⁵ are as described above.

In a nineteenth embodiment, in the method of the sixteenth embodiment, (i) the branched polyether-functional polyorganosiloxane comprises a branched polyorganosiloxane oligomer of structure:

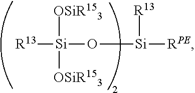

where R^{PE}, R¹³, and R¹⁵ are as described above.

In a twentieth embodiment, in the method of the forty-first embodiment, the polyether functional organosilicon compound comprises a Q-branched polyorganosiloxane of unit formula (i2-13): (R⁴₃SiO_{1/2})_{q}(R⁴₂R^{PE}SiO_{1/2})ᵣ(R⁴₂SiO_{2/2})ₛ(SiO_{4/2})ₜ, where R⁴ and R^{PE} are as described above, and subscripts q, r, s, and t have average values such that 2≥q≥0, 4≥r≥0, 995≥s≥4, t=1, (q+r)=4, and (q+r+s+t) has a value sufficient to impart a viscosity >170 mPa·s measured by rotational viscometry to the branched polyorganosiloxane.

In a twenty-first embodiment, in the method of the forty-first embodiment, the polyether functional organosilicon compound comprises a Q-branched polyorganosiloxane comprising formula (i2-14): [R^{PE}R⁴₂Si—(O—SiR⁴₂)ₓ—O]_{(4-w)}—Si—[O—(R⁴₂SiO)ᵥSiR⁴₃]_{w}, where R^{PE} and R⁴ are as described above; and subscripts v, w, and x have values such that 200≥v≥1, 2≥w≥0, and 200≥x≥1.

In a twenty-second embodiment, in the method of the forty-first embodiment, the polyether functional organosilicon compound comprises a T-branched polyorganosiloxane of unit formula (i2-15): (R⁴₃SiO_{1/2})ₐₐ(R^{PE}R⁴₂SiO_{1/2})_{bb}(R⁴₂SiO_{2/2})_{cc}(R^{PE}R⁴SiO_{2/2})ₑₑ(R⁴SiO_{3/2})_{dd}, where R⁴ and R^{PE} are as described above, subscript aa≥0, subscript bb>0, subscript cc is 15 to 995, subscript dd>0, and subscript ee≥0.

In a twenty-third embodiment, in the method of the forty-first embodiment, the polyether functional organosilicon compound comprises a polyorganosilicate resin comprising unit formula (i2-17): (R⁴₃SiO_{1/2})ₘₘ(R⁴₂R^{PE}SiO_{1/2})ₙₙ(SiO_{4/2})ₒₒ(ZO_{1/2})ₕ, where Z, R⁴, and R^{PE}, and subscript h are as described above and subscripts mm, nn and oo have average values such that mm≥0, nn>0, oo>0, and 0.5≤(mm+nn)/oo≤4.

In a twenty-fourth embodiment, in the method of the forty-first embodiment, the polyether functional organosilicon compound comprises a silsesquioxane resin of unit formula: (R⁴₃SiO_{1/2})ₐ(R⁴₂R^{PE}SiO_{1/2})_{b}(R⁴₂SiO_{2/2})_{c}(R⁴R^{PE}SiO_{2/2})_{d}(R⁴SiO_{3/2})ₑ(R^{PE}SiO_{3/2})_{f}(ZO_{1/2})ₕ; where R⁴ and R^{PE} are as described above, subscript f>1,2<(e+f)<10,000; 0<(a+b)/(e+f)<3; 0<(c+d)/(e+f)<3; and 0<h/(e+f)<1.5.

In a twenty-fifth embodiment, in the method of the forty-first embodiment, the polyether functional organosilicon compound comprises a silsesquioxane resin may comprising unit formula (i2-19): (R⁴SiO_{3/2})ₑ(R^{PE}SiO_{3/2})_{f}(ZO_{1/2})ₕ, where R⁴, R^{PE}, Z, and subscripts h, e and f are as described above.

In a twenty-sixth embodiment, in the method of the twenty-fifth embodiment, the silsesquioxane resin further comprises units of formulae (R⁴₂SiO_{2/2})_{c}(R⁴R^{PE}SiO_{2/2})_{d}, where R⁴, R^{PE}, and subscripts c and d are as described above.

In a twenty-seventh embodiment, in the method of the twenty-sixth embodiment, the silsesquioxane resin further comprises units of formulae (R⁴₃SiO_{1/2})ₐ(R⁴₂R^{PE}SiO_{1/2})_{b}, where R⁴, R^{PE}, and subscripts a and b are as described above.

In a twenty-eighth embodiment, in the method of any one of the first to twenty-sixth embodiments, the carbinol-functional organosilicon compound is prepared, before step (1), by a process comprising:

I) combining, under conditions to catalyze hydrogenation reaction, starting materials comprising an aldehyde-functional organosilicon compound, hydrogen, and a hydrogenation catalyst, thereby forming a hydrogenation reaction product comprising the carbinol-functional organosilicon compound.

In a twenty-ninth embodiment, in the method of the twenty-eighth embodiment, the hydrogenation catalyst is a heterogeneous hydrogenation catalyst comprising a metal selected from the group consisting of Ni, Cu, Co, Ru, Pd, Pt, and a combination of two or more thereof.

In a thirtieth embodiment, in the method of the twenty-ninth embodiment, the hydrogenation catalyst is selected from the group consisting of Raney nickel, Raney copper, copper catalyst on a porous supporting material, a palladium catalyst on a porous supporting material, a ruthenium catalyst on a porous supporting material, and a combination of two or more thereof; and wherein the porous supporting material is selected from the group consisting of Al₂O₃, SiO₂, SiC, and C.

In a thirty-first embodiment, in the method of any one of the twenty-eighth to thirtieth embodiments, amount of the hydrogenation catalyst is 1 weight % to 20 weight % based on weight of the aldehyde-functional organosilicon compound.

In a thirty-second embodiment, in the method of any one of the twenty-eighth to thirty-first embodiments, H₂ pressure is 10 psig (68.9 kPa) to 800 psig (5516 kPa).

In a thirty-third embodiment, in the method of any one of the twenty-eighth to thirty-second embodiments, hydrogenation reaction temperature is 0° C. to 200° C.

In a thirty-fourth embodiment, the method of any one of the twenty-eighth to thirty-third embodiments, further comprises pre-treating the hydrogenation catalyst before step I).

In a thirty-fifth embodiment, the method of any one of the twenty-eighth to thirty-fourth embodiments further comprises:
II) recovering the carbinol-functional organosilicon compound from the hydrogenation reaction product during and/or after step I) and before step (1).

In a thirty-sixth embodiment, in the method of any one of the twenty-eighth to thirty-fifth embodiments, the method further comprises:
forming the aldehyde-functional organosilicon compound before step I) by a process comprising: combining, under conditions to catalyze hydroformylation reaction, starting materials comprising
(A) a gas comprising hydrogen and carbon monoxide,
(B) an alkenyl-functional organosilicon compound, and
(C) a rhodium/bisphosphite ligand complex catalyst, where the bisphosphite ligand has formula

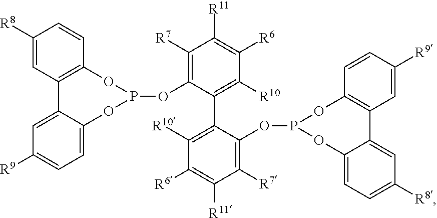

where
R⁶ and R⁶′ are each independently selected from the group consisting of hydrogen, an alkyl group of 1 to 20 carbon atoms, a cyano group, a halogen group, and an alkoxy group of 1 to 20 carbon atoms;
R⁷ and R⁷′ are each independently selected from the group consisting of an alkyl group of 3 to 20 carbon atoms, and a group of formula —SiR¹⁷₃, where each R¹⁷ is an independently selected monovalent hydrocarbon group of 1 to 20 carbon atoms;
R⁸, R⁸′, R⁹, and R⁹′ are each independently selected from the group consisting of hydrogen, an alkyl group, a cyano group, a halogen group, and an alkoxy group, and
R¹⁰′, R¹¹, and R¹¹′ are each independently selected from the group consisting of hydrogen or and alkyl group; thereby forming a hydroformylation reaction product comprising the aldehyde-functional organosilicon compound.

In a thirty-seventh embodiment, the method of the thirty-sixth embodiment further comprises recovering the aldehyde-functional organosilicon compound before step I).

1. A method for making a polyether-functional organosilicon compound, wherein the method comprises:
(1) combining, at a temperature up to 100° C. for a time up to 10 hours, starting materials comprising
(A) an epoxide;
(B) a halogenated triarylborane Lewis acid; and
(C) a carbinol-functional organosilicon compound.

2. The method of claim 1, where the epoxide is selected from the group consisting of ethylene oxide, propylene oxide, butylene oxide, glycidol, cyclohexene oxide, styrene oxide, and a combination of two or more thereof.

3. The method of claim 1, where the epoxide comprises an alkylene oxide.

4. The method of claim 1, where (B) the halogenated triarylborane Lewis acid has formula 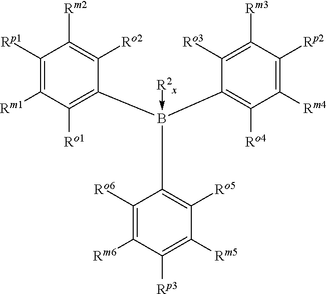
where each of R^{o1-6}, each of R^{m1-6}, and each of R^{p1-3} is independently selected from H, F, Cl, Br or CF₃; with the provisos that not all of R^{o1-6}, R^{m1-6}, and R^{p1-3} are simultaneously H, and when two or more of R^{o1-6} are simultaneously CF₃; subscript x is 0 or 1, and R² comprises a functional group or a functional polymer group.

5. The method of claim 4, where (B) the halogenated triarylborane Lewis acid is selected from the group consisting of tris(3,5-bis(trifluoromethyl)phenyl)borane THF adduct; bis(3,5-bis(trifluoromethyl)phenyl)(2,4,6-trifluorophenyl)borane THF adduct; and tris(pentafluorophenyl)borane.

6. The method of claim 5, where (C) the carbinol-functional organosilicon compound has 1 or 2 carbinol-functional groups per molecule, and (B) the halogenated triarylborane Lewis acid is tris(pentafluorophenyl)borane.

7. The method of claim 5, where (C) the carbinol-functional organosilicon compound has more than 2 carbinol-functional groups per molecule, and (B) the halogenated triarylborane Lewis acid is selected from the group consisting of tris(3,5-bis(trifluoromethyl)phenyl)borane THF adduct; and bis(3,5-bis(trifluoromethyl)phenyl)(2,4,6-trifluorophenyl)borane THF adduct.

8. The method of claim 1, where (B) the halogenated triarylborane Lewis acid is used in an amount of 50 ppm to 10,000 ppm by weight, based on combined weights of (A) the epoxide, (B) the halogenated triarylborane Lewis acid, and (C) the carbinol-functional organosilicon compound.

9. The method of claim 1, where (C) the carbinol functional organosilicon compound comprises a group, R^{Car}, of formula 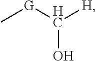
where G is a divalent hydrocarbon group free of aliphatic unsaturation that has 1 to 8 carbon atoms.

10. The method of claim 9, where (C) the carbinol functional organosilicon compound comprises a carbinol-functional silane of formula: R^{Car}ₓSiR⁴₍₄₋ₓ₎, where each R^{Car} is an independently selected carbinol group of 3 to 9 carbon atoms of formula 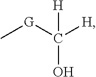
where G is a divalent hydrocarbon group free of aliphatic unsaturation that has 2 to 8 carbon atoms; each R⁴ is independently selected from the group consisting of an alkyl group of 1 to 18 carbon atoms, an aryl group of 6 to 18 carbon atoms, an acyloxy group of 2 to 18 carbon atoms, and a hydrocarbonoxy-functional group of 1 to 18 carbon atoms; and subscript x is 1 to 4.

11. The method of claim 9, where (C) the carbinol functional organosilicon compound comprises a carbinol-functional polyorganosiloxane of unit formula (C2-1):
(R⁴₃SiO_{1/2})ₐ(R⁴₂R^{Car}SiO_{1/2})_{b}(R⁴₂SiO_{2/2})_{c}(R⁴R^{Car}SiO_{2/2})_{d}(R⁴SiO_{3/2})ₑ(R^{Car}SiO_{3/2})_{f}(SiO_{4/2})_{g}(ZO_{1/2})ₕ; where
each R⁴ is independently selected from the group consisting of an alkyl group of 1 to 18 carbon atoms, an aryl group of 6 to 18 carbon atoms, an acyloxy group of 2 to 18 carbon atoms, and a hydrocarbonoxy-functional group of 1 to 18 carbon atoms;
each Z is independently selected from the group consisting of a hydrogen atom and R⁵,
where each R⁵ is independently selected from the group consisting of an alkyl group of 1 to 18 carbon atoms and an aryl group of 6 to 18 carbon atoms;
subscripts a, b, c, d, e, f, and g represent average numbers of each unit in formula (C2-1) and have values such that
subscript a≥0,
subscript b≥0,
subscript c≥0,
subscript d≥0,
subscript e≥0,
subscript f≥0,
subscript g≥0; and
subscript h has a value such that 0≤h/(e+f+g)≤1.5, 10,000≥(a+b+c+d+e+f+g)≥2, and
a quantity (b+d+f)≥1.

12. The method of claim 1, where the temperature in step (1) is 20° C. to 100° C.

13. The method of claim 1, where the time in step (1) is 1 to 10 hours.

14. The method of claim 1, further comprising (2) recovering the polyether-functional organosilicon compound after step (1).

15. The method of claim 1, further comprising removing all or a portion of an impurity from (C) the carbinol-functional organosilicon compound before step (1).

16. The method of claim 1, further comprising contacting (C) the carbinol-functional organosilicon compound with an adsorbent before step (1).

17. The method of claim 1, further comprising preparing the carbinol-functional organosilicon compound before step (1) by a method comprising:
i) forming an aldehyde-functional organosilicon compound by a process comprising: combining, under conditions to catalyze hydroformylation reaction, starting materials comprising
(A) a gas comprising hydrogen and carbon monoxide,
(B) an alkenyl-functional organosilicon compound, and
(C) a rhodium/bisphosphite ligand complex catalyst, where the bisphosphite ligand has formula 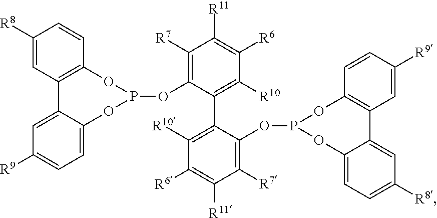
where
R⁶ and R^{6′} are each independently selected from the group consisting of hydrogen, an alkyl group of 1 to 20 carbon atoms, a cyano group, a halogen group, and an alkoxy group of 1 to 20 carbon atoms;
R⁷ and R^{7′} are each independently selected from the group consisting of an alkyl group of 3 to 20 carbon atoms, and a group of formula —SiR¹⁷₃, where each R¹⁷ is an independently selected monovalent hydrocarbon group of 1 to 20 carbon atoms;
R⁸, R^{8′}, R⁹, and R^{9′} are each independently selected from the group consisting of hydrogen, an alkyl group, a cyano group, a halogen group, and an alkoxy group, and
R^{10′}, R¹¹, and R^{11′} are each independently selected from the group consisting of hydrogen or and alkyl group; thereby forming a hydroformylation reaction product comprising the aldehyde-functional organosilicon compound;
optionally ii) recovering the aldehyde-functional organosilicon compound,
iii) combining, under conditions to catalyze hydrogenation reaction, starting materials comprising the aldehyde-functional organosilicon compound, hydrogen, and a hydrogenation catalyst, thereby forming a hydrogenation reaction product comprising the carbinol-functional organosilicon compound; and
optionally iv) recovering the carbinol-functional organosilicon compound.

18. (canceled)

19. The method for preparing the polyether-functional organosilicon compound of claim 1, where the polyether-functional organosilicon compound has a formula selected from the group consisting of: 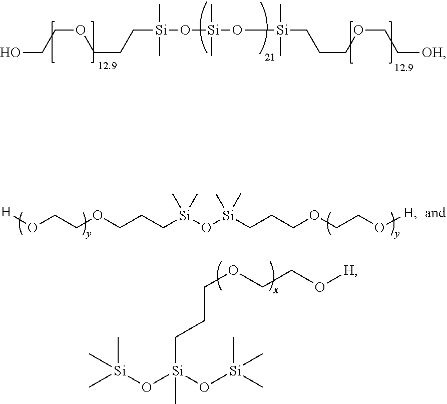
where each subscript y is 4 to 15 and subscript x is 2 to 16.

20. The method of claim 1, where the polyether-functional organosilicon compound has unit formula (R⁴₃SiO_{1/2})₂(R⁴₂SiO_{2/2})₈(R⁴R^{PE}SiO_{2/2})₄, where R^{PE} has formula 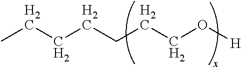
where subscript x is 2 to 16.
